(19) United States
(12) Patent Application Publication
(10) Pub. No.: US 2004/0012900 A1
(43) Pub. Date: Jan. 22, 2004

(54) Information service system and information service method

(76) Inventors: Yasuji Obuchi, Kitakatsuragi-shi (JP); Manabu Fujimoto, Yamatokoroyama-shi (JP); Hidetaka Mizumaki, Nara-shi (JP)

Correspondence Address: David G Conlin, Dike Bronstein Roberts & Cushman Edward & Angell, Intellectual Property Practice Group, P O Box 9169, Boston, MA, 02209, US

(21) Appl. No.: 10/398,062

(22) PCT Filed: Aug. 13, 2001
(86) PCT No.: PCT/JP01/07002

(30) Foreign Application Priority Data
Sep. 29, 2000 (JP) 2000-300980
Sep. 29, 2000 (JP) 2000-301024

(51) Int. Cl. H02H 3/00

(52) U.S. Cl. 361/1; 283/56

(57) ABSTRACT

An information service system includes a display section (14), provided at a place where unspecified number of users each having a portable information device (1) can use the display section (14), for displaying image information; a transmitting/receiving section (17) for communicating with the portable information device (1); and a display control section (15) for causing the display section (14) to display image information supplied via the transmitting/receiving section (17) from the portable information device (1), in accordance with a request from the portable information device (1). This allows, for example, a personal computer (PC) user to work with a large display screen even in visiting places without being forced to use a PC with poor portability in visiting places.

### TECHNICAL FIELDS

The present invention relates to an information service system and an information service method which provide, for example, users of small-sized portable information devices in visiting places with, for example, display devices with large screens.

### BACKGROUND OF THE INVENTION

In recent years, the diffusion rate of personal computers (hereinafter referred to as PC) has increased because of the explosive spread of IT (Information Technology) such as the Internet, and the PC price drop. In the PC as an information terminal device, for example, the use of the Internet enables retrieving various kinds of information and downloading application programs to use them. Further, over the Internet, data exchange is possible not only between PCs, but also between a PC and a information device such as portable telephone and portable information terminal. This expects that the PC has continued to spread with such information devices.

The PC, as a typical arrangement, has a main unit and a display unit for displaying image data. The main unit is provided with an operating section for input of data, etc. by a user of PC; a data control section for data processing, data storage, display image data creation, etc. Note that, some PCs, depending on the type of PCs, are arranged so that an operating section is separated from a main unit.

In the operating section, data is inputted generally by keyboard input, or voice input. The main unit is provided with a CPU (Central Processing Unit) for data processing, HD (Hard Disk) fore storing large volumes of data, a memory required for data processing, a graphic card for creating image data, and others. The display unit, in case of space-saving display unit, is provided with a liquid crystal panel, a signal converting section for driving a liquid crystal, a liquid crystal backlight, and an inverter of the backlight. As such PCs, a desktop PC conscious of high performance and economical efficiency, and a notebook PC conscious of portability, i.e. size and weight reduction have spread.

The latter notebook PC has an integrated combination of the operating section, the main unit, and the display unit. Such a notebook PC, which is positioned in an information terminal device that can be carried easily, is further requested to enhance its portability and size reduction. In order to respond to such a request, Japanese Unexamined Patent Publication No. 62400/1997 (Tokukaihei 9-62400; published on Mar. 7, 1997), makes an effort to reduce the weight of a notebook PC with acceptance on an arrangement including the operating section, a main body (main unit), and a display section (display unit).

More specifically, the arrangement in the above publication, in order to thin a back cover which is a cabinet of the display section, improves the strength of the cabinet by providing a brace type rib on the back cover, thereby improving the weight reduction of a notebook PC.

Further, in addition to the diffusion rate of the PC, the diffusion rate of information devices such as portable telephone, portable information terminal, etc. has increased because of the explosive spread of IT such as the Internet, and the price drop of the information device. The use of the Internet enables retrieving various kinds of information to information devices, downloading various kinds of application software to use them, and exchanging e-mails between information devices.

A typical information device having such functions is mainly composed of an operating section for inputting data, etc.; a main body for data processing, data storage, display image data creation, etc.; and a display section for displaying image data. For example, of the components, for the display section of a PC mainly used is a TFT color liquid crystal panel, and for the display section of a portable information terminal and a portable telephone mainly used is a small-sized duty liquid crystal panel.

However, the conventional PC, even though adopting a notebook PC form and improving its size reduction, requires the area for properly displaying image data on the display section as far as it includes at least the main body and display section. Because of this, the PC is subjected to the restriction in the area and weight of the display section, thereby having limitations of the reduction in its size and weight.

More specifically, decreasing the area in the display section for a size and weight reduction of the PC must make a sacrifice of, for example, a screen resolution of the display section, resulting in a significant decrease in display function. Further, instead of the sacrifice of the screen resolution, a decrease in pixel pitch decreases the size of a font, resulting in a significant decrease in display function again. Such a problem also occurs in portable information terminals other than a portable telephone or notebook PC, for example.

Therefore, a PC user, in order to work with a display screen of enough area in a visiting place, currently has no choice but to carry a PC having a display screen of enough area with a poor portability, or to install his/her own PC in visiting places. In such a case, the latter way makes substantially difficult for the PC user to work with a PC in unspecified visiting places. However, if putting a value on portability, the PC user has no choice but to use a portable telephone and a portable information terminal having a display section of small area.

Further, in recent years have increased a HP (Home Page) on the Internet and commercially-available application software having large volume of information, using static image, moving image, sound, music data, etc. requirements for using these data in a comfortable manner are to have each information device with built-in dedicated software for reproducing and displaying these data and to use a large and high-definition display device.

Still further, a portable information device, such as portable information terminal and portable telephone, which can access to the Internet from anywhere such as means of transport, has the convenience of information gathering and analyzing, and information transmission. Therefore, such portable information devices have great expectations of establishing more convenient use mode.

However, the foregoing portable information device has limitations of increasing the size of a display panel which is provided to the device, because of its portability. Therefore, the conventional form of portable information device, which is mainly provided with an operating section, a main body, and a display section, makes it difficult to have both excellent display and portable functions.

Note that, Japanese Unexamined Patent Publication No. 62400/1997, as described above, makes an effort to reduce the weight of a notebook PC with acceptance on an arrangement including an operating section, a main body, and a display section. More specifically, the arrangement in the above publication, in order to thin a back cover which is a cabinet of the display section, improves the strength of the cabinet by providing a brace type rib on the back cover, thereby improving the weight reduction of a notebook PC. However, since this arrangement also requires the display section having the area for properly displaying image data, the area and weight of the display section is limited. This makes it impossible to sufficiently reduce the size and weight of the notebook PC.

Further, the foregoing large and high-definition display device, for example, a liquid crystal display panel, has a problem that it is presently expensive or that it is not in the condition that anyone can easily purchase it because of housing conditions.

Meanwhile, in spite of good portability, a small and light portable information device without a large screen, makes it possible to use it while properly displaying content data (e.g. application software) having large volumes of information and to efficiently create documents, charts, etc. while displaying them on the large screen. Therefore, the user has no choice but to perform the data processing by using a PC having a large screen at home, for example. Further, in the case where the content data are retrieved to the portable information device, those data must be transferred to the PC for processing. Therefore, such a small and light portable information device has a problem of not taking full advantage of its portability.

Therefore, an object of the present invention is to provide an information service system and an information service method which can remove a large screen from the portable information device so as to reduce the size and weight of the portable information device, take advantage of the small size and light weight of the device, work with a large display screen in visiting places, and use data which is retrieved, for example, via the Internet; or to provide an information service system and an information service method which allows a PC user, for example, to work with a large display screen even in visiting places without being forced to use a PC with poor portability in visiting places.

### DISCLOSURE OF THE INVENTION

In order to solve the foregoing problems, an information service system of the present invention comprises: display means, provided at a place where unspecified number of users each having an external device, e.g. a portable personal computer can use the display means, for displaying image information; display side communicating means for communicating with the external device; and display control means for causing the display means to display image information supplied from the external device via the display side communicating means, in accordance with a request from the external device.

With the foregoing arrangement, in accordance with the request from the external device, the display control means cause the display means to display the image information supplied from the external device via the display side communicating means. Therefore, the external device does not require large-sized display means which can display images properly. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Another information service system of the present invention comprises: display means for displaying image information; display side communicating means for communicating with an external device, e.g. a portable personal computer; display control means for causing the display means to display image information supplied from the external device via the display side communicating means; and display management means having a charge processing section for charging for use of the display means by the external device.

With the foregoing arrangement, in accordance with the request from the external device, the display control means cause the display means to display the image information supplied from the external device via the display side communicating means. Therefore, the external device does not require large-sized display means which can display images properly. As a result of this, the external device can reduce its size and weight, thereby increasing portability.

Further, the charge processing section of the display management means charges for the use of the display means by the external device, so that it is possible to properly gain profits from the use of the display means.

Still another information service system of the present invention comprises: portable information means, e.g. a portable personal computer, and display providing means, the display providing means including: display means, provided at a place where unspecified number of users each having the portable information means can use the display means, for displaying image information; display side communicating means for communicating with the portable information means; display control means for causing the display means to display image information supplied from the portable information means via the display side communicating means, in accordance with a request for use from the portable information means; and display management means for managing display operation of the display means.

With the foregoing arrangement, in accordance with the request from the portable information means, the display control means cause the display means to display the image information supplied from the portable information means via the display side communicating means. Therefore, the portable information means does not require large-sized display means which can display images properly. As a result of this, the portable information means can reduce its size and weight, thereby increasing portability.

Further, since the display means are provided at the place where unspecified number of users each having portable information means can use the display means, e.g. a public place, holders of the portable information means can use the display means easily in visiting places and means of transport.

Yet another information service system comprises: portable information means, e.g. a portable personal computer, display providing means, and the display providing means including: display means for displaying image information; display side communicating means for communicating with the portable information means; display control means for causing the display means to display image information supplied from the portable information means via the display side communicating means; and display management means having a charge processing section for charging for use of the display means by the portable information means.

With the foregoing arrangement, in accordance with the request from the portable information means, the display control means cause the display means to display the image information supplied from the portable information means via the display side communicating means. Therefore, the portable information means does not require large-sized display means which can display images properly. As a result of this, the portable information means can reduce its size and weight, thereby increasing portability.

Further, the charge processing section of the display management means charges for the use of the display means by the portable information means, so that it is possible to properly gain profits from the use of the display means.

The foregoing information service system may have an arrangement in which the display means are paired up with the display side communicating means, and plural pairs of the display means and the display side communicating means are provided with respect to one display management means.

With the foregoing arrangement, one display management means manage a plurality of display means. This enables an efficient system arrangement and makes the installation of the plurality of display means easy.

The foregoing information service system may have an arrangement in which the display means are paired up with the display side communicating means, and at least plural pairs of the display means and the display side communicating means are dispersed in plural areas.

With the foregoing arrangement, the display means are dispersed in plural areas. This makes the use of the display means easy and enhances convenience of the present system.

The foregoing information service system may have an arrangement in which the charge processing section charges an amount of money depending on a length of time that the portable information means use the display means.

With the foregoing arrangement, it is possible to charge properly for the use of the display means by the portable information means.

The foregoing information service system may have an arrangement in which the display management means have a fee-based information storing section for storing fee-based information and provide the portable information means with the fee-based information in response to a request from the portable information means; and the charge processing section, when the fee-based information is provided to the portable information means, further charges a fee for the use of the fee-based information.

With the foregoing arrangement, the portable information means not only can use the display means for causing the display means to display image information held by the portable information means, but also can use fee-based information held by the fee-based information storing section of the display management means, thereby enhancing convenience of the system. Further, it is possible to properly charge not only for the use of the display means by the portable information means but also for the use of the fee-based information held by the fee-based management means.

The foregoing information service system may have an arrangement in which the display providing means further have a fee payment means accepting section; and the charge processing section asks a user of the portable information means for payment of a price charged and performs checkout processing with respect to fee payment means taken in the fee payment means accepting section.

With the foregoing arrangement, the charge processing section performs checkout processing for the price charged with respect to the fee payment means, for example, cash, credit card, debit card, various prepaid cards, and electric money, which are taken in the fee payment means accepting section. This makes easy checkout processing for the use fee by the user (holder) of the portable information means.

The foregoing information service system may have an arrangement in which the display management means include an availability determination section for managing a length of time that the portable information means use the display means in accordance with an amount that can be spent, given by the fee payment means taken in the fee payment means accepting section.

With the foregoing arrangement, the availability determination section manages a length of time that the portable information means use the display means in accordance with an amount that can be spent, given by the fee payment means, for example, cash, credit card, debit card, various prepaid cards, and electric money, which are taken in the fee payment means accepting section, so that it is possible to properly manage a length of time the portable information means can use the display means.

The foregoing information service system may have an arrangement in which the display management means further include: an advertisement information storage section for storing advertisement information which is displayed on the display means; and a display switching control section for switching so that the advertisement information stored in the advertisement information storage section is displayed on the display means while the display means are not used by the portable information means.

With the foregoing arrangement, while the display means are not used by the portable information means, advertisement information stored in the advertisement information storage section is displayed on the display means by switching operation of the display switching control section. Therefore, while the display means are not used by the portable information means, an advertiser can take advantage of display operation in the display means effectively for advertising.

The foregoing information service system may have an arrangement in which the display management means further include: an advertisement information storage section for storing advertisement information which is displayed on the display means; and a display switching control section for switching so that the advertisement information stored in the advertisement information storage section is displayed on the display means while the display means are not used by the portable information means, and the charge processing section charge an advertiser for display of the advertisement information on the display means.

With the foregoing arrangement, while the display means are not used by the portable information means, advertisement information stored in the advertisement information storage section is displayed on the display means by switching operation of the display switching control section. Therefore, while the display means are not used by the portable information means, an advertiser can take advantage of display operation in the display means effectively for advertising.

Further, the charge processing section charges an advertiser for display of advertisement information on the display means. This makes it possible to gain profits properly from the display of advertisement information on the display means.

The foregoing information service system may have an arrangement in which the display management means further include: an advertisement information storage section for storing advertisement information which is displayed on the display means; and a display switching control section for switching so that the advertisement information stored in the advertisement information storage section is displayed on the display means while the display means are not used by the portable information means, and the charge processing section reduces an amount asked to a user of the portable information means from a price charged and asks an advertiser whose advertisement is displayed on the display means for the amount that has been reduced.

With the foregoing arrangement, while the display means are not used by the portable information means, advertisement information stored in the advertisement information storage section is displayed on the display means by switching operation of the display switching control section. Therefore, while the display means are not used by the portable information means, an advertiser can take advantage of display operation in the display means effectively for advertising.

Further, in accordance with the advertisement display, the charge processing section reduces an amount asked to a user of the portable information means from a price charged and asks an advertiser whose advertisement is displayed on the display means for the amount that has been reduced. This provides a low-cost and friendly system for the user of the portable information means.

Still another information service system comprises: portable information means and display providing means, the display providing means including: display means for displaying image information; display side communicating means for communicating with the portable information means; display control means for causing the display means to display image information supplied from the portable information means via the display side communicating means; and display management means for managing an operation of the display means, the display management means including: an advertisement information storage section for storing advertisement information which is displayed on the display means; a display switching control section for switching so that the advertisement information stored in the advertisement information storage section is displayed on the display means while the display means are not used by the portable information means; and a charge processing section for charging an advertiser whose advertisement is displayed on the display means for a use fee for the display means.

With the foregoing arrangement, in accordance with the request from the portable information means, the display control means cause the display means to display the image information supplied from the portable information means via the display side communicating means. Therefore, the portable information means does not require large-sized display means which can display images properly. As a result of this, the portable information means can reduce its size and weight, thereby increasing portability.

Further, while the display means are not used by the portable information means, advertisement information stored in the advertisement information storage section is displayed on the display means by switching operation of the display switching control section. Therefore, while the display means are not used by the portable information means, an advertiser can take advantage of display operation in the display means effectively for advertising.

Further, in accordance with the advertisement display, the charge processing section charges an advertiser whose advertisement is displayed on the display means for a use fee for the display means. This provides an economically less burdensome and friendly system for the user of the portable information means.

The foregoing information service system may have an arrangement in which the charge processing section returns a part of profits gained by charging at least to an installation location provider who provides an installation location for the display means.

With the foregoing arrangement, at least the installation location provider for the display means can gain profits from providing the installation location.

The foregoing information service system may have an arrangement in which the charge processing section returns a part of profits gained by charging at least to an installation location provider who provides an installation location for the display means, and carries out the charging to the installation location provider in case where the installation location provider is an advertiser.

With the foregoing arrangement, at least the installation location provider for the display means can gain profits from providing the installation location. On the other hand, in the case where the installation location provider is an advertiser, the charging is carried out to the installation location provider. This makes it possible to properly carry out the return of profits and the charging to the installation location provider.

The foregoing information service system may have an arrangement in which the portable information means communicates with the display providing means in accordance with IEEE802.11, USB, or IEEE1394 specification.

With the foregoing arrangement, it is possible to easily make connections for communication between the portable information means and the display providing means.

An information service method of the present invention comprises the steps of: installing display means for displaying image information at a place where unspecified number of users each having portable information means can use the display means; and causing the display means to display image information supplied from the portable information means in accordance with a request for use from the portable information means.

With the foregoing arrangement, in accordance with the request from the portable information means, the image information supplied from the portable information means is displayed on the display means. Therefore, the portable information means does not require large-sized display means which can display images properly. As a result of this, the portable information means can reduce its size and weight, thereby increasing portability.

Further, since the display means are provided at the place where unspecified number of users each having portable information means can use the display means, e.g. a public place, holders of the portable information means can use the display means easily in visiting places and means of transport.

Yet another information service method comprises the steps of: installing display means for displaying image information; causing the display means to display image information supplied from portable information means; and charging for use of the display means by the portable information means.

With the foregoing arrangement, in accordance with the request from the portable information means, the image information supplied from the portable information means is displayed on the display means. Therefore, the portable information means does not require large-sized display means which can display images properly. As a result of this, the portable information means can reduce its size and weight, thereby increasing portability.

Further, it is charged for the use of the display means by the portable information means, so that it is possible to properly gain profits from the use of the display means.

The foregoing information service method may further comprise the steps of: asking a user of the portable information means for payment of a price charged; and performing checkout processing with respect to fee payment means provided.

With the foregoing arrangement, checkout processing for the price charged is performed with respect to the fee payment means, for example, cash, credit card, debit card, various prepaid cards, and electric money, which are taken in the fee payment means accepting section. This makes easy checkout processing for the use fee by the user (holder) of the portable information means.

The foregoing information service method may further comprise the step of: causing the display means to display advertisement information while the display means are not used by the portable information means.

With the foregoing arrangement, while the display means are not used by the portable information means, advertisement information is displayed on the display means. Therefore, while the display means are not used by the portable information means, an advertiser can take advantage of display operation in the display means effectively for advertising.

The foregoing information service method may further comprise the step of: charging an advertiser for display of the advertisement information on the display means.

Further, an advertiser is charged for display of advertisement information on the display means. This makes it possible to gain profits properly from the display of advertisement information on the display means.

The foregoing information service method may further comprise the steps of: causing the display means to display advertisement information while the display means are not used by the portable information means; reducing an amount asked to a user of the portable information means from a price charged; and asking an advertiser whose advertisement is displayed on the display means for the amount that has been reduced.

With the foregoing arrangement, while the display means are not used by the portable information means, advertisement information is displayed on the display means. Therefore, while the display means are not used by the portable information means, an advertiser can take advantage of display operation in the display means effectively for advertising.

Further, in accordance with the advertisement display, an amount asked to a user of the portable information means is reduced from a price charged and the amount that has been reduced is asked to an advertiser whose advertisement is displayed on the display means. This provides a low-cost and friendly system for the user of the portable information means.

The foregoing information service method may comprise the steps of: installing display means for displaying image information; causing the display means to display image information supplied from portable information means; causing the display means to display advertisement information while the display means are not used by the portable information means; and charging an advertiser whose advertisement is displayed on the display means for a use fee for the display means regarding an advertisement display and a use fee for the display means by the portable information means.

With the foregoing arrangement, in accordance with the request from the portable information means, the image information supplied from the portable information means is displayed on the display means. Therefore, the portable information means does not require large-sized display means which can display images properly. As a result of this, the portable information means can reduce its size and weight, thereby increasing portability.

Further, while the display means are not used by the portable information means, advertisement information is displayed on the display means. Therefore, while the display means are not used by the portable information means, an advertiser can take advantage of display operation in the display means effectively for advertising.

Further, in accordance with the advertisement display, a use fee for the display means is charged to an advertiser whose advertisement is displayed on the display means. This provides an economically less burdensome and friendly system for the user of the portable information means.

The foregoing information service method may further comprise the step of: returning a part of profits gained by charging to an installation location provider for the display means.

With the foregoing arrangement, at least the installation location provider for the display means can gain profits from providing the installation location.

The foregoing information service method may further comprise the step of: returning a part of profits gained by charging to an installation location provider who provides an installation location for the display means; and carrying out the charging to the installation location provider in case where the installation location provider is an advertiser.

With the foregoing arrangement, at least the installation location provider for the display means can gain profits from providing the installation location. On the other hand, in the case where the installation location provider is an advertiser, the charging is carried out to the installation location provider. This makes it possible to properly carry out the return of profits and the charging to the installation location provider.

An information service system of the present invention comprises: display means, provided at a place where unspecified number of users each having an external device, e.g. a portable personal computer can use the display means, for displaying information; display side communicating means for communicating with the external device; and display management means for retrieving information via a communication network, in accordance with a request supplied from the external device via the display side communicating means, and causing the display means to display the information.

With the foregoing arrangement, the display management means, in accordance with the request supplied from the external device via the display side communicating means, retrieve information via a communication network and cause the display means to display the information. Therefore, the external device does not require large-sized display means which can display information properly. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Another information service system of the present invention comprises: display means, provided at a place where unspecified number of users each having an external device can use the display means, for displaying information; display side communicating means for communicating with the external device; and display management means for retrieving information via a communication network, in accordance with a request supplied from the external device via the display side communicating means, supplying the information to the external device via the display side communicating means, and causing the display means to display a process of this processing.

With the foregoing arrangement, the display management means, in accordance with the request supplied from the external device via the display side communicating means, retrieve information via a communication network, supply the information to the external device via the display side communicating means, and cause the display means to display a process of this processing. Therefore, the external device does not require large-sized display means which can properly display a process of the processing carried out in accordance with the request from the external device. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Still another information service system comprises: display means for displaying information; display side communicating means for communicating with an external device; and display management means for retrieving information via a communication network, in accordance with a request supplied from the external device via the display side communicating means, causing the display means to display the information, and charging for at least a part of processing which is carried out in accordance with the request from the external device.

With the foregoing arrangement, the display management means, in accordance with the request supplied from the external device via the display side communicating means, retrieve information via a communication network and cause the display means to display the information. Therefore, the external device does not require large-sized display means which can display information properly. As a result of this, the external device can reduce its size and weight, thereby increasing portability.

Further, the display management means charge for at least a part of processing which is carried out in accordance with the request from the external device, so that it is possible to gain profits from carrying out the foregoing processing.

Yet another information service system comprises: display means for displaying information; display side communicating means for communicating with an external device; and display management means for retrieving information via a communication network, in accordance with a request supplied from the external device via the display side communicating means, supplying the information to the external device via the display side communicating means, causing the display means to display a process of this processing, and charging for at least a part of processing which is carried out in accordance with the request from the external device.

With the foregoing arrangement, the display management means, in accordance with the request supplied from the external device via the display side communicating means, retrieve information via a communication network, supply the information to the external device via the display side communicating means, and cause the display means to display a process of this processing. Therefore, the external device does not require large-sized display means which can properly display a process of the processing carried out in accordance with the request from the external device. As a result of this, the external device can reduce its size and weight, thereby increasing portability.

Further, the display management means charge for at least a part of processing which is carried out in accordance with the request from the external device, so that it is possible to gain profits from carrying out the foregoing processing.

The foregoing information service system may be arranged so as to further comprise: portable information means as the external device; and information distributing means for being capable of distributing information via the network to the display management means.

With the foregoing arrangement, the display management means, in accordance with the request supplied from the portable information means via the display side communicating means, can properly retrieve information from the information distributing means via a communication network. The portable information means do not require large-sized display means. As a result of this, the portable information means can reduce its size and weight, thereby increasing portability.

The foregoing information service system may have an arrangement in which the display means are paired up with the display side communicating means, and plural pairs of the display means and the display side communicating means are provided with respect to one display management means.

With the foregoing arrangement, one display management means manage a plurality of display means. This enables an efficient system arrangement and makes the installation of the plurality of display means easy.

The foregoing information service system may have an arrangement in which the display means are paired up with the display side communicating means, and at least plural pairs of the display means and the display side communicating means are dispersed in plural areas.

With the foregoing arrangement, the display means are dispersed in plural areas. This makes the use of the display means easy and enhances convenience of the present system.

The foregoing information service system may have an arrangement in which the display management means carry out the charging in accordance with a length of time that the display means is used.

With the foregoing arrangement, it is possible to charge properly for the use of the display means.

The foregoing information service system may have an arrangement in which the display management means obtain fee-based information from information distributing means which make a contract for information distribution via the communication network with the display management means.

With the foregoing arrangement, by previously making a contract for information distribution with selected information distributing means which provide useful fee-based information, the display management means can obtain fee-based information from such display management means. This makes it possible to easily obtain various kinds of high-quality information.

The foregoing information service system may have an arrangement in which the information distributing means exist in plurality, and the display management means obtain fee-based information to be obtained from information distributing means which supply the fee-based information at the lowest price.

With the foregoing arrangement, it is possible to supply useful information to a user of the present system at low prices.

The foregoing information service system may have an arrangement in which a fee payment means accepting section is further included, and the display management means ask a user of the external device for payment of a price charged and perform checkout processing with respect to fee payment means taken in the fee payment means accepting section.

With the foregoing arrangement, the display management means ask a user of the external device for payment of a price charged and perform checkout processing with respect to the fee payment means, for example, cash, credit card, debit card, various prepaid cards, and electric money, which are taken in the fee payment means accepting section. This makes easy checkout processing for the use fee by the user (holder) of the external device.

The foregoing information service system may have arrangement in which the display management means manage a length of time that the external device use the display means in accordance with an amount that can be spent, given by the fee payment means that are taken in the fee payment means accepting section.

With the foregoing arrangement, the display management means manage a length of time that the external device use the display means in accordance with an amount that can be spent, given by the fee payment means, for example, cash, credit card, debit card, various prepaid cards, and electric money, which are taken in the fee payment means accepting section, so that it is possible to properly manage a length of time the external device can use the display means.

The foregoing information service system may have an arrangement in which the display management means further include an advertisement information storage section for storing advertisement information which is displayed on the display means, and causes the display means to display the advertisement information stored in the advertisement information storage section while the display means are not used by the external device.

With the foregoing arrangement, while the display means are not used by the external device, advertisement information stored in the advertisement information storage section is displayed on the display means. Therefore, while the display means are not used by the external device, an advertiser can take advantage of display operation in the display means effectively for advertising.

The foregoing information service system may have an arrangement in which the display management means retrieve advertisement information via the communication network, and causes the display means to display the advertisement information while the display means are not used by the external device.

With the foregoing arrangement, while the display means are not used by the external device, advertisement information retrieved via the communication network is displayed on the display means. Therefore, while the display means are not used by the external device, an advertiser can take advantage of display operation in the display means effectively for advertising.

The foregoing information service system may have an arrangement in which the display management means charge an advertiser for display of the advertisement information on the display means.

With the foregoing arrangement, it is possible to properly gain profits from the display of advertisement information on the display means.

The foregoing information service system may have an arrangement in which the display management means, while the display means are not used by the external device, cause the display means to display advertisement information, charge an advertiser for display of the advertisement information on the display means, reduce an amount asked by charging to a user of the external device, and ask the advertiser for the amount that has been reduced.

With the foregoing arrangement, while the display means are not used by the external device, advertisement information is displayed on the display means. Therefore, while the display means are not used by the external device, an advertiser can take advantage of display operation in the display means effectively for advertising.

Further, in accordance with the advertisement display, the display management means reduce an amount asked to a user of the external device from a price charged and asks an advertiser whose advertisement is displayed on the display means for the amount that has been reduced. This provides a low-cost and friendly system for the user of the external device.

The foregoing information service system may have an arrangement in which the display management means return a part of profits gained by charging at least to an installation location provider who provides an installation location for the display means.

With the foregoing arrangement, at least the installation location provider for the display means can gain profits from providing the installation location.

The foregoing information service system may have an arrangement in which the display management means return a part of profits gained by charging at least to an installation location provider who provides an installation location for the display means, and carries out the charging to the installation location provider in case where the installation location provider is an advertiser.

With the foregoing arrangement, at least the installation location provider for the display means can gain profits from providing the installation location. On the other hand, in the case where the installation location provider is an advertiser, the charging is carried out to the installation location provider. This makes it possible to properly carry out the return of profits and the charging to the installation location provider.

The foregoing information service system may have an arrangement in which the display management means include a questions storage section for storing questions to a user of the external device, and cause the display means to display the questions when a request for use of the present system is inputted from the external device.

With the foregoing arrangement, when a request for use of the present system is inputted from the external device, the display management means read out questions to the user of the external device from the questions storage section to display the questions on the display means. Therefore, answering of the questions by the user of the external device enables easy collection of valuable information in business activities, such as information on the user of the external device and the user's trend.

The foregoing information service system may have an arrangement in which the display management means, when a request for use of the present system is inputted from the external device, retrieve questions to a user of the external device via the communication network from a request issuer of the questions and cause the display means to display the questions.

With the foregoing arrangement, when a request for use of the present system is inputted from the external device, the display management means retrives questions to a user of the external device via the communication network from a request issuer of the questions and cause the display means to display the questions. Therefore, answering of the questions by the user of the external device enables easy collection of valuable information in business activities, such as information on the user of the external device and the user's trend.

The foregoing information service system may have an arrangement in which the display management means, when a request for use of the present system is inputted from the external device, cause the display means to display questions to a user of the external device, and reduce an amount asked by charging to the user of the external device when answers to the questions can be obtained.

With the foregoing arrangement, when a request for use of the present system is inputted from the external device, the questions to the user of the external device are displayed on the display means by the display management means. Therefore, answering of the questions by the user of the external device enables easy collection of valuable information in business activities, such as information on the user of the external device and the user's trend.

Meanwhile, by answering questions, the user of the external device can get an amount asked by charging reduced. This makes a low-price and friendly system for the user of the external device.

The foregoing information service system may have an arrangement in which the display management means ask a request issuer of the questions for the amount that has been reduced in accordance with answers to the questions.

With the foregoing arrangement, it is possible to properly collect profits from the use of the present system.

The foregoing information service system may have an arrangement in which the display side communicating means communicate with the external device in accordance with IEEE802.11, USB, or IEEE1394 specification.

With the foregoing arrangement, it is possible to easily make connections for communication between the display management means and the external device.

The foregoing information service system may have an arrangement in which between the display management means and the communication network provided are wireless communication means and communication management means for relaying via the wireless communication means between the display management means and the communication network.

With the foregoing arrangement, the display management means are arranged so as to be connected to the communication network via the wireless communication means and the communication management means, so that it is possible to establish the display means and the display management means in the means of transport for transporting, such as airplane, ship, train, and bus. This allows the user of the external device to use the present system in the means of transport, thereby enhancing convenience of the present system.

An information service method of the present invention comprises the steps of: installing display means for displaying information at a place where unspecified number of users each having an external device can use the display means; retrieving information via a communication network, in accordance with a request supplied from the external device; and causing the display means to display the information.

With the foregoing arrangement, the external device does not require large-sized display means which can display information properly. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Another information service method of the present invention comprises the steps of: installing display means for displaying information at a place where unspecified number of users each having an external device can use the display means; retrieving information via a communication network, in accordance with a request supplied from the external device; supplying the information to the external device; and causing the display means to display a process of this processing.

With the foregoing arrangement, the external device does not require large-sized display means which can properly display a process of the processing carried out in accordance with the request from the external device. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Still another information service method of the present invention comprises the steps of: installing display means for displaying information; retrieving information via a communication network, in accordance with a request supplied from the external device; causing the display means to display the information; charging for at least a part of processing which is carried out in accordance with the request from the external device.

With the foregoing arrangement, in the case where information that has been retrieved via the communication network is displayed, the external device does not require large-sized display means which can display information properly. As a result of this, the external device can reduce its size and weight, thereby increasing portability.

Further, charging is carried out for at least a part of processing which is carried out in accordance with the request from the external device, so that it is possible to gain profits from carrying out the foregoing processing.

Yet another information service method of the present invention comprises the steps of: installing display means for displaying information; retrieving information via a communication network, in accordance with a request supplied from the external device; supplying the information to the external device; causing the display means to display a process of this processing; and charging for at least a part of processing which is carried out in accordance with the request from the external device.

With the foregoing arrangement, in the case where information that has been retrieved via the communication network is supplied to the external device, the external device does not require large-sized display means which can properly display a process of the processing carried out in accordance with the request from the external device. As a result of this, the external device can reduce its size and weight, thereby increasing portability.

Further, charging is carried out for at least a part of processing which is carried out in accordance with the request from the external device, so that it is possible to gain profits from carrying out the foregoing processing.

The foregoing information service method may further comprise the steps of: using portable information means as the external device; and retrieving the information from information distributing means for being capable of distributing information via the communication network.

With the foregoing arrangement, it is possible to properly retrieve information from the information distributing means via the communication network in accordance with the request supplied from the portable information means. The portable information means do not require large-sized display means. As a result of this, the portable information means can reduce its size and weight, thereby increasing portability.

The foregoing information service method may have an arrangement in which the information obtained is fee-based information, and the fee-based information is obtained from information distributing means which make a contract for information distribution via the communication network.

With the foregoing arrangement, by previously making a contract for information distribution with selected information distributing means which provide useful fee-based information, the display management means can obtain fee-based information from such display management means. This makes it possible to easily obtain various kinds of high-quality information.

The foregoing information service method may have an arrangement in which the information distributing means exist in plurality, and fee-based information to be obtained is obtained from information distributing means which supply the fee-based information at the lowest price.

With the foregoing arrangement, it is possible to supply useful information to a user of the present system at low prices.

The foregoing information service method may further comprise the step of: causing the display means to display advertisement information while the display means are not used by the external device.

With the foregoing arrangement, while the display means are not used by the external device, an advertiser can take advantage of display operation in the display means effectively for advertising.

The foregoing information service method may further comprise the steps of: causing the display means to display advertisement information while the display means are not used by the external device; and charging an advertiser for display of the advertisement information on the display means.

With the foregoing arrangement, it is possible to properly gain profits from the display of the advertisement information on the display means.

The foregoing information service method may further comprise the steps of: causing the display means to display advertisement information while the display means are not used by the external device; charging an advertiser for display of the advertisement information on the display means; reducing an amount asked by charging to a user of the external device; and asking the advertiser for the amount that has been reduced.

With the foregoing arrangement, while the display means are not used by the external device, an advertiser can take advantage of display operation in the display means effectively for advertising.

Further, in accordance with the advertisement display, an amount asked to the user of the external device is reduced. This provides a low-price and friendly system for the user of the external device.

The foregoing information service method further comprises the step of: causing the display means to display questions to a user of the external device when a request for use of the present system is inputted from the external device.

With the foregoing arrangement, answering of the questions by the user of the external device enables easy collection of valuable information in business activities, such as information on the user of the external device and the user's trend.

The information service method may further comprise the steps of: causing the display means to display questionnaire entries for a user of the external device when a request for use of the present system is inputted from the external device; and reducing an amount asked by charging to the user of the external device when answers to the questions can be obtained.

With the foregoing arrangement, answering of the questions by the user of the external device enables easy collection of valuable information in business activities, such as information on the user of the external device and the user's trend.

Meanwhile, by answering questions, the user of the external device can get an amount asked by charging reduced. This makes a low-price and friendly system for the user of the external device.

The foregoing information service method may further comprise the step of: asking a request issuer of the questions for the amount that has been reduced in accordance with answering to the questions.

With the foregoing arrangement, it is possible to properly collect profits from the use of the present system.

The foregoing information service method may further comprise the step of: retrieving further via wireless communication means, information which is retrieved via the communication network.

With the foregoing arrangement, it is possible to establish the display means in the means of transport for transporting, such as airplane, ship, train, and bus. This allows the user of the external device to use the present system in the means of transport, thereby enhancing convenience of the present system.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram functionally showing the arrangement of an information service system in one embodiment of the present invention.

FIG. 2 is an explanatory view showing one example of a display section shown in FIG. 1.

FIG. 3 is a block diagram specifically showing the arrangement of a display control section shown in FIG. 2.

FIG. 4 is a block diagram specifically showing the arrangement of the information service system shown in FIG. 1.

FIG. 5 is an explanatory view schematically showing an external view of the information service system shown in FIG. 1.

FIG. 6 is a perspective view schematically showing an external view of the case where a display device is provided inside a box in the information service system shown in FIG. 1.

FIG. 7 is a block diagram more specifically showing function parts of a display management device shown in FIG. 1.

FIG. 8 is a block diagram explaining an example of charge processing by a charge processing section shown in FIG. 7, in the case where advertisement display is carried out without using an external network.

FIG. 9 is a block diagram explaining an example of charge processing by a charge processing section shown in FIG. 7, in the case where advertisement display is carried out using an external network.

FIG. 10 is a flowchart showing an operation in the case where a user of a portable information device is charged for the use of a display device by the portable information device in the information service system shown in FIG. 1.

FIG. 11 is a flowchart showing an operation continuing from the operation shown in FIG. 10 in the information service system.

FIG. 12 is an explanatory view showing a display example of a selection screen for fee payment means on a display device, in the operation shown in FIG. 10.

FIG. 13 is a flowchart showing an operation in the case where a user of a portable information device is not charged for the use of a display device by the portable information device in the information service system shown in FIG. 1.

FIG. 14 is an explanatory view schematically showing an external view of an information service system in another embodiment of the present invention.

FIG. 15 is an explanatory view showing the arrangement in which a display device is provided inside a box, in the arrangement of the information service system shown in FIG. 14.

FIG. 16 is a block diagram specifically showing the arrangement of a display management device shown in FIG. 1, in the information service system shown in FIG. 14.

FIG. 17 is a flowchart showing an operation in the case where a user of a portable information device is charged for the use of a display device by the portable information device in the information service system shown in FIG. 14.

FIG. 18 is a flowchart showing an operation continuing from the operation shown in FIG. 17 in the information service system.

FIG. 19 is a flowchart showing an operation in the case where a user of a portable information device is not charged for the use of a display device by the portable information device in the information service system shown in FIG. 14.

FIG. 20(a) is a schematic diagram of the information service system shown in FIG. 1 when it is seen from a system side.

FIG. 20(b) is a schematic diagram of the information service system shown in FIG. 1 when it is seen from a user side of a portable information device.

FIG. 21 is a schematic diagram of the information service system shown in FIG. 1 in which transmitting/receiving sections and internal network sections are given.

FIG. 22 is a block diagram functionally showing the arrangement of an information service system in still another embodiment of the present invention.

FIG. 23 is an explanatory view showing an example of a display section shown in FIG. 22.

FIG. 24 is a block diagram specifically showing the arrangement of a display control section shown in FIG. 23.

FIG. 25 is a block diagram specifically showing the arrangement of the information service system shown in FIG. 22.

FIG. 26 is an explanatory view schematically showing an external view of the information service system shown in FIG. 22.

FIG. 27 is a perspective view schematically showing an external view of the case where a display device is provided inside a box in the information service system shown in FIG. 22.

FIG. 28 is a block diagram more specifically showing function parts of a display management device shown in FIG. 22.

FIG. 29 is a block diagram explaining an example of charge processing by a charge processing section shown in FIG. 28, in the case where advertisement display is carried out using a communication network.

FIG. 30 is a flowchart showing an operation in the case where a user of a portable information device is charged for the use of a display device by the portable information device in the information service system shown in FIG. 22.

FIG. 31 is a flowchart showing an operation continuing from the operation shown in FIG. 30 in the information service system.

FIG. 32 is an explanatory view showing a display example of a selection screen for fee payment means on a display device, in the operation shown in FIG. 30.

FIG. 33 is a flowchart showing an operation in the case where a user of a portable information device is not charged for the use of a display device by the portable information device in the information service system shown in FIG. 22.

FIG. 34 is an explanatory view schematically showing an external view of an information service system in yet another embodiment of the present invention.

FIG. 35 is an explanatory view showing the arrangement in which a display device is provided inside a box, in the arrangement of the information service system shown in FIG. 34.

FIG. 36 is an explanatory view showing the arrangement of one embodiment of the information service system shown in FIG. 34.

FIG. 37 is a block diagram specifically showing the arrangement of a display management device shown in FIG. 1, in the information service system shown in FIG. 34.

FIG. 38 is a flowchart showing an operation in the case where a user of a portable information device is charged for the use of a display device by the portable information device in the information service system shown in FIG. 34.

FIG. 39 is a flowchart showing an operation continuing from the operation shown in FIG. 38 in the information service system.

FIG. 40 is a flowchart showing an operation in the case where a user of a portable information device is not charged for the use of a display device by the portable information device in the information service system shown in FIG. 34.

FIG. 41 is a flowchart showing an operation in the case where the amount charged to a user of a portable information device for the use of a display device is reduced in accordance with answers to a questionnaire, in an information service system of still another embodiment of the present invention.

FIG. 42 is a flowchart showing an operation continuing from the operation shown in FIG. 41 in the information service system.

FIG. 43 is an explanatory view showing an input screen of a request for the use of a display device in the operation shown in FIG. 41.

FIG. 44 is an explanatory view showing a display screen of a questionnaire in the operation shown in FIG. 42.

FIG. 45 is an explanatory view showing a display example of the selection for change to an answer-to-questionnaire screen in the operation shown in FIG. 42.

FIG. 46 is an explanatory view schematically showing an external view of an information service system in still another embodiment of the present invention.

FIG. 47(a) is a schematic diagram of the information service system shown in FIG. 22 when it is seen from a system side.

FIG. 47(b) is a schematic diagram of the information service system shown in FIG. 22 when it is seen from a user side of a portable information device.

FIG. 48 is a schematic diagram of the information service system shown in FIG. 1 in which transmitting/receiving sections and internal network sections are given.

### BEST MODE FOR CARRYING OUT THE INVENTION

[First Embodiment]

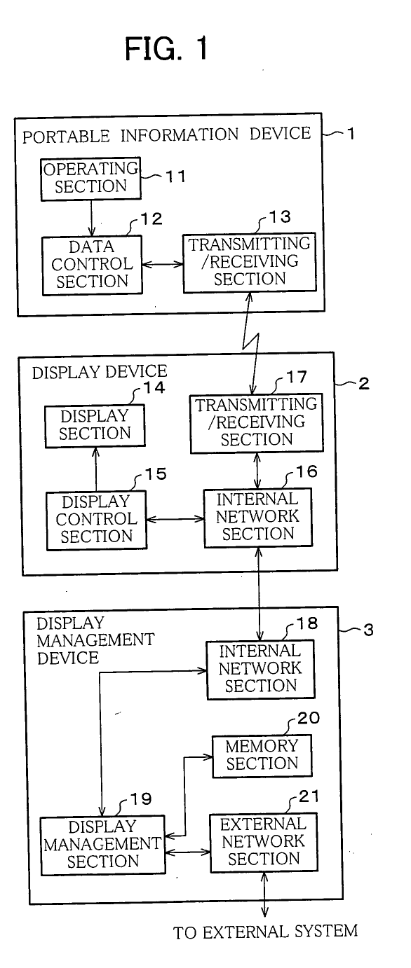

The following will explain one embodiment of the present invention with reference to FIGS. 1 through 13, 20 and 21.

The information service system of the present embodiment, as shown in FIG. 1, includes a portable information device (portable information means) 1, a display device 2, and a display management device (display management means) 3. Further, the display device 2 and the display management device 3 constitute display providing means.

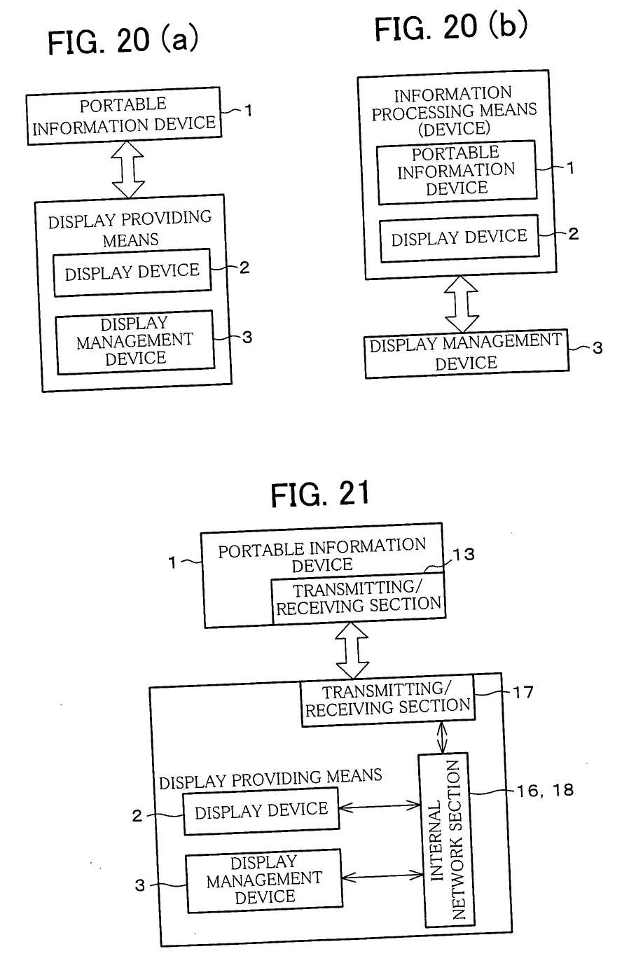

FIG. 1 shows an arrangement of the information service system when it is seen from a system side. On the other hand, when the system is seen from a user side of the portable information device 1, it can be understood as a system in which the portable information device 1 and the display device 2 constitute an information processor similar to a conventional PC, etc. FIG. 20(a) and FIG. 20(b) are easily comparative schematic diagrams showing a difference in a system structure between when it is seen from the foregoing both sides. FIG. 20(a) shows the information service system when it is seen from the system side, and FIG. 20(b) shows the information service system when it is seen from the user of the portable information device 1. FIG. 21 shows a schematic diagram of the system in which transmitting/receiving sections 13 and 17 and internal network sections 16 and 18 are given.

The portable information device 1, which has a portability-conscious, small and light arrangement, holds image data that can be displayed on the display device 2. The display device 2 is available as a display device of the portable information device 1. The display management device 3 manages display operation, etc. of the display device 2. In the present embodiment, the display management device 3 is provided to each of the display devices 2.

The portable information device 1 includes an operating section 11, a data control section 12, the transmitting/receiving sections 13 and a battery section (not shown). The portable information device 1 is, for example, a notebook personal computer (hereinafter, a personal computer is referred to as “PC”), a handheld PC, a pocket PC, a portable telephone, or a portable information terminal.

The operating section 11 has, for example, various input keys for inputting various instructions. The data control section 12 processes data in accordance with the input from the operating section 11 and carries out various control operations in the portable information device 1. The transmitting/receiving section 13 transmits/receives image data and control data to/from the transmitting/receiving section (display side communicating means) 17. Note that, although the portable information device 1 is dispersed with a display section for improving its size and weight reduction, it may include a small display section which does not affect so much on the size and weight reduction for the portable information device 1.

The portable information device 1, as described above, is dispersed with such a large display section that is provided, for example, to the notebook PC. Accordingly, the size and weight of the portable information device 1 is drastically reduced. Therefore, it may be incorporated into a hand baggage such as an attaché case, a bag, or a pouch.

The display device 2, which includes a display section (display means) 14, a display control section (display control means) 15, the internal network section 16, the transmitting/receiving section 17, and a power source section (not shown), displays image data, etc. supplied from the portable information device 1, for example.

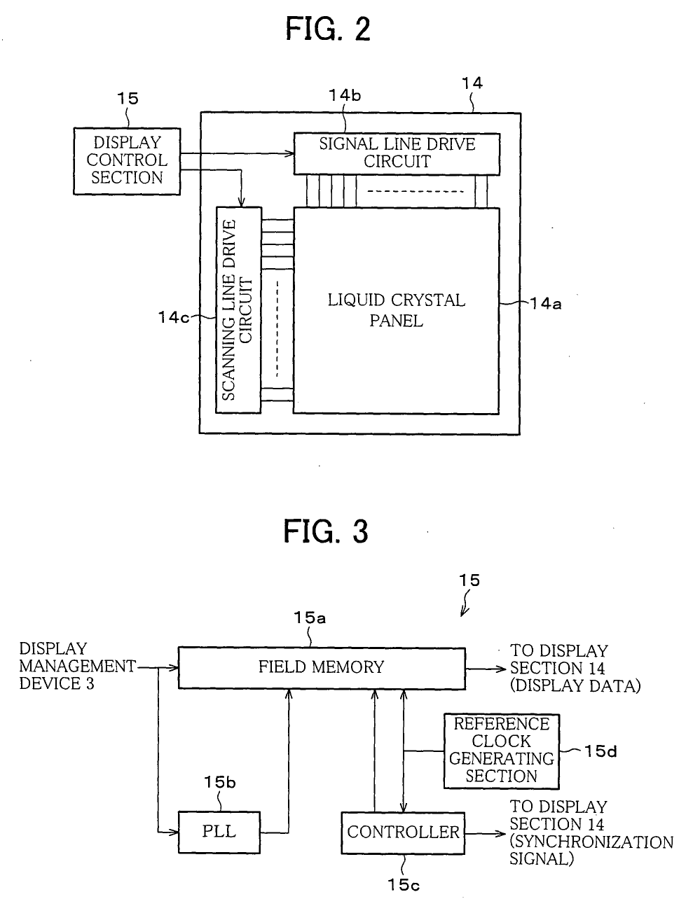

The display section 14, as shown in FIG. 2, includes, for example, a liquid crystal panel 14a, and a signal line drive circuit 14b and a scanning line drive circuit 14c for driving the liquid crystal panel 14a. The liquid crystal panel 14a is, for example, a transmission TFT liquid crystal panel. The transmission TFT liquid crystal panel has a 12-inch screen with 800×RGB×600 pixels and 16 gradation levels. The transmission TFT liquid crystal panel has the same structure as that of a conventional panel. Therefore, the explanation thereof is simplified here.

The transmission TFT liquid crystal panel basically has a structure in which a liquid crystal is sandwiched between glass substrates or plastic substrates, and an array of pixels is formed on one substrate. For driving the transmission liquid crystal panel at a vertical synchronization frequency of 60 Hz, an approximately 346 Mbps of transmission speed is required. However, the transmission speed can be reduced by carrying out a low-frequency drive that is disclosed in Japanese Patent Application No. 2000-131183 filed by the applicant of the present application. For example, when the vertical synchronization frequency is reduced to approximately 1.8 Hz, the transmission speed can be reduced to approximately 1.1 Mbps. Accordingly, in case of transmission of time-series image data, it is possible to display it on the display section 14 at the transmission speed specified by the IEEE802.11, which is described below.

Here, the display section 14 is explained, taking as an example the liquid crystal panel 14a having a 12-inch screen with 800×RGB×600 pixels. However, the display section 14 is a factor that has a significant influence on the determination in the size and shape of the display device 2. Therefore, it is preferable that suitable screen size and number of display pixels for the display section 14 are determined according to an installation location of the display device 2.

Furthermore, in the case where a high-resolution type liquid crystal panel 14a having more display pixels is used for the display section 14, the transmission speed of pixel data (image data) may be increased, or the pixel data may be transmitted in the form of HTML (Hyper Text Markup Language), XML (Extensible Markup Language), or others. Note that, the display section 14 is not necessarily limited to the liquid crystal panel 14a. For example, the display section 14 may be an EL panel. Further, the display section 14 may be a CRT (Cathode Ray Tube), provided that the installation location of the display device 2 has enough space.

The display control section 15 has an interface section which converts supplied image data into a signal suitable for driving a liquid crystal panel 14d (display section 14). The interface section, as shown in FIG. 3, is provided with a field memory 15a, a PLL (Phase Locked Loop) 15b, a controller 15c, and a reference clock generating section 15d. The field memory 15a is capable of storing image data by the volume of one frame.

In the display control section 15, of display data supplied from the display management device 3, video data is supplied to the field memory 15a, and a synchronization signal is supplied to the PLL 15b. In the PLL 15b, a dot clock is generated in accordance with the synchronization signal, and the video data is written in the field memory 15a at the timing of the dot clock. The controller 15c generates the synchronization signal having a timing suitable for driving the display section 14 in accordance with a reference clock supplied from the reference clock generating section 15d to supply the generated synchronization signal to the display section 14, and reads out the video data from the field memory 15a to supply the video data to the display section 14.

The internal network section 16 is connected to an internal network section 18 in the display management device 3 to transmit/receive data to/from the display management device 3. The transmitting/receiving section 17 transmits/receives data to/from the transmitting/receiving section 13 in the portable information device 1.

The display management device 3 is provided with the internal network section 18, a display management section 19, a memory section 20, an external network section 21, and a power source section (not shown). The internal network section 18 is connected via an internal network to the internal network section 16 in the display device 2 for data transmission and reception. Mainly, the display management section 19 manages display operation of the display device 2 and carries out various control operations involved in the display operation. The memory section 20, which is used for processing in the display management section 19, stores data therein. The external network section 21 causes the display management device 3 (display management section 19) to connect via an external network to an external system.

For data transmission and reception via the transmitting/receiving sections 13 and 17 between the portable information device 1 and the display device 2, a wireless interface specified by IEEE802.11 is used for example. The IEEE802.11, which is a widely spreading wireless communication technique, uses 2.4 GHz band. As to the IEEE802.11, an initial version defined transmission speeds as being 1 Mbps and 2 Mbps; however, other version having a transmission speed of 11 Mbps has already begun to spread.

For data transmission and reception by the transmitting/receiving sections 13 and 17, a wired interface specified by USB (Universal Serial Bus) or IEEE1394 (Institute of Electrical and Electronics Engineers 1394) may be used.

Further, for the internal network, LAN (Local Area Network) may be used for example. For the external network, the LAN, the Internet via a general telephone, the Internet via a portable telephone, or the Internet via the LAN may be used, for example.

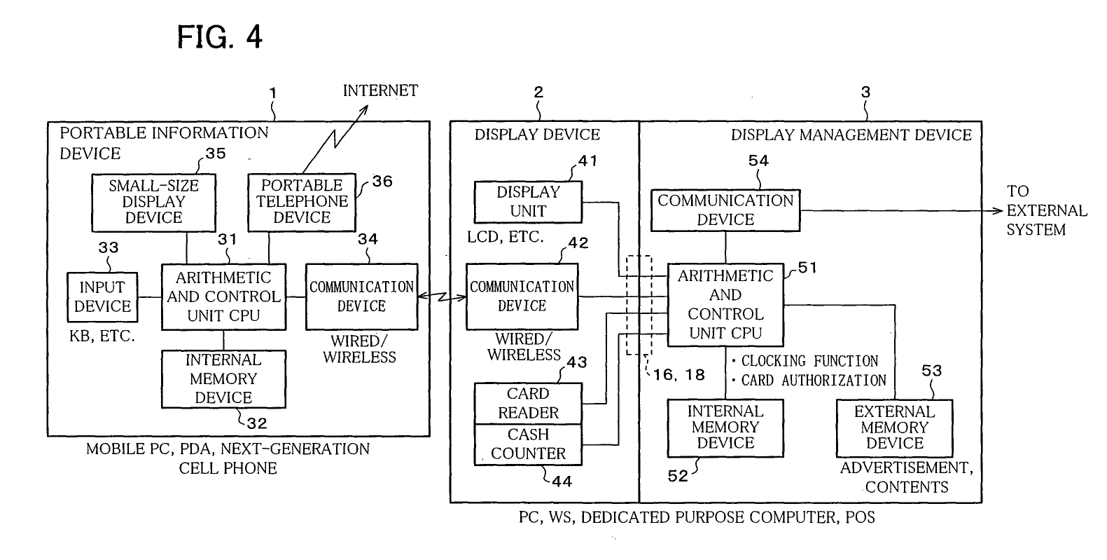

Next, FIG. 4 shows a more specific arrangement of the information service system shown in FIG. 1. Note that, FIG. 4 shows the arrangement in the case where each of the display devices 2 is provided with the display management device 3.

In FIG. 4, the portable information device 1 is provided with an arithmetic and control unit 31 which is a CPU; an internal memory device 32; an input device 33 which is, for example, a small-sized key board; and a communication device 34 which carries out wired or wireless communication with the display device 2. Further, the portable information device 1 may be provided with a small-size display device 35 and an internet-capable portable telephone 36. The small-size display device 35 and portable telephone 36 are suitably provided if necessary. Such a portable information device 1 may be a mobile PC, a PDA, or a next-generation cell phone.

The arithmetic and control unit 31 and the internal memory device 32 constitute the data control section 12 shown in FIG. 1. The input device 33 constitutes the operating section 11, and the communication device 34 constitutes the transmitting/receiving section 13.

Here, the internal memory device 32 is an internal memory of the arithmetic and control unit 31. The internal memory device 32 is also a dedicated memory device of the portable information device 1, which is capable of storing given contents and executing as needed, as a work area of programs and a storing area of data such as image data.

The display device 2 is provided with a display unit 41, a communication device 42, a card reader (fee payment means accepting section) 43, and a cash counter (fee payment means accepting section) 44. The display unit 41 is composed of the display section 14 and the display control section 15. The communication device 42 constitutes the transmitting/receiving section 17. The card reader 43 is a reading device of fee payment means including a credit card, a debit card, a prepaid card, an electric money, or other fee-payment-use card. The cash counter 44 is a calculator of the amount of money put in a cash slot (not shown). The cash slot is provided, for example, on the front surface of the display device 2. The cash counter 44 has a function of deducting a use fee of the display device 2 from the amount put in the cash slot and paying the change.

The display management device 3 includes an arithmetic and control unit 51 which is a CPU, an internal memory device 52, an external memory device 53, and a communication device 54. The arithmetic and control unit 51 constitutes the display management section 19 shown in FIG. 1. The arithmetic and control unit 51 is connected to the display unit 41 in the display device 2, the communication device 42, the card reader 43, the cash counter 44, etc. The arithmetic and control unit 51 serves as a central processing unit as well as controls the internal memory device 52 and the external memory device 53. The internal memory device 52 and the external memory device 53 constitute the memory section 20.

Here, the internal memory device 52, which is an internal memory of the arithmetic and control unit 51, serves as a device which is capable of storing and executing given contents as needed, as a work area of programs and a storing area of data such as image data. Incidentally, the internal memory device 52 does not require an especially large storage capacity because the image data outputted from the portable information device 1 can be stored only in a period during which the portable information device 1 accesses to the display management device 3. Similarly, this is applied to the case where each of the display devices 2 is not provided with the display management device 3.

Meanwhile, the external memory device 53 stores therein advertisement data to be displayed on the display unit 41 (display section 14) and content data supplied to the portable information device 1 according to the request from the portable information device 1. The external memory device 53 transmits and receives data to and from the internal memory device 52 in accordance with the control operation by the arithmetic and control unit 51 so as to cause the advertisement data to be displayed on the display unit 41.

Further, the arithmetic and control unit 51 can cause the internal memory device 32 of the portable information device 1 to store and execute various application software, etc. by communicating with the portable information device 1. Further, the arithmetic and control unit 51 has a function of combining or switching data displayed on the display unit 41 of the display device 2 and the advertisement data, etc. so as to be screen-displayed, according to a program which operates in accordance with control operation by the arithmetic and control unit 31 of the portable information device 1. The communication device 54 constitutes the external network section 21 and causes the display management device 3 to connect to an external system via the external network section 21. Examples of the external system includes an Internet server and a server of a card company dealing a credit card, a debit card, etc.

In the present information service system, the user of the portable information device 1 uses the display device 2 and is suitably charged for the use of the display device 2. Note that, whether charging is carried out or not, a charging price, and others are suitably set according to the usage mode of the display device 2.

Since the display device 2 is used in the above manner, the display device 2 is preferably available to unspecified number of users each carrying the portable information device 1. FIG. 1 shows the case of a minimum structure of the information service system including one display device 2 and one display management device 3 only. However, in view of the above aspect, the display device 2 and the display management device 3 are preferably installed in plurality.

The display device 2 can be installed at any place around the street corner or in a room of a building and a hotel room. The installation location of the display device 2 is not especially limited; however, a place where unspecified number of users can use the display device 2, for example, a public place is preferable. Furthermore, if the installation location of the display device 2 is a place where the users can stay for a certain amount of time period, the availability of the present information service system and the convenience for the user are enhanced further. For example, such a place is a public place including a lobby of a hotel, a waiting room in a station and an air port, a seat on a bullet train, a waiting room in a hospital, a library, a city hall, a book store, a shopping mall, and an inside of a telephone box provided on a sidewalk, etc. or an inside of a box having such a form.

Further, in view of such an installation location, the display device 2 is preferably a thin display such as a liquid crystal display that can save a space. Further, the display management device 3 may have either arrangement in which it is incorporated into the display device 2 or in which it is separated from the display device 2.

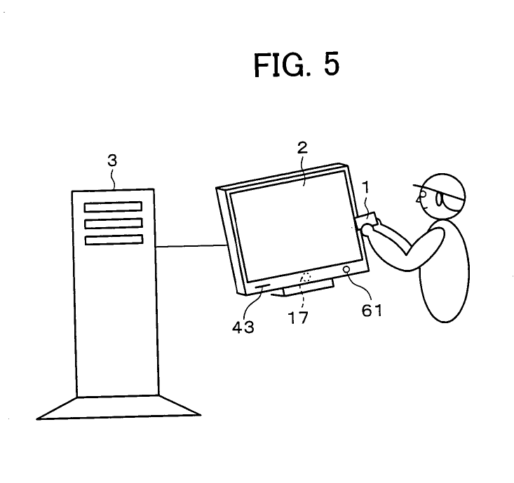

An external view of the information service system is schematically shown in FIG. 5, for example. Here, shown is the arrangement in which the display management device 3 is separated from the display device 2. On the front surface of the display device 2, for example, a card slot of the card reader 43, the transmitting/receiving section 17, and a use permission indicating section 61 are provided. The display device 2 is, if necessary, further provided with a cash slot to a cash counter 44 and various input keys. Note that, the card may be read not only in an arrangement of the card reader 43 integrally incorporated into the display device 2, but also in a mode of reading such as a hand-held bar code reader which is used in POS (Point of Sale), for example.

The above use permission indicating section 61 is, for example, an LED (light-emitting diode), which is lit up if the use of the display device 2 is permitted. The light-up and light-out of the use permission indicating section 61 is controlled by the arithmetic and control unit 51 (display management section 19).

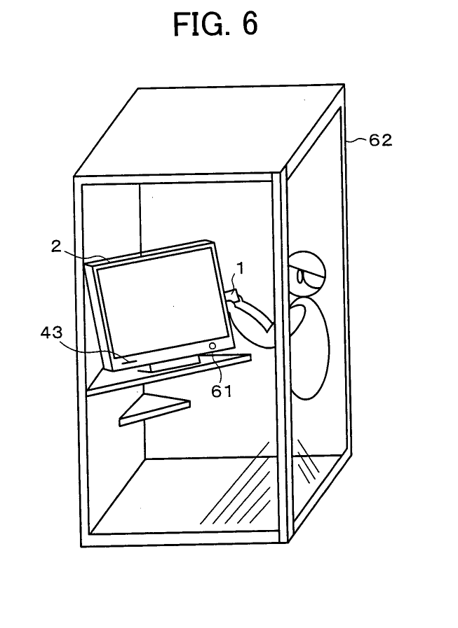

Further, FIG. 6 shows an external view of the case where the display device 2 is provided inside the box 62 as described above. Such a box 62 provided, for example, on the sidewalk and at the stores increases the convenience of using the display device 2.

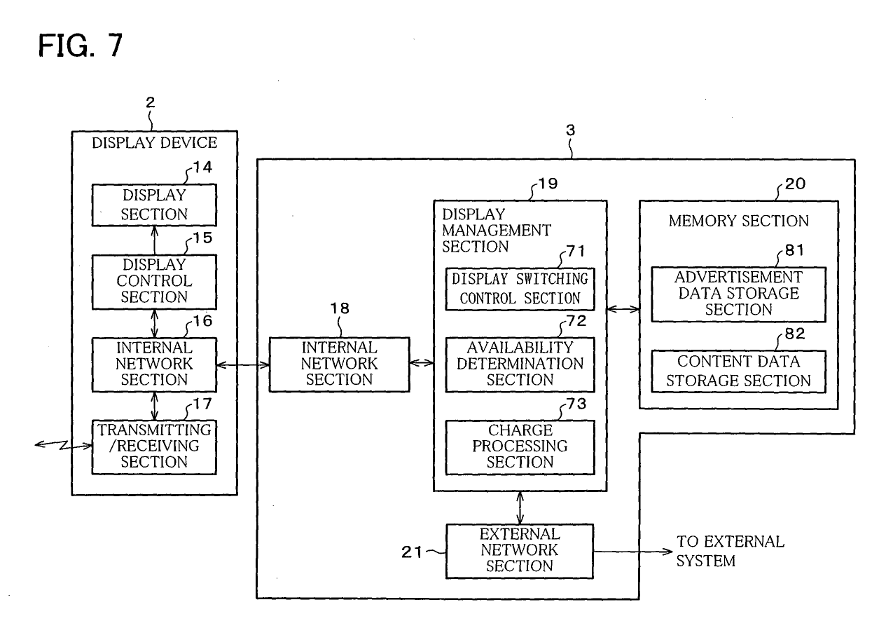

FIG. 7 shows the display management device 3 shown in FIG. 1, in which each function part is more specifically given. More specifically, the display management section 19 has a display switching control section 71, an availability determination section 72, and a charge processing section 73. Further, the memory section 20 has an advertisement data storage section (advertisement information storage section) 81 and a content data storage section (fee-based information storage section) 82.

The display switching control section 71, while the availability determination section 72 does not permit the portable information device 1 to use the display device 2 (while the use of the display device 2 is not requested by the portable information device 1), causes the display device 2 to display the advertisement data stored in the advertisement data storage section 81 described later. Further, the display switching control section 71, when the availability determination section 72 permits the portable information device 1 to use the display device 2, causes the display device 2 to display the image data requested by the portable information device 1, instead of the advertisement data. The advertisement data in such a case may be appeared, for example, on one corner of the screen, in the form of a small image for a banner advertising, etc., without completely removed from the display screen.

Note that, in the case where the display section 14 of the display device 2 is, for example, the liquid crystal 14a, the display switching control section 71 may change a viewing angle on the liquid crystal panel 14a, by its automatic operation or by the user's operation, in switching from the advertisement display to the display of the image data requested by the portable information device 1. More specifically, a wide viewing angle, when the advertisement is displayed, increases an advertising effectiveness. On the other hand, a narrow viewing angle, when the image data requested by the portable information device 1 is displayed, makes it difficult for other people to see the displayed content.

As a result of the card reader 43, for example, shown in FIG. 4 reading the card, when determining that the card is capable of paying a use fee of the display device 2, the availability determination section 72 permits the portable information device 1 to use the display device 2 and causes the use permission indicating section 61 to light on. At this moment, in the case where the card is, for example, a credit card, the availability determination section 72 asks a server of the corresponding card company as an external system via the external network section 21 about whether the card can be charged. The same processing is also carried out in the case where the card is a debit card, an electronic money, or the like.

The charge processing section 73 calculates the use fee for the use of the display device 2 and charges it to the user of the portable information device 1.

The advertisement data storage section 81 stores therein the image data of advertisement displayed on the display device 2. The content data storage section 82 stores therein content data which are useful for the user of the portable information device 1, such as various application programs.

Next, the following will explain an example of a charge processing by the charge processing section 73.

(1) The Case of Displaying an Advertisement Without Using the External Network (An Example of the Advertisement Display (1))

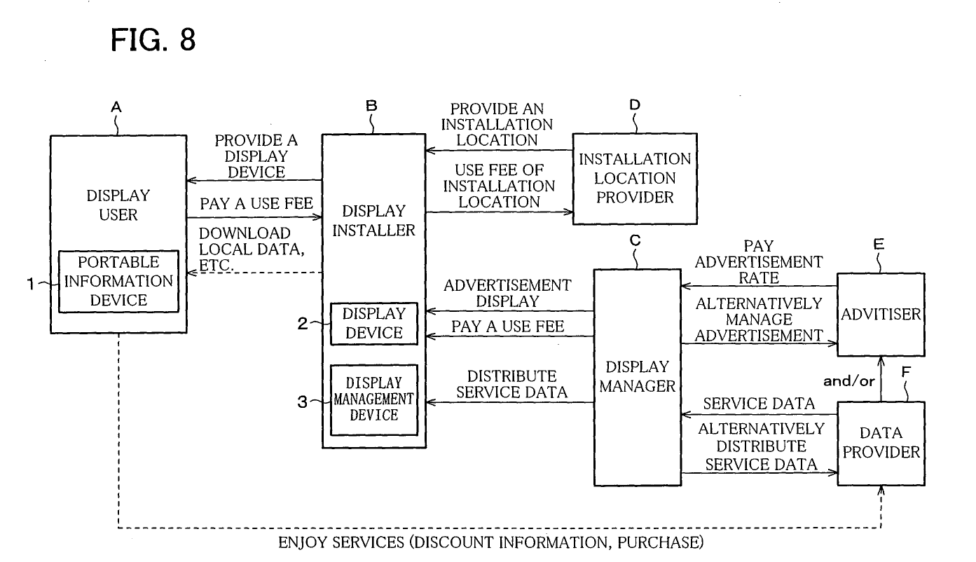

In such a case, as shown in FIG. 8, people involved in the fee calculation are a display user A (a user of the portable information device 1), a display installer B (installer (owner) of the display device 2 and the display management device 3), a display manager C, an installation location provider D, an advertiser E, and a data provider F.

The display installer B gains profits from the display user A using the display device 2. The display manager C is entrusted with the management of the display device 2 by the display installer B. The installation location provider D is a provider of the place where the display device 2 is installed. The advertiser E is a provider of the advertisement displayed on the display device 2. This advertisement is displayed while the display device 2 is not used by the display user A. The data provider F is a provider of useful content data. Note that, the display installer B may serve as the display manager C.

Basically, the charge processing section 73 of the display management device 3 (display installer B) charges for the use of the display device 2 by the portable information device 1 (display user A). The use at this time is, for example, to display the image data on the display device 2 in response to the request for display by the portable information device 1. The image data are data transmitted from the portable information device 1 or content data, such as local data and application data, which are provided by the data provider F and stored in the content data storage section 82 shown in FIG. 7. Examples of the local data include geographical information of the place where the display device 2 is installed and its surroundings, regional information, various information on facilities, information on shops, information on companies, information on events, information on concerts, timetables of public transports, and information on new books. Examples of the information on shops include information on discounting by shops, supermarkets, and restaurants. Further, when the information on events is displayed, admission tickets for the events may be issued. In such a case, the display device 2 is installed with a printer.

The use fee by the display user A at this time is calculated according to a length of time that the display device 2 is used. Further, as to the use of the content data, the fee may be calculated depending on a data capacity or a unit price set for every data.

Further, the use fee at this time may be made free by being borne by the advertiser E, for example, an advertiser, a company, a shop, etc. whose advertisement is included in content data; or by being shared by the former (advertiser E) and the latter (advertiser, etc. of the advertisement included in the content data).

The followings are the methods of charging for the use of the display device 2 by the advertiser E.

(1) The charging is carried out depending on the length of time that the advertisement is displayed on the display device 2. In such a case, for the fee calculation, an area where the advertisement is displayed on the display device 2 (whether the advertisement is displayed with a small image or a normal, large image) is considered. Note that, the display user A bears the amount for the use of the display device 2 by the display user A.

(2) The charging is carried out according to a time period, for example, hours and days for the use of the display device 2, including the amount for the use by the display user A.

The management of the display device 2 and the display management device 3 is alternatively carried out by the display manager C who is entrusted by the display installer B. In such a case, the advertiser E pays a use fee of the display device 2 (advertisement rate) to the display manager C. The display manager C deducts a management fee from the use fee and pays the net amount to the display installer B.

The data provider F supplies content data (service data) to the display manager C, i.e. the display management device 3. This data is stored in the content data storage section 82. Therefore, the display manager C alternatively carries out the distribution of the content data. Further, the data provider F creates advertisement data in accordance with the request from the advertiser E and supplies the created data to the advertiser E.

Further, the display installer B pays to the installation location provider D, a use fee for the use of the installation location for the display device 2 and the display management device 3. The use fee includes, for example, a given amount determined previously by a contract, or an amount calculated according to the percentage in the display installer B's profits gained from the charging.

Note that, in the case where the advertiser E is the installation location provider D, the display installer B can collect an advertisement rate (the use fee of the display device 2 for the purpose of displaying the advertisement) from the advertiser E without paying the use fee for the use of the installation location.

(2) The Case of Displaying an Advertisement Using the External Network (An Example of the Advertisement Display (2))

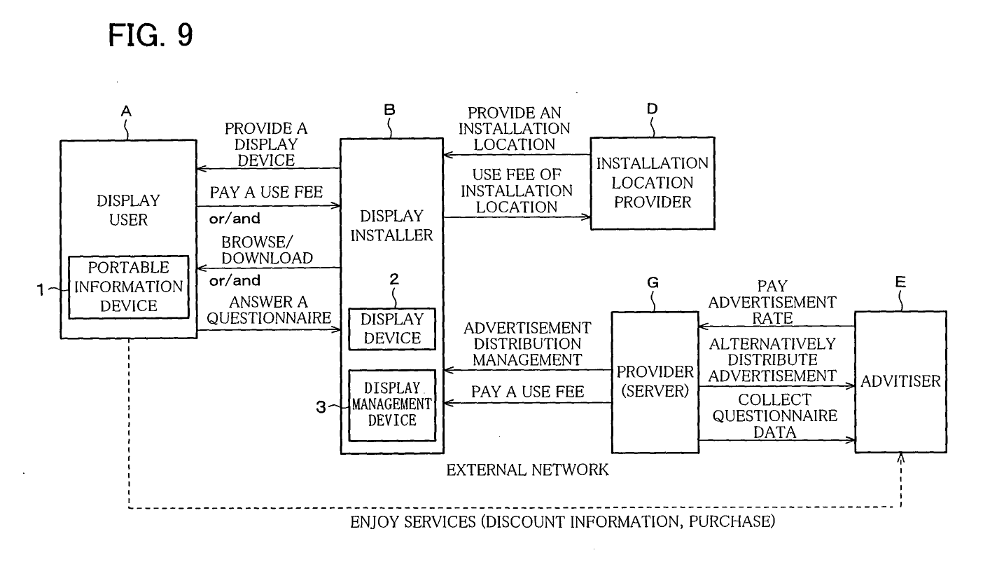

In such a case, as shown in FIG. 9, people involved for a fee calculation are a display user A (a user of the portable information device 1), a display installer B (installer (owner) of the display device 2 and the display management device 3), a provider (server) G, an installation location provider D of the display device 2, and a advertiser E.

The provider G, which corresponds to one of the external system shown in FIGS. 1 and 4, alternatively delivers the advertisement in response to the payment of the advertisement rate from the advertiser E. The provider G transmits the advertisement to the display management device 3 in response to the request from the display switching control section 71 in the display management device 3. This advertisement is supplied via the external network, e.g. the Internet, to the display management device 3, and then, the advertisement is displayed on the display device 2. The advertisement rate is paid via the provider G from the advertiser E to the display manager C.

Further, at the time of the use of the display device 2 by the display user A, questions from the advertiser E are first displayed on the screen. The answers to the questions by the display user A are sent to the advertiser E via the display management device 3, the external network, and the provider G.

The charging method and mode other than the foregoing description are the same as those described in the example of advertisement display (1). Note that, the questionnaire is here conducted by the advertiser E. In the case where the display user A bears the use fee for the use of the display device 2 by the display user A, it may be arranged such that the use fee is reduced for the display user A who answers the questionnaire, and the advertiser E bears the amount that has been reduced.

In the above arrangement, the following will explain the operation of the present information service system.

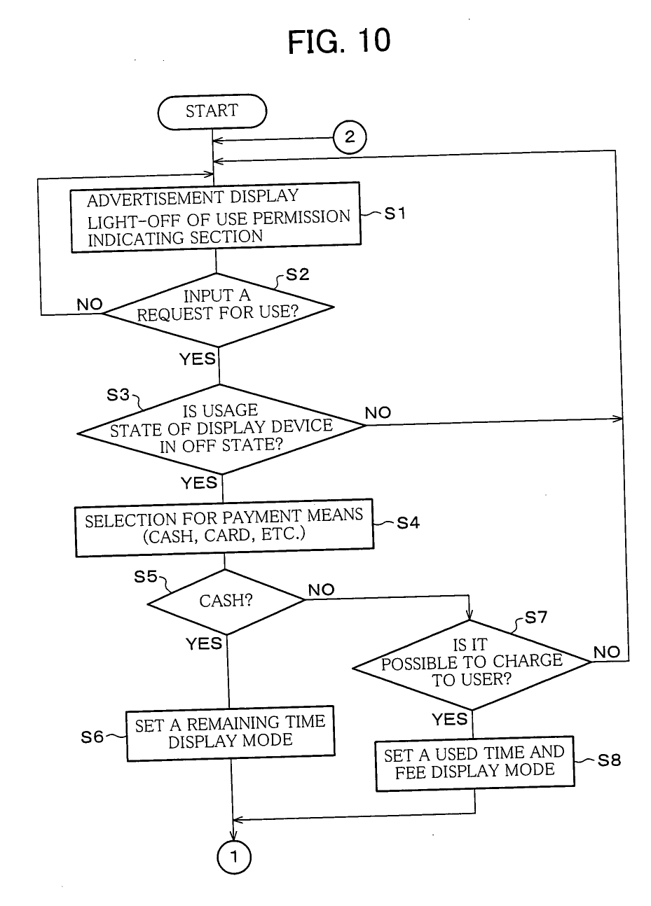

First, in the information service system, the operation in the case where the user of the portable information device 1 is charged for the use of the display device 2 by the portable information device 1 will be explained with reference to flow charts of FIGS. 10 and 11 and FIG. 12.

First, as shown in FIG. 10, the display switching control section 71 of the display management section 19 in the display management device 3 (see FIG. 7) causes the display device 2 to display the advertisement. At this moment, the use permission indicating section 61 (see FIG. 5) is in a light-off state (S1). The advertisement data displayed at this moment are data stored previously in the advertisement data storage section 81 of the memory section 20, or data supplied via the external network from the provider G to the display management device 3, in the arrangement shown in FIG. 9.

In this state, when the request for the use of the display device 2 (a request for occupancy) is supplied from the portable information device 1 (S2), the display switching control section 71 determines whether the usage state of the display device 2 is in OFF state, that is, whether the display device 2 is not currently used by other portable information device 1 (whether the advertisement is being displayed) (S3).

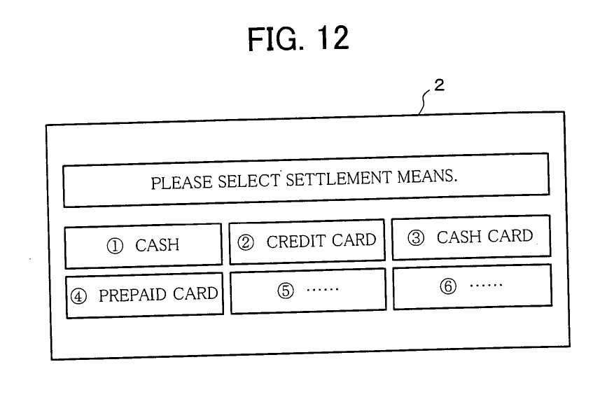

As a result of the determination, when the usage state of the display device 2 is in OFF state, the display switching control section 71, as shown in FIG. 12, causes the display device 2 to display a selection screen showing payment means for the use fee of the display device 2 (settlement means) and requests the user to select the payment means (S4).

Here, the payment means is selected by inputting a number attached to the respective menu of the displayed payment means, or by touching the displayed part of the menu (in the case where the display device 2 has a function of touch panel).

At this moment, for example, when cash is selected (S5), cash is inserted into a cash slot (not shown) of the display device 2, the cash counter 44 (see FIG. 4) counts the cash inserted. In accordance with the result of the counting, the arithmetic and control unit 51 of the display management device 3, i.e. the availability determination section 72 (see FIG. 7) calculates a remaining time (available time) corresponding to a balance and sets a mode to cause the display device 2 to display the remaining time (S6).

Further, at S5, when any card is selected other than the cash, and the selected card is inserted into the card reader 43 of the display device 2 (see FIG. 5), the card reader 43 reads out information in the card. In accordance with the result of reading, the arithmetic and control unit 51 of the display management device 3 (see FIG. 4), i.e. the availability determination section 72 (see FIG. 7) determines whether it is possible to charge the user (S7). More specifically, in accordance with the information which is written in the card, the availability determination section 72 determines the presence or absence of the balance in the card, or asks a card company about the presence or absence of the balance in the card, etc. via the external network, and then, determines whether the user's card can be charged.

As a result of the determination, if the portable information device 1 can use the display device 2, the availability determination section 72 sets a mode to cause the display device 2 to display the integral of the used time and the corresponding integral charge (S8). On the other hand, as a result of the above determination, if the portable information device 1 cannot use the display device 2, the procedure goes back to S1, and the advertisement display is continued.

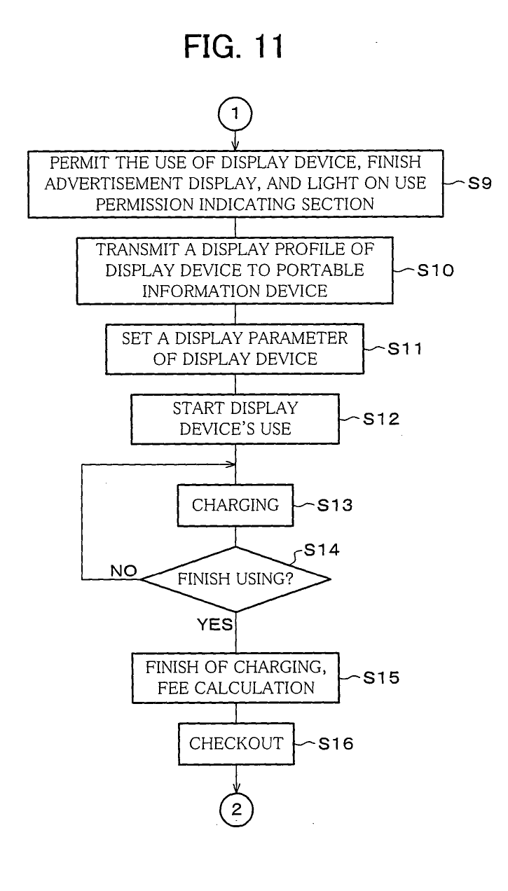

Next, thereafter, if the portable information device 1 can use the display device 2, as shown in FIG. 11, the availability determination section 72 permits the use of the display device 2 and causes the use permission indicating section 61 to light on, so as to let the user of the portable information device 1 know that the display device 2 is available. Further, the display switching control section 71 finishes the advertisement display on the display device 2 (S9). Note that, the display switching control section 71 at this moment may be arranged so that the advertisement is appeared on one corner of the screen in the form of a small image for a banner advertising, etc., without completely finishing the advertisement display.

Then, the display switching control section 71, as a process for the availability of the display device 2 by the portable information device 1, transmits to the portable information device 1 a profile (display profile) which is necessary for the display on the display device 2 (S10). The portable information device 1, which has received the profile, makes a display setting for the screen of the display device 2 according to the display profile (S11).

Next, the display switching control section 71 in the display management device 3, in response to the supply of the image data from the portable information device 1, causes the display device 2 to display the supplied image data (S12). Then, the charge processing section 73 starts charging for the use of the display device 2 by the portable information device 1 (S13).

Thereafter, the display switching control section 71 observes whether the portable information device 1 has finished using the display device 2 (S14). Note that, the use of the display device 2 is finished in accordance with, for example, a use finishing operation carried out by the user of the portable information device 1 in the operating section 11 of the portable information device 1, lack of the balance for the use of the display device 2, the user's touch of a use finishing section provided on the display device 2, or no access for a given time period from the portable information device 1 to the display device 2. Note that, the lack of the balance is detected by the charge processing section 73.

At S14, when the display switching control section 71 detects that the portable information device 1 has finished using the display device 2, the charge processing section 73 finishes charging and calculates the use fee of the display device 2 (S15). Then, checkout processing is performed (S16). At this moment, in case of payment by cash with change occurred, the charge processing section 73 makes change. In case of payment by card, checkout processing is performed suitably according to the type of the card. Thereafter, the procedure goes back to S1, and the display switching control section 71 restarts the advertisement display on the display device 2.

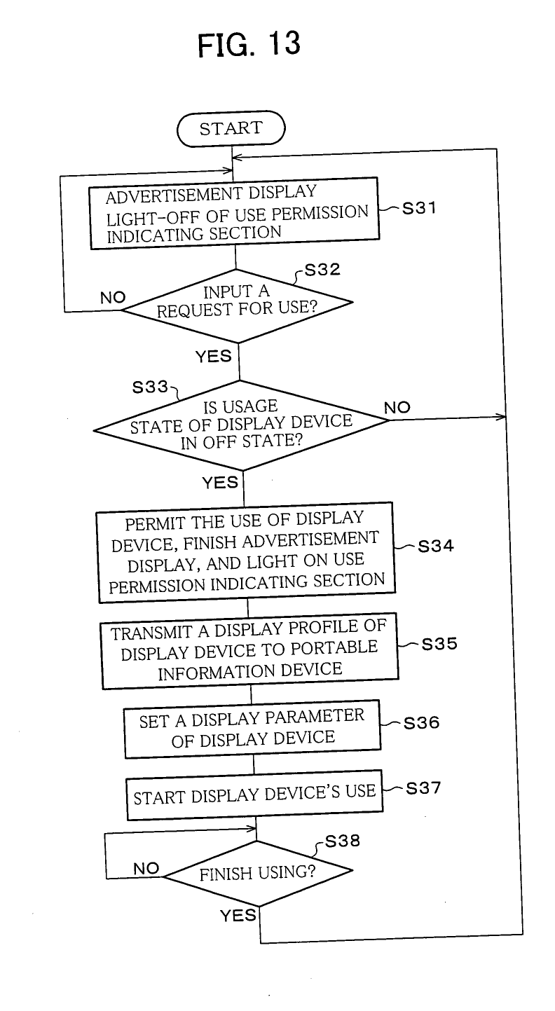

Next, in the information service system, the operation in the case where the user of the portable information device 1 is not charged for the use of the display device 2 by the portable information device 1 with reference to a flow chart of FIG. 13.

First, the display switching control section 71 of the display management section 19 in the display management device 3 (see FIG. 7) causes the display device 2 to display the advertisement. At this moment, the use permission indicating section 61 (see FIG. 5) is in a light-off state (S31). The advertisement data displayed at this moment are data stored previously in the advertisement data storage section 81 of the memory section 20, or data supplied via the external network from the provider G to the display management device 3, in the arrangement shown in FIG. 9.

In this state, when the request for the use of the display device 2 (a request for occupancy) is supplied from the portable information device 1 (S32), the display switching control section 71 determines whether the usage state of the display device 2 is in OFF state, that is, whether the display device 2 is not currently used by other portable information device 1 (whether the advertisement is being displayed) (S33).

As a result of the determination, when the usage state of the display device 2 is in OFF state, the availability determination section 72 permits the use of the display device 2 and causes the use permission indicating section 61 to light on, so as to let the user of the portable information device 1 know that the display device 2 is available. Further, the display switching control section 71 finishes the advertisement display on the display device 2 (S34). Note that, the display switching control section 71 at this moment may be arranged so that the advertisement is appeared on one corner of the screen in the form of a small image for a banner advertising, etc., without completely finishing the advertisement display.

Then, the display switching control section 71, as a process for the availability of the display device 2 by the portable information device 1, transmits to the portable information device 1 a profile (display profile) which is necessary for the display on the display device 2 (S35). The portable information device 1, which has received the profile, makes a display setting for the screen of the display device 2 according to the display profile (S36).

Next, the display switching control section 71 in the display management device 3, in response to the supply of the image data from the portable information device 1, causes the display device 2 to display the supplied image data (S 37).

Thereafter, the display switching control section 71 observes whether the portable information device 1 has finished using the display device 2 (S38). Note that, the use of the display device 2 is finished in accordance with, for example, a use finishing operation carried out by the user of the portable information device 1 in the operating section 11 of the portable information device 1, the user's touch of a use finishing section provided on the display device 2, or no access for a given time period from the portable information device 1 to the display device 2.

At S38, when the display switching control section 71 detects that the portable information device 1 has finished using the display device 2, the procedure goes back to S31, and the display switching control section 71 restarts the advertisement display on the display device 2.

In this process, as described above, the charge processing section 73 does not carry out the charge processing for the use of the display device 2 by the portable information device 1. However, for the advertisement display on the display device 2, the charge processing is carried out in accordance with the contract with the advertiser E. Therefore, in the case where the use fee by the portable information device 1 is asked to the advertiser E, the charge processing section 73 carries out the charge processing for the use fee to the advertiser E. Further, in the case of a period contract with the advertiser E, the calculation processing is carried out suitably for various fees according to the contract.

[Second Embodiment]

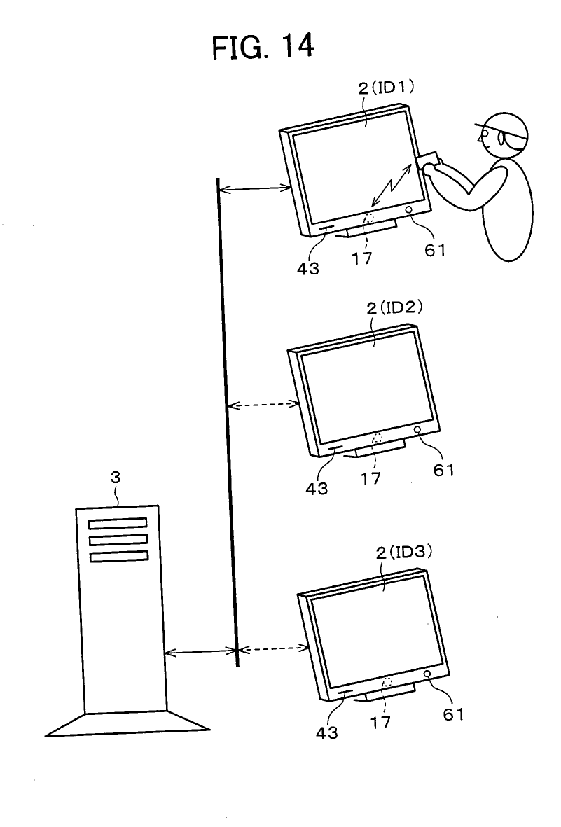

The following will explain another embodiment of the present invention with reference to FIGS. 14 through 19. Note that, for the purpose of explanation, means having the same functions as the foregoing means are given the same reference numerals and explanations thereof are omitted here.

An information service system of the present embodiment has a basic arrangement shown in FIG. 1. As shown in FIG. 14, one display management device 3 manages a plurality of display devices 2 which are connected to the display management device 3. Therefore, for example, in an arrangement in which the display device 2 is provided inside a box 62, as shown in FIG. 6, the display device 2 and the display management device 3 in the present information service system are the ones shown in FIG. 15.

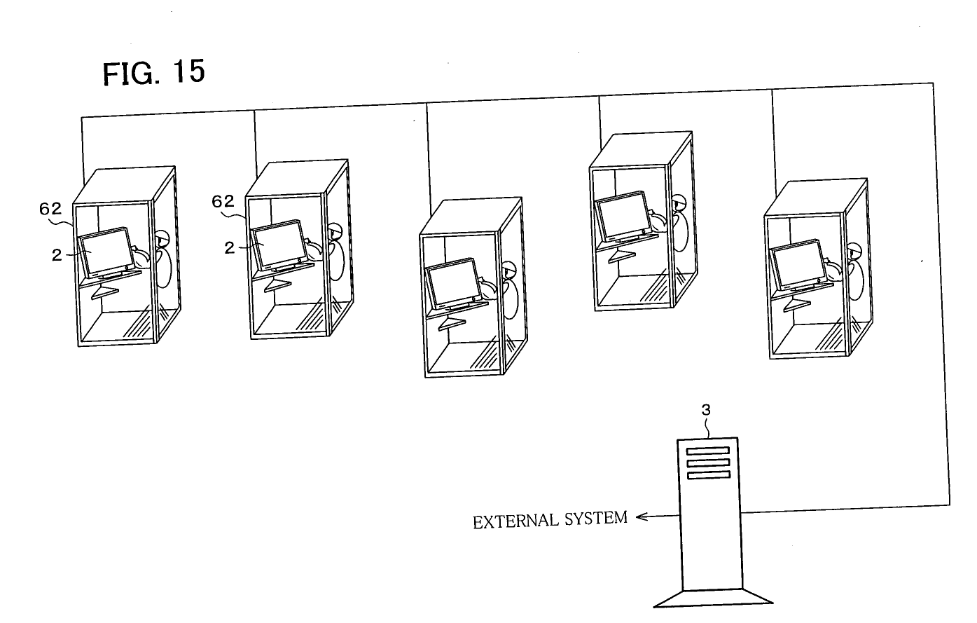

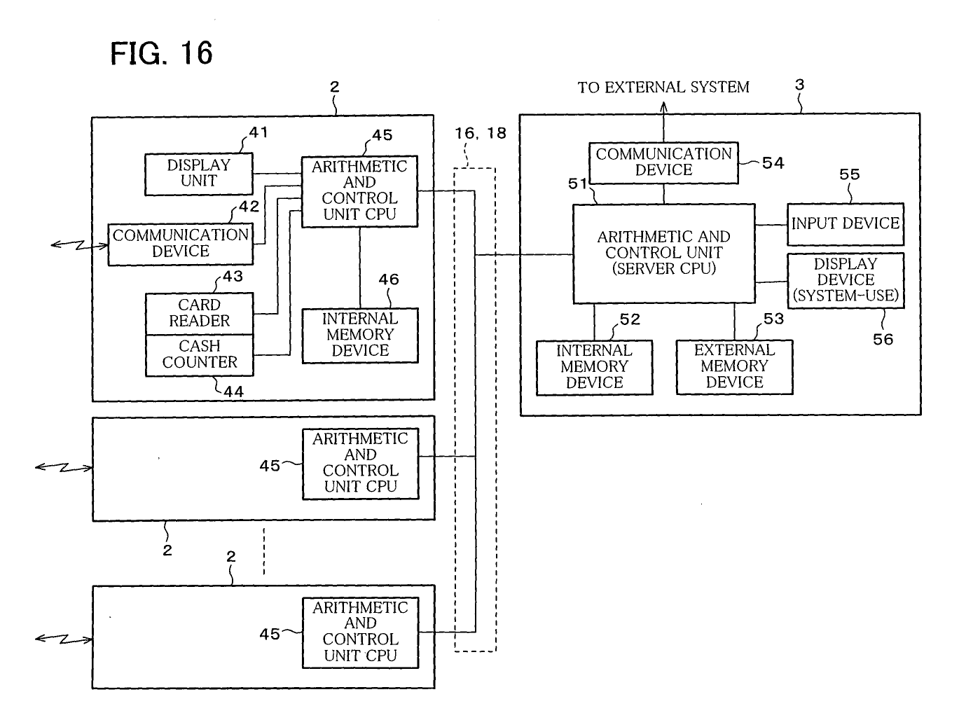

A specific arrangement of the information service system is shown in FIG. 16. Note that, description of a portable information device 1 is omitted here because the portable information device 1 is the same as that shown in FIG. 4.

In FIG. 16, the display device 2 includes a display unit 41, a communication device 42, a card reader 43, a cash counter 44, an arithmetic and control unit 45, and an internal memory device 46.

In the present embodiment, the display unit 41 constitutes a display section 14 shown in FIG. 1, and the communication device 42 constitutes a transmitting/receiving section 17. The arithmetic and control unit 45, which constitutes a display control section 15, communicates with an arithmetic and control unit 51 of the display management device 3 so as to control the whole display device 2.

The display management device 3 includes an internal memory device 52, an external memory device 53, and a communication device 54, which are provided in the display management device 3 shown in FIG. 4. Further, the display management device 3 includes an input device 55 for inputting various instructions, and a display device 56 for system monitoring.

The external memory device 53 stores therein data on advertisement for displaying on the display unit 41 (display section 14) and data on the contents supplied to the portable information device 1 in response to the request from the portable information device 1. The communication device 54 constitutes an external network section 21 and causes the display management device 3 to connect to an external system via the external network. The external system is a server such as an Internet server, or a server of a card company dealing a credit card or a debit card, for example.

In the above arrangement, the following will explain the operation of the present information service system.

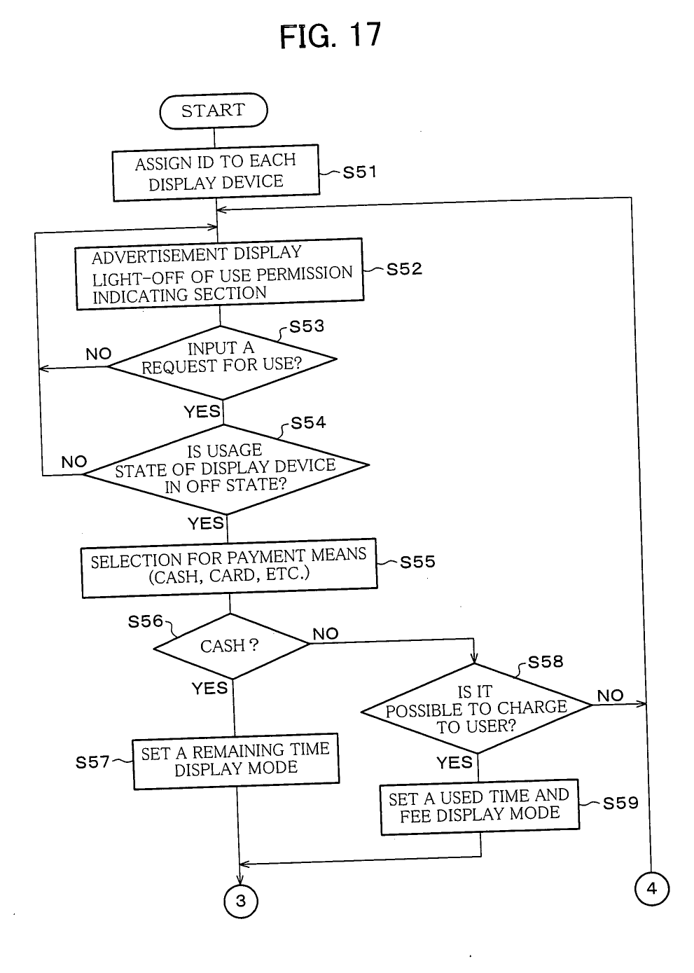

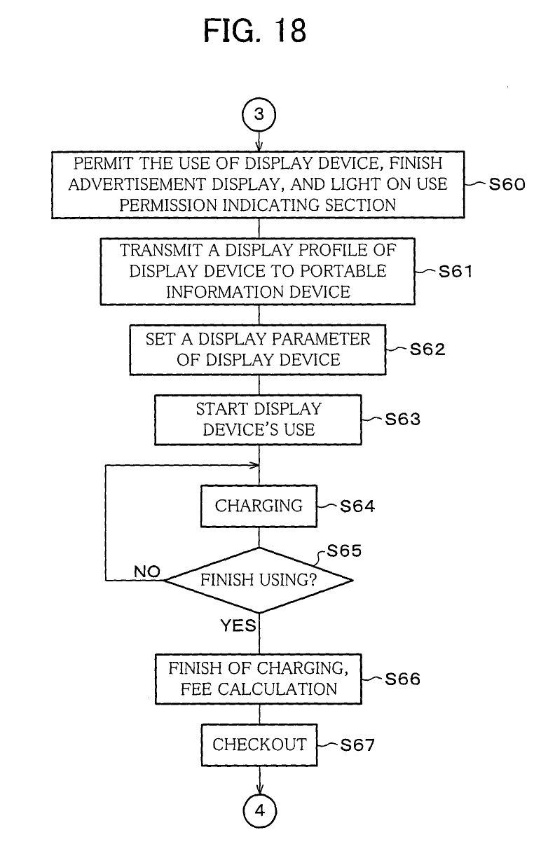

First, the operation in the case where the user of the portable information device 1 is charged for the use of the display device 2 by the portable information device 1 will be explained with reference to flow charts of FIGS. 17 and 18.

As shown in FIG. 17, the display switching control section 71 in the display management device 3 (see FIG. 7) previously assigns IDs to each of the display devices 2 which are connected to the display management device 3 (S51). With these IDs, the display management device 3 manages the plurality of display devices 2.

In this state, first, the display switching control section 71 causes each of the display devices 2 to display the advertisement. At this moment, the respective use permission indicating sections 61 (see FIG. 14) are in a light-off state (S52). The advertisement data displayed at this moment are data stored previously in an advertisement data storage section 81 of a memory section 20, or data supplied via the external network from a provider G to the display management device 3, in the arrangement shown in FIG. 9.

Next, when the request for the use of the display device 2 (a request for occupancy) is supplied from the portable information device 1 to any one of the display devices 2 (S53), the display control section 15 in the display device 2 transmits this information with ID information to the display management device 3. The display switching control section 71 in the display management device 3 determines whether the usage state of the display device 2 which is assigned the ID is in OFF state, that is, whether the display device 2 which is assigned the ID is not currently used by other portable information device 1 (whether the advertisement is being displayed) (S54).

As a result of the determination, when the usage state of the display device 2 is in OFF state, the display switching control section 71, as shown in FIG. 12, causes the display device 2 to display a selection screen showing payment means for the use fee of the display device 2 (settlement means) and requests the user to select the payment means (S55). Note that, a selection method is as described previously.

At this moment, for example, when cash is selected (S56), cash is inserted into a cash slot (not shown) of the display device 2, the cash counter 44 (see FIG. 16) counts the cash inserted. In accordance with the result of the counting, the arithmetic and control unit 51 of the display management device 3, i.e. the availability determination section 72 (see FIG. 7) calculates a remaining time (available time) corresponding to a balance and sets a mode to cause the display device 2 to display the remaining time (S57).

Further, at S56, when any card is selected other than the cash, and the selected card is inserted into the card reader 43 of the display device 2 (see FIG. 14), the card reader 43 reads out information in the card. In accordance with the result of reading, the arithmetic and control unit 51 of the display management device 3 (see FIG. 16), i.e. the availability determination section 72 (see FIG. 7) determines whether it is possible to charge the user (S58). More specifically, in accordance with the information which is written in the card, the availability determination section 72 determines the presence or absence of the balance in the card, or asks a card company about the presence or absence of the balance in the card, etc. via the external network, and then, determines whether the user's card can be charged.

As a result of the determination, if the portable information device 1 can use the display device 2, the availability determination section 72 sets a mode to cause the display device 2 to display a used time and the corresponding integral charge (S59). On the other hand, as a result of the above determination, if the portable information device 1 cannot use the display device 2, the procedure goes back to S52.

Next, thereafter, if the portable information device 1 can use the display device 2, as shown in FIG. 18, the availability determination section 72 permits the use of the display device 2 and causes the use permission indicating section 61 to light on, so as to let the user of the portable information device 1 know that the display device 2 is available. Further, the display switching control section 71 finishes the advertisement display on the display device 2 (S60). Note that, as described previously, the advertisement may be appeared in the form of a small image for a banner advertising, etc.

Then, the display switching control section 71, as a process for the availability of the display device 2 by the portable information device 1, transmits to the portable information device 1 a profile (display profile) which is necessary for the display on the display device 2 (S61). The portable information device 1, which has received the profile, makes a display setting for the screen of the display device 2 according to the display profile (S62).

Next, the display switching control section 71 in the display management device 3, in response to the supply of the image data from the portable information device 1, causes the display device 2 to display the supplied image data (S63). Then, the charge processing section 73 starts charging for the use of the display device 2 by the portable information device 1 (S64).

Thereafter, the display switching control section 71 observes whether the portable information device 1 have finished using the display device 2 (S65). Note that, finishing the use of the display device 2 is as described previously.

At S65, when the display switching control section 71 detects that the portable information device 1 has finished using the display device 2, the charge processing section 73 finishes charging and calculates the use fee of the display device 2 (S66). Then, checkout processing is performed (S67). At this moment, in case of payment by cash with change occurred, the charge processing section 73 makes change. In case of payment by card, checkout processing is performed suitably according to the type of the card. Thereafter, the procedure goes back to S52, and the display switching control section 71 restarts the advertisement display on the display device 2.

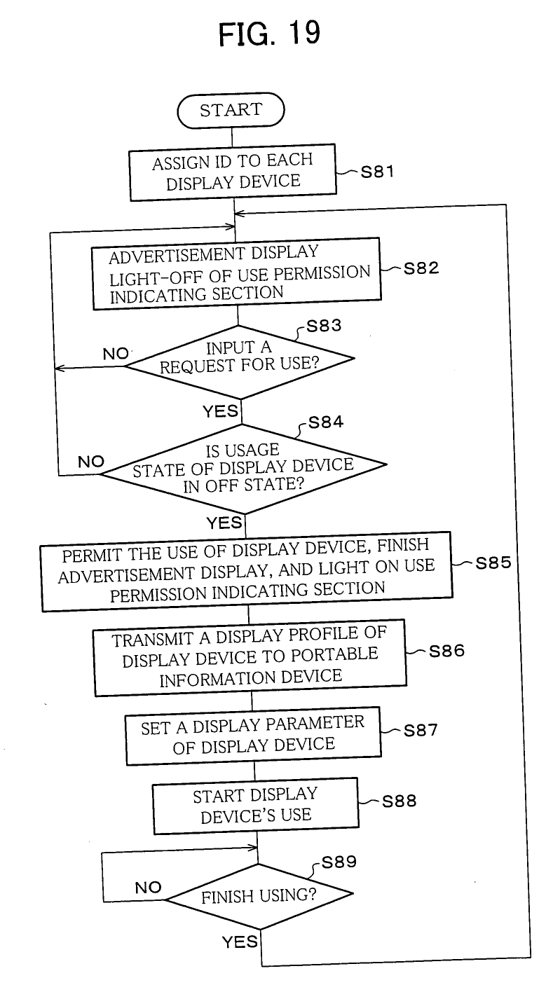

Next, in the information service system, the operation in the case where the user of the portable information device 1 is not charged for the use of the display device 2 by the portable information device 1 with reference to a flow chart of FIG. 19.

The display switching control section 71 in the display management device 3 (see FIG. 7) previously assigns IDs to each of the display devices 2 which are connected to the display management device 3 (S81). With these IDs, the display management device 3 manages the plurality of display devices 2.

In this state, the display switching control section 71 causes each of the display devices 2 to display the advertisement. At this moment, the respective use permission indicating sections 61 (see FIG. 14) are in a light-off state (S82).

In this state, when the request for the use of the display device 2 (a request for occupancy) is supplied from the portable information device 1 to any one of the display devices 2 (S83), the display control section 15 in the display device 2 transmits this information with ID information to the display management device 3. The display switching control section 71 in the display management device 3 determines whether the usage state of the display device 2 which is assigned the ID is in OFF state, that is, whether the display device 2 is not currently used by other portable information device 1 (whether the advertisement is being displayed) (S84).

As a result of the determination, when the usage state of the display device 2 is in OFF state, the availability determination section 72 permits the use of the display device 2 and causes the use permission indicating section 61 to light on, so as to let the user of the portable information device 1 know that the display device 2 is available. Further, the display switching control section 71 finishes the advertisement display on the display device 2 (S85). Note that, as described previously, the advertisement may be appeared in the form of a small image for a banner advertising, etc.

Then, the display switching control section 71, as a process for the availability of the display device 2 by the portable information device 1, transmits to the portable information device 1 a profile (display profile) which is necessary for the display on the display device 2 (S86). The portable information device 1, which has received the profile, makes a display setting for the screen of the display device 2 according to the display profile (S87).

Next, the display switching control section 71 in the display management device 3, in response to the supply of the image data from the portable information device 1, causes the display device 2 to display the supplied image data (S 88).

Thereafter, the display switching control section 71 observes whether the portable information device 1 has finished using the display device 2 (S89). Note that, finishing the use of the display device 2 is as described previously.

At S89, when the display switching control section 71 detects that the portable information device 1 has finished using the display device 2, the procedure goes back to S82, and the display switching control section 71 restarts the advertisement display on the display device 2.

In this process, as described above, the charge processing section 73 does not carry out the charge processing for the use of the display device 2 by the portable information device 1. However, for the advertisement display on the display device 2, the charge processing is carried out in accordance with the contract with the advertiser E. In the case where the use fee by the portable information device 1 is asked to the advertiser E, the charge processing section 73 carries out the charge processing for the use fee to the advertiser E. Further, in the case of a period contract with the advertiser E, the calculation processing is carried out suitably for various fees according to the contract.

As described above, the information service system of the present invention makes it possible for the portable information device 1 to use any one of the display devices 2, which are located in any places such as the street corners, for example. Therefore, in the information service system, the portable information device 1 itself does not have to be provided with a display device, so that it is possible to promote a small and light portable information device 1. Further, the display device 2, which does not have to be carried with the portable information device 1, can increase to a large-sized screen. This allows the user of the portable information device 1 such as a PC to operate the portable information device 1 while looking at a large screen in visiting places and means of transport (for example, in the case where the display device 2 is provided to the seat of a vehicle), without limitation to the display device which is equipped with the portable information device 1.

Thus, the present information service system is a convenient system for the user of the portable information device 1 and a system to provide an effective advertising medium for the advertiser who uses the display device 2 for the purpose of the advertisement display. Further, by charging to the user of the portable information device 1 and the advertiser, profits can be increased properly.

[Third Embodiment]

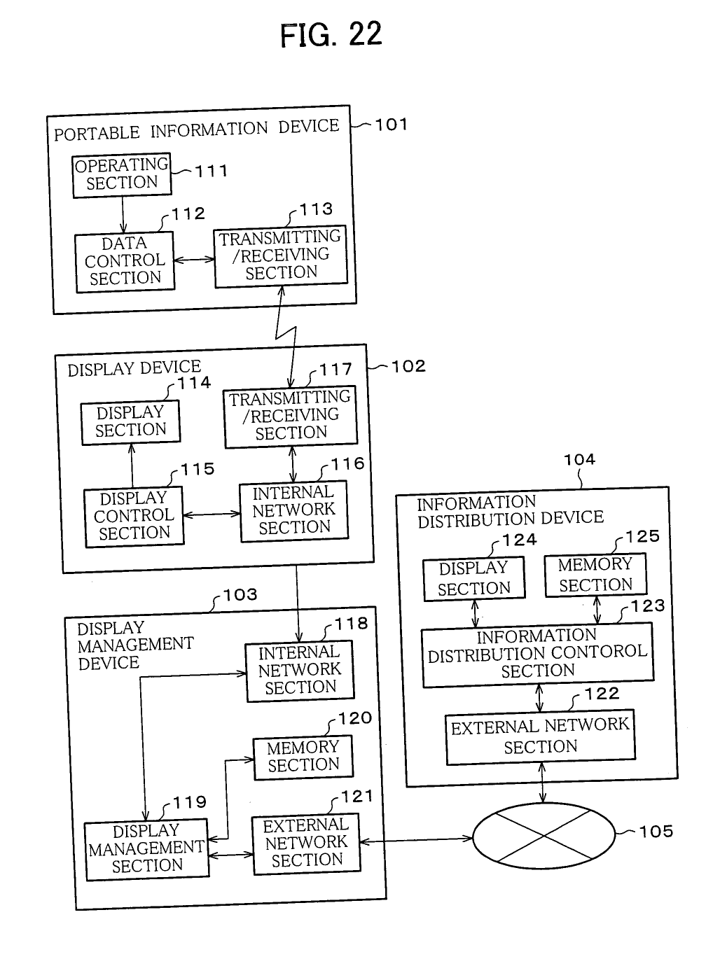

The following will explain still another embodiment of the present invention with reference to FIGS. 22 through 33, FIG. 47, and FIG. 48.

The information service system of the present embodiment, as shown in FIG. 22, includes a portable information device (portable information means, external device) 101, a display device 102, a display management device (display management means) 103, and an information distribution device (information distributing means) 104.

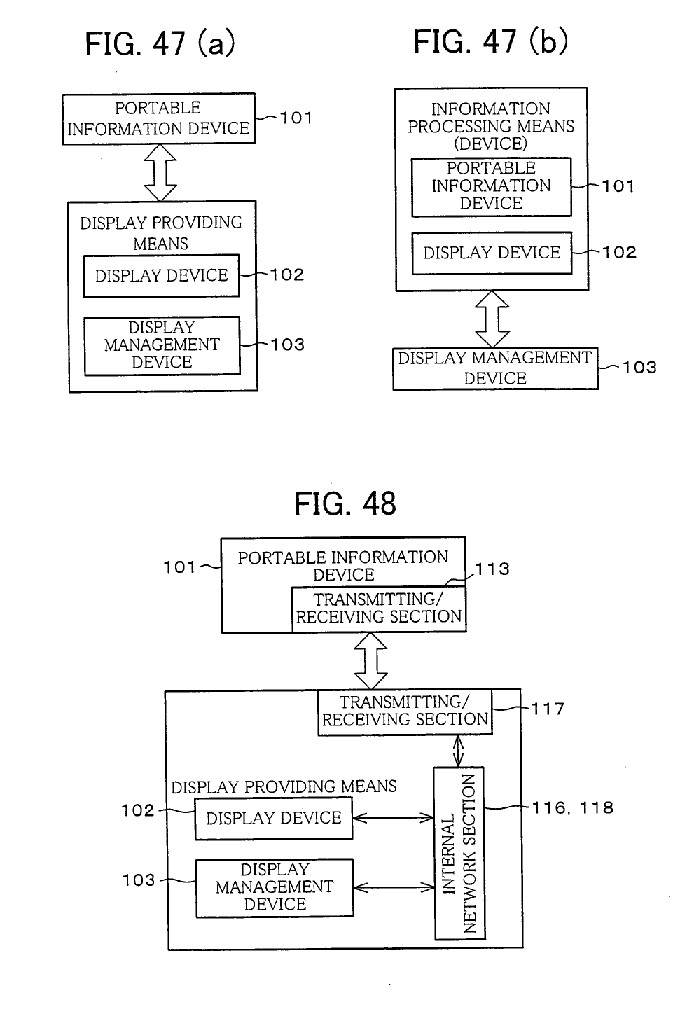

FIG. 22 shows an arrangement of the information service system when it is seen from a system side. On the other hand, when the system is seen from a user side of the portable information device 101, it can be understood as a system in which the portable information device 101 and the display device 102 constitute an information processor similar to a conventional PC, etc. (the information distribution device 104 is not shown). FIG. 47(a) and FIG. 47(b) are easily comparative schematic diagrams showing a difference in a system structure between when it is seen from the foregoing both sides. FIG. 47(a) shows the information service system when it is seen from the system side, and FIG. 47(b) shows the information service system when it is seen from the user of the portable information device 101. FIG. 48 shows a schematic diagram of the system in which transmitting/receiving sections 113 and 117 and internal network sections 116 and 118 are given.

The portable information device 101 has a portability-conscious, small and light arrangement, removing a large display section. The display device 102 is available as a display device of the portable information device 101. The display management device 103 manages display operation, etc. of the display device 102. In the present embodiment, the display management device 103 is provided to each of the display devices 102. The information distribution device 104, for example, can communicate with the display management device 103 via a communication network 105 as the Internet and distributes information in response to the request from the display management device 103. The information distribution device 104 exists in plurality.

The portable information device 101 includes an operating section 111, a data control section 112, the transmitting/receiving sections 113 and a battery section (not shown). The portable information device 101 is, for example, a handheld personal computer (hereinafter, a personal computer is referred to as “PC”), a pocket PC, a portable telephone, or a portable information terminal.

The operating section 111 has, for example, various input keys for inputting various instructions. The data control section 112 processes data in accordance with the input from the operating section 111 and carries out various control operations in the portable information device 101. The transmitting/receiving section 113 transmits/receives image data and control data to/from the transmitting/receiving section (display side communicating means) 117. Note that, although the portable information device 101 is dispersed with a display section for improving its size and weight reduction, it may include a small display section which does not affect so much on the size and weight reduction for the portable information device 101.

The portable information device 101, as described above, is dispersed with such a large display section that is provided, for example, on the notebook PC. Accordingly, the size and weight of the portable information device 101 is drastically reduced. Therefore, it may be incorporated into a hand baggage such as an attaché case, a bag, or a pouch.

The display device 102 includes a display section (display means) 114, a display control section 115, the internal network section 116, a transmitting/receiving section 117, and a power source section (not shown), and the display device 102 displays data such as image data.

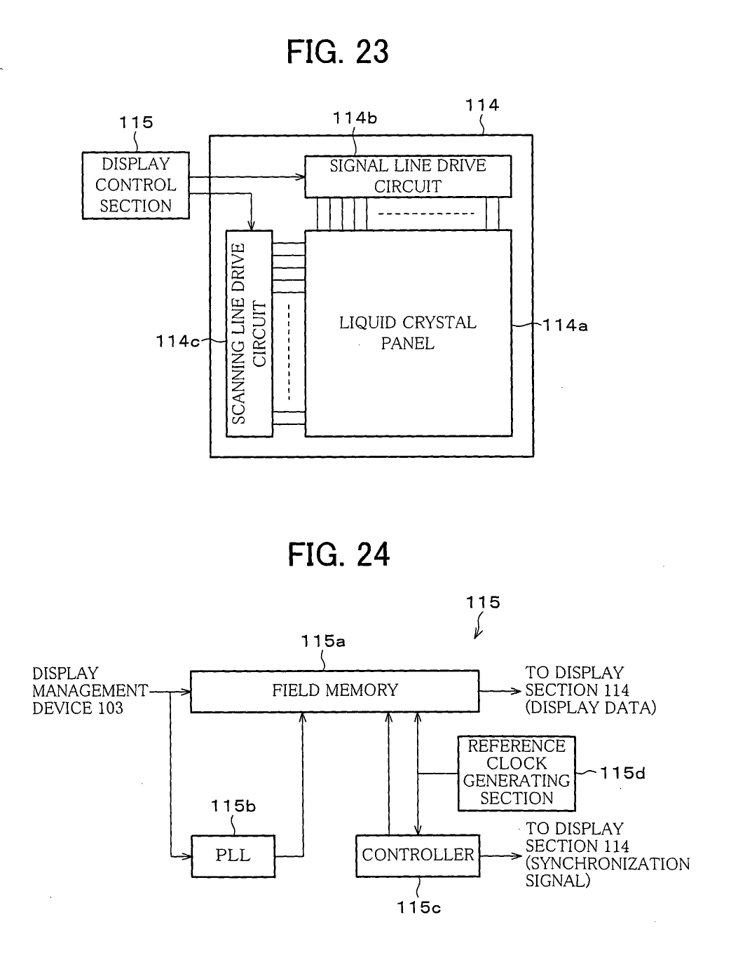

The display section 114, as shown in FIG. 23, includes, for example, a liquid crystal panel 114a, and a signal line drive circuit 114b and a scanning line drive circuit 114c for driving the liquid crystal panel 114a. The liquid crystal panel 114a is, for example, a transmission TFT liquid crystal panel. The transmission TFT liquid crystal panel has a 12-inch screen with 800×RGB×600 pixels and 16 gradation levels. The transmission TFT liquid crystal panel has the same structure as that of a conventional panel. Therefore the explanation thereof is simplified here.

The transmission TFT liquid crystal panel basically has a structure in which a liquid crystal is sandwiched between glass substrates or plastic substrates, and an array of pixels is formed on one substrate. For driving the transmission liquid crystal panel at a vertical synchronization frequency of 60 Hz, an approximately 346 Mbps of transmission speed is required. However, the transmission speed can be reduced by carrying out a low-frequency drive that is disclosed in Japanese Patent Application No. 2000-131183 filed by the applicant of the present application. For example, when the vertical synchronization frequency is reduced to approximately 1.8 Hz, the transmission speed can be reduced to approximately 1.1 Mbps. Accordingly, even in case of transmission of time-series image data, it is possible to display it on the display section 114 at the transmission speed specified by the IEEE802.11, which is described below.

Here, the display section 114 is explained, taking as an example the liquid crystal panel 114a having a 12-inch screen with 800×RGB×600 pixels. However, the display section 114 is a factor that has a significant influence on the determination in the size and shape of the display device 102. Therefore, it is preferable that suitable screen size and number of display pixels for the display section 114 are determined according to an installation location of the display device 102.

Furthermore, in the case where a high-resolution type liquid crystal panel 114a having more display pixels is used for the display section 114, the transmission speed of pixel data (image data) may be increased, or the pixel data may be transmitted in the form of HTML (Hyper Text Markup Language), XML (Extensible Markup Language), or others. Note that, the display section 114 is not necessarily limited to the liquid crystal panel 114a. For example, the display section 114 may be an EL panel. Further, the display section 14 may be a CRT (Cathode Ray Tube), provided that the installation location of the display device 102 has enough space.

The display control section 115 has an interface section which converts supplied image data into a signal suitable for driving a liquid crystal panel 114d (display section 114). The interface section, as shown in FIG. 24, is provided with a field memory 115a, a PLL (Phase Locked Loop) 115b, a controller 115c, and a reference clock generating section 115d. The field memory 115a is capable of storing image data by the volume of one frame.

In the display control section 115, of display data supplied from the display management device 103, video data is supplied to the field memory 115a, and a synchronization signal is supplied to the PLL 115b. In the PLL 115b, a dot clock is generated in accordance with the synchronization signal, and the video data is written in the field memory 115a at the timing of the dot clock. The controller 115c generates the synchronization signal having a timing suitable for driving the display section 114 in accordance with a reference clock supplied from the reference clock generating section 115d to supply the generated synchronization signal to the display section 114, and reads out the video data from the field memory 115a to supply the video data to the display section 114.

The internal network section 116 is connected to an internal network section 118 in the display management device 103 to transmit/receive data to/from the display management device 103. The transmitting/receiving section 117 transmits/receives data to/from the transmitting/receiving section 113 in the portable information device 101.

The display management device 103 is provided with the internal network section 118, a display management section 119, a memory section (advertisement information storage section, questions storage section) 120, an external network section 121, and a power source section (not shown). The internal network section 118 is connected via an internal network to the internal network section 116 in the display device 102 for data transmission and reception. The display management section 119 mainly manages display operation of the display device 102 and carries out various control operations involved in the display operation. The memory section 120, which is used for processing in the display management section 119, stores data therein. The external network section 121 causes the display management device 103 (display management section 119) to connect via the communication network 105 to the information distribution device 104.

For data transmission and reception via the transmitting/receiving sections 113 and 117 between the portable information device 101 and the display device 102, a wireless interface specified by IEEE802.11 is used for example. The IEEE802.11, which is a widely spreading wireless communication technique, uses 2.4 GHz band. As to the IEEE802.11, an initial version defined transmission speeds as being 1 Mbps and 2 Mbps; however, other version having a transmission speed of 11 Mbps has already begun to spread.

For data transmission and reception by the transmitting/receiving sections 113 and 117, a wired interface specified by USB (Universal Serial Bus) or IEEE1394 (Institute of Electrical and Electronics Engineers 1394) may be used.

Further, for the internal network, LAN (Local Area Network) may be used for example.

The information distribution device 104 is provided with an external network section 122, an information distribution control section 123, a display section 124, and a memory section 125.

The external network section 122 causes the information distribution device 104 to connect to the display management device 103 via the communication network 105. The memory section 125 stores therein data such as content data, advertisement data which are displayed on the display device 2, and questionnaire data. The information distribution control section 123 suitably distributes data which is stored in the memory section 125, in response to the request from the display management device 103 side. Further, the information distribution control section 123 causes the display section 124 to suitably display information indicating a status of operations, etc.

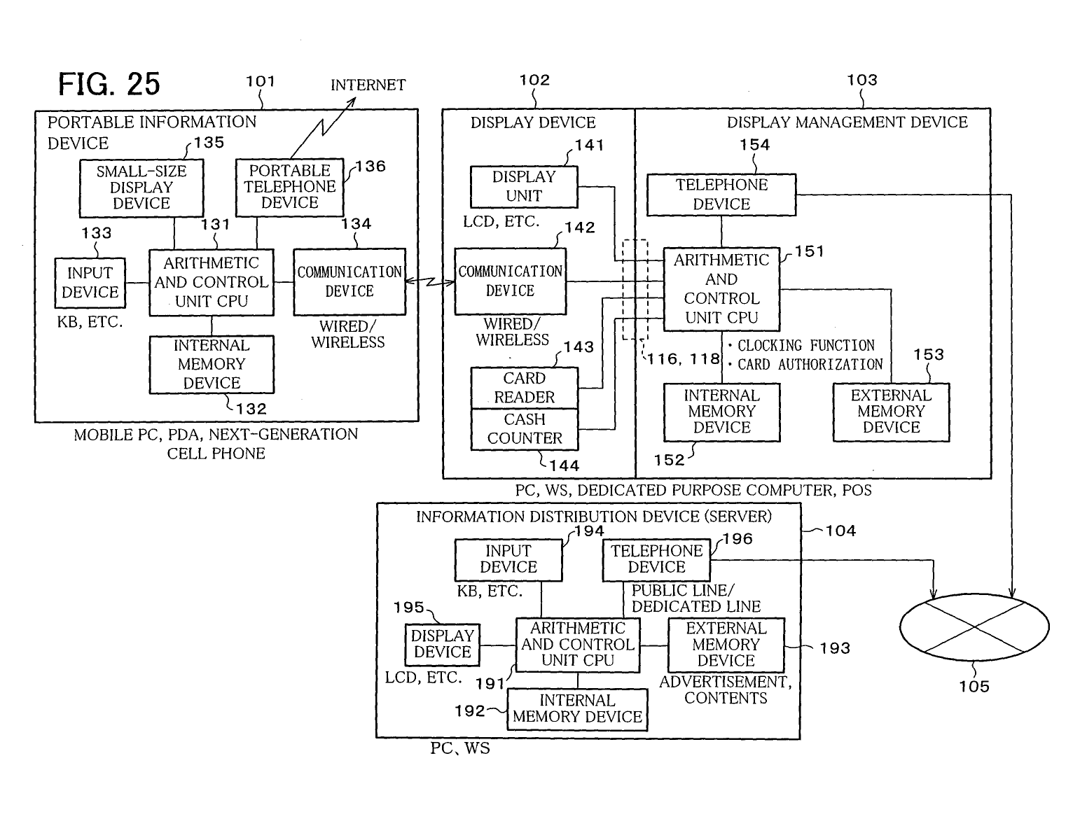

Next, FIG. 25 shows a more specific arrangement of the information service system shown in FIG. 22. Note that, FIG. 25 shows the arrangement in the case where each of the display devices 102 is provided with the display management device 103.

In FIG. 25, the portable information device 101 is provided with an arithmetic and control unit 131 which is a CPU; an internal memory device 132; an input device 133 which is, for example, a small-sized key board; and a communication device 134 which carries out wired or wireless communication with the display device 102. Further, the portable information device 101 may be provided with a small-size display device 135 and an internet-capable portable telephone 136. The small-size display device 135 and portable telephone 136 are suitably provided if necessary. Such a portable information device 101 may be a mobile PC, a PDA, or a next-generation cell phone.

The arithmetic and control unit 131 and the internal memory device 132 constitute the data control section 112 shown in FIG. 22. The input device 133 constitutes the operating section 111, and the communication device 134 constitutes the transmitting/receiving section 113.

Here, the internal memory device 132 is an internal memory of the arithmetic and control unit 131. The internal memory device 132 is also a dedicated memory device of the portable information device 101, which is capable of storing given contents and executing as needed, as a work area of programs and a storing area of data such as image data.

The display device 102 is provided with a display unit 141, a communication device 142, a card reader (fee payment means accepting section) 143, and a cash counter (fee payment means accepting section) 144. The display unit 141 is composed of the display section 114 and the display control section 115. The communication device 142 constitutes the transmitting/receiving section 117. The card reader 143 is a reading device of fee payment means including a credit card, a debit card, a prepaid card, an electric money, or other fee-payment-use card. The cash counter 144 is a calculator of the amount of money put in a cash slot (not shown). The cash slot is provided, for example, on the front surface of the display device 102. The cash counter 144 has a function of deducting a use fee of the display device 2 from the amount put in the cash slot and paying the change.

The display management device 103 includes an arithmetic and control unit 151 which is a CPU, an internal memory device 152, an external memory device 153, and a telephone device 154. The arithmetic and control unit 151 constitutes the display management section 119 shown in FIG. 22. The arithmetic and control unit 151 is connected to the display unit 141 in the display device 102, the communication device 142, the card reader 143, the cash counter 144, etc. The arithmetic and control unit 151 serves as a central processing unit as well as controls the internal memory device 152 and the external memory device 153. The internal memory device 152 and the external memory device 153 constitute the memory section 120.

Here, the internal memory device 152, which is an internal memory of the arithmetic and control unit 151, serves as a device which is capable of storing and executing given contents as needed, as a work area of programs and a storing area of data such as image data. Incidentally, the internal memory device 152 does not require an especially large storage capacity because the image data outputted from the portable information device 101 can be stored only in a period during which the portable information device 101 accesses to the display management device 103. Similarly, this is applied to the case where each of the display devices 102 is not provided with the display management device 103.

Meanwhile, the external memory device 153 stores therein advertisement data to be displayed on the display unit 141 (display section 114) and content data supplied to the portable information device 101 according to the request from the portable information device 101. The external memory device 153 transmits and receives data to and from the internal memory device 152 in accordance with the control operation by the arithmetic and control unit 151 so as to cause the advertisement data to be displayed on the display unit 141.

Further, the arithmetic and control unit 151 can cause the internal memory device 132 of the portable information device 101 to store and execute various application software, etc. by communicating with the portable information device 101. Further, the arithmetic and control unit 151 has a function of combining or switching data displayed on the display unit 141 of the display device 102 and the advertisement data, etc. so as to be screen-displayed, according to a program which operates in accordance with control operation by the arithmetic and control unit 131 of the portable information device 101. The telephone device 154 constitutes the external network section 121 and causes the display management device 103 to connect to an external system via the external network section 121. Examples of the external system include a server of a card company dealing a credit card, a debit card, etc., and further include a server which carries out an advertisement distribution and a content distribution.

The information distribution device 104 is provided with an arithmetic and control unit 191 which is a CPU, an internal memory device 192, an external memory device 193, an input device 194, a display device 195, and a telephone device 196. The arithmetic and control unit 191 constitutes the information distribution control section 123 shown in FIG. 22, and the internal memory device 192 and the external memory device 193 constitute the memory section 125. The external memory device 193 stores therein the foregoing advertisement data and content data, etc. The content data, which are various application programs for example, are useful data for the user of the portable information device 101. The display device 195 constitutes the display section 124, and the telephone device 196 constitutes the external network section 122.

In the present information service system, the user of the portable information device 101 is suitably charged for the obtaining of the content data, etc. from the information distribution device 104 by using the display device 102. Note that, whether charging is carried out or not, a charging price, and others are suitably set according to the usage mode of the display device 102.

Since the display device 102 is used in the above manner, the display device 102 is preferably available to unspecified number of users each carrying the portable information device 101. FIG. 22 shows the case of a minimum structure of the information service system including one display device 102 and one display management device 103 only. However, in view of the above aspect, the display device 102 and the display management device 103 are preferably installed in plurality.

The display device 102 can be installed at any place around the street corner or in a room of a building and a hotel room. The installation location of the display device 102 is not especially limited; however, a place where unspecified number of users can use the display device 102, for example, a public place is preferable. Furthermore, if the installation location of the display device 102 is a place where the users can stay for a certain amount of time period, the availability of the present information service system and the convenience for the user are enhanced further. For example, such a place is a public place including a lobby of a hotel, a waiting room in a station and an air port, a seat on a bullet train, a waiting room in a hospital, a library, a city hall, a book store, a shopping mall, and an inside of a telephone box provided on a sidewalk, etc. or an inside of a box having such a form.

Further, in view of such an installation location, the display device 102 is preferably a thin display such as a liquid crystal display that can save a space. Further, the display management device 103 may have either arrangement in which it is incorporated into the display device 102 or in which it is separated from the display device 102.

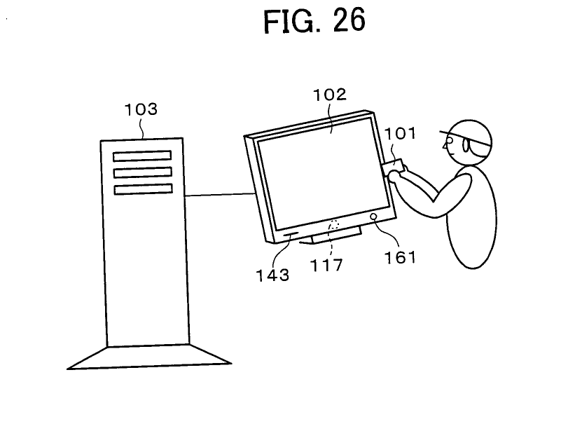

An external view of the information service system is schematically shown in FIG. 26, for example. Here, shown is the arrangement in which the display management device 103 is separated from the display device 102. On the front surface of the display device 102, for example, a card slot of the card reader 143, the transmitting/receiving section 117, and a use permission indicating section 161 are provided. The display device 102 is, if necessary, further provided with a cash slot to a cash counter 144 and various input keys. Note that, the card may be read not only in an arrangement of the card reader 143 integrally incorporated into the display device 102, but also in a mode of reading such as a hand-held bar code reader which is used in POS (Point of Sale), for example.

The above use permission indicating section 161 is, for example, an LED (light-emitting diode), which is lit up if the use of the display device 102 is permitted. The light-up and light-out of the use permission indicating section 161 is controlled by the arithmetic and control unit 151 (display management section 119).

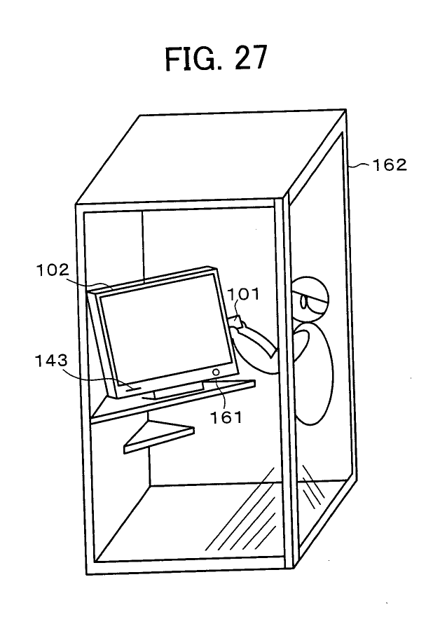

Further, FIG. 27 shows an external view of the case where the display device 102 is provided inside the box 162 as described above. Such a box 162 provided, for example, on the sidewalk and at the stores increases the convenience of using the display device 102.

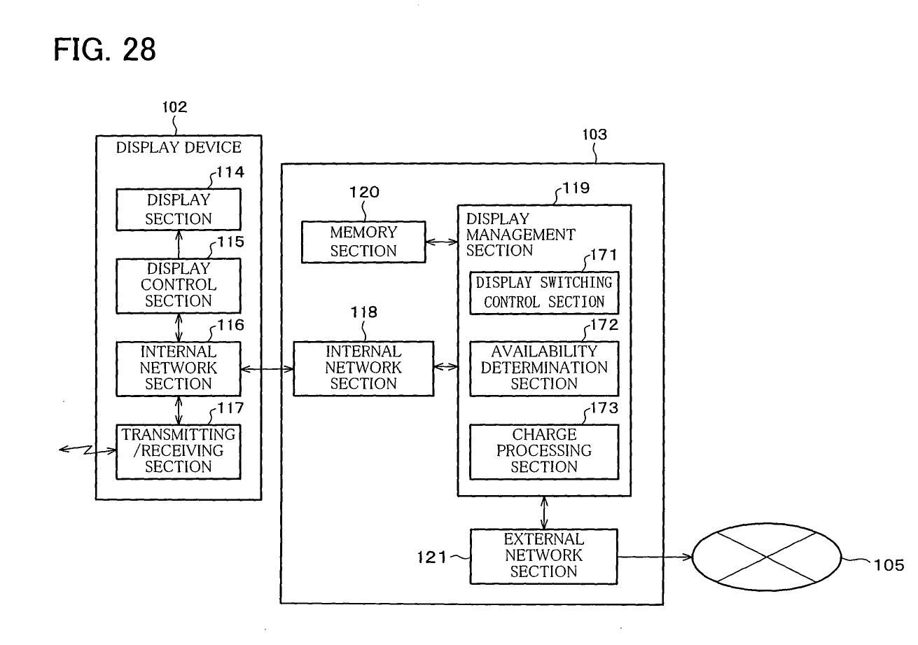

FIG. 28 shows the display management device 103 shown in FIG. 22, in which each function part is more specifically given. More specifically, the display management section 119 has a display switching control section 171, an availability determination section 172, and a charge processing section 173.

The display switching control section 171, while the availability determination section 172 does not permit the portable information device 101 to use the display device 102 (while the use of the display device 102 is not requested by the portable information device 101), requests the information distribution device 104 for the distribution of the advertisement data, and cause the display device 102 to display the advertisement data. Alternatively, the display switching control section 171 causes the display device 102 to display the advertisement data stored previously in the memory section 120. Further, the display switching control section 171, when the availability determination section 172 permits the portable information device 101 to use the display device 102 causes the display device 102 to display the image data, etc. requested by the portable information device 101, instead of the advertisement data. The advertisement data in such a case may be appeared, for example, on one corner of the screen in the form of a small image for a banner advertising, etc., without completely removed from the display screen.

Note that, in the case where the display section 114 of the display device 102 is, for example, the liquid crystal 114a, the display switching control section 171 may change a viewing angle on the liquid crystal panel 114a, by its automatic operation or by the user's operation, in switching from the advertisement display to the display of the image data requested by the portable information device 101. More specifically, a wide viewing angle, when the advertisement is displayed, increases an advertising effectiveness. On the other hand, a narrow viewing angle, when the image data requested by the portable information device 101 is displayed, makes it difficult for other people to see the displayed content.

As a result of the card reader 143, for example, shown in FIG. 25 reading the card, when determining that the card is capable of paying a use fee of the display device 102, the availability determination section 172 permits the portable information device 101 to use the display device 102 and causes the use permission indicating section 161 to light on. At this moment, in the case where the card is, for example, a credit card, the availability determination section 172 asks a server of the corresponding card company as an external system via the communication network 105 about whether the card can be charged. The same processing is also carried out in the case where the card is a debit card, an electronic money, or the like.

The charge processing section 173 calculates the use fee for the use of the display device 2, etc. and charges it to the user of the portable information device 101.

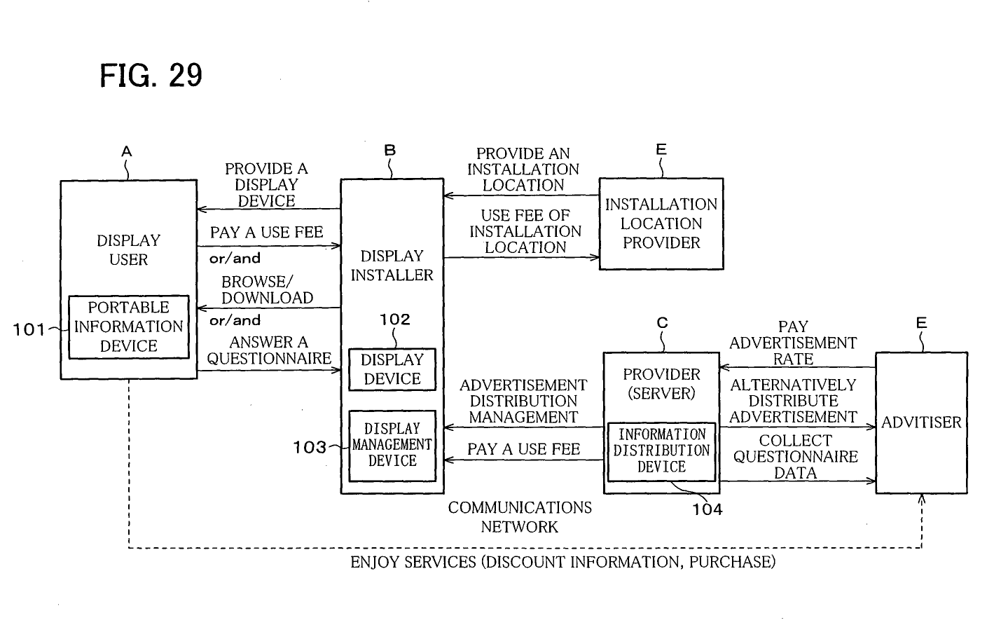

Next, the following will explain an example of a charge processing by the charge processing section 173. As shown in FIG. 29, people involved in the fee calculation are a display user A (a user of the portable information device 101), a display installer B (installer (owner) of the display device 102 and the display management device 103), a provider C (information distribution device 104), an advertiser D, and an installation location provider E of the display device 102.

The display installer B gains profits from the display user A using the display device 102. The provider C, an owner of the information distribution device 104, alternatively delivers the advertisement in response to the payment of the advertisement rate from the advertiser D. The provider C transmits the advertisement to the display management device 103 in response to the request from the display switching control section 171 of the display management device 103. The advertisement is supplied to the display management device 103 via the communication network 105, e.g. the Internet, and then, the advertisement is displayed on the display device 102. The advertisement rate is paid via the provider C from the advertiser D to the display installer B. The advertiser D is a provider of the advertisement displayed on the display device 102. This advertisement is displayed while the display device 102 is not used by the display user A. The installation location provider E is a provider of the place where the display device 102 is installed. Note that, the display installer B here also serves as a display manager. However, the display manager entrusted by the display installer B may manage the display device 102.

Basically, the charge processing section 173 of the display management device 103 (display installer B) charges for the use of the display device 102 by the portable information device 101 (display user A) and for the obtaining of content data from the provider C. The content data are content data such as local data and application data. Examples of the local data include geographical information of the place where the display device 102 is installed and its surroundings, regional information, various information on facilities, information on shops, information on companies, information on events, information on concerts, timetables of public transports, and information on new books. Examples of the information on shops include information on discounting by shops, supermarkets, and restaurants.

The use fee by the display user A at this time is calculated according to a length of time that the display device 102 is used. Further, as to the use of the content data, the fee may be calculated depending on a data capacity or a unit price set for every data.

Further, the use fee at this time may be made free by being borne by the advertiser D, for example, an advertiser, a company, a shop, etc. whose advertisement is included in content data; or by being shared by the former (advertiser D) and the latter (advertiser, etc. of the advertisement included in the content data).

The followings are the methods of charging for the use of the display device 102 by the advertiser D.

(1) The charging is carried out according to the length of time that the advertisement is displayed on the display device 102. In such a case, for the fee calculation, an area where the advertisement is displayed on the display device 102 (whether the advertisement is displayed with a small image or a normal, large image) is considered. Note that, the display user A bears the amount for the use of the display device 102 by the display user A.

(2) The charging is carried out according to a time period, for example, hours and days for the use of the display device 102, including the amount for the use by the display user A.

Further, the display installer B pays to the installation location provider E, a use fee for the use of the installation location for the display device 102 and the display management device 103. The use fee includes, for example, a given amount determined previously by a contract, or an amount calculated according to the percentage in the display installer B's profit gained from the charging.

Note that, in the case where the advertiser D is the installation location provider E, the display installer B can collect an advertisement rate (the use fee of the display device 102 for the purpose of displaying the advertisement) from the advertiser E without paying the use fee for the use of the installation location.

Further, at the time of the use of the display device 102 by the display user A, questions from the advertiser D are first displayed on the screen. The answers to the questions by the display user A are sent to the advertiser D via the display management device 103, the communication network 105, and the provider C. Note that, in the case where the display user A bears the use fee for the use of the display device 102 by the display user A, it may be arranged such that the use fee is reduced for the display user A who answers the questionnaire, and the advertiser D bears the amount that has been reduced.

In the above arrangement, the following will explain the operation of the present information service system.

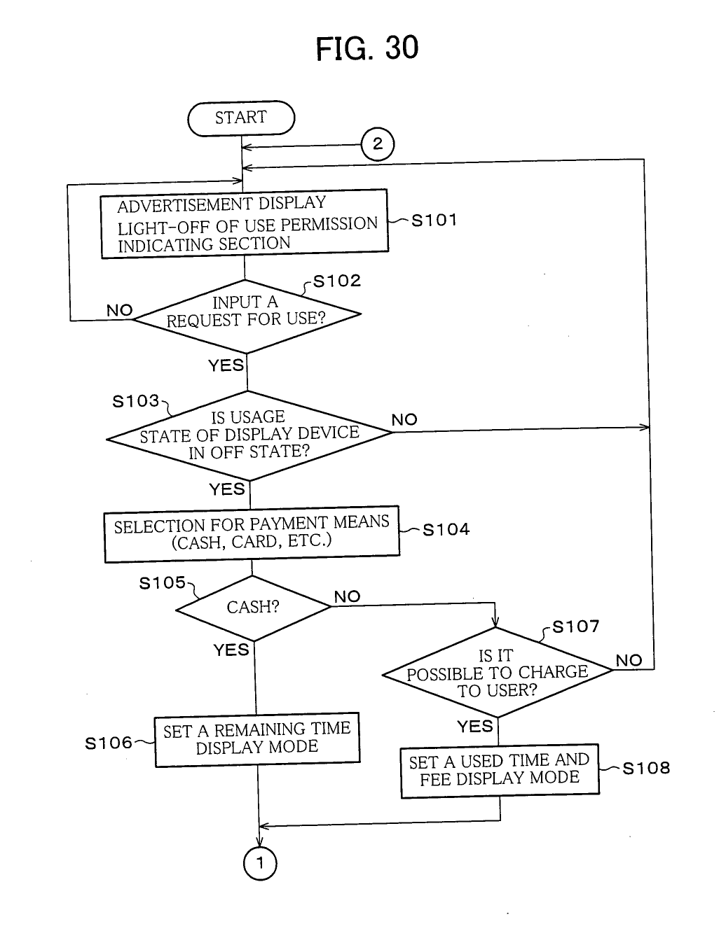

First, in the information service system, the operation in the case where the user of the portable information device 101 is charged for the use of the display device 102 by the portable information device 1, that is, obtaining of content data from the information distribution device 104 by using the display device 2, or display processing of the content data on the display device 102 will be explained with reference to flow charts of FIGS. 30 and 31 and FIG. 32.

First, as shown in FIG. 30, the display switching control section 171 of the display management section 119 in the display management device 103 (see FIG. 28) causes the display device 102 to display the advertisement. At this moment, the use permission indicating section 161 (see FIG. 26) is in a light-off state (S101). The advertisement data displayed at this moment is data supplied via the communication network 105 from the provider C (information distribution device 104) to the display management device 103, in the arrangement shown in FIG. 29, or data stored previously in the memory section 120.

In this state, when the request for the use of the display device 102 (a request for occupancy) is supplied from the portable information device 101 (S102), the display switching control section 171 determines whether the usage state of the display device 102 is in OFF state, that is, whether the display device 102 is not currently used by other portable information device 101 (whether the advertisement in being display) (S103).

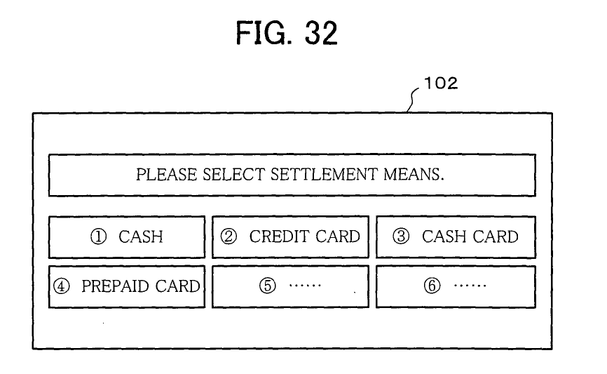

As a result of the determination, when the usage state of the display device 102 is in OFF state, the display switching control section 171, as shown in FIG. 32, causes the display device 102 to display a selection screen showing payment means for the use fee of the display device 102 (settlement means) and requests the user to select the payment means (S104).

Here, the payment means is selected by inputting a number attached to the respective menu of the displayed payment means, or by touching the displayed part of the menu (in the case where the display device 102 has a function of touch panel).

At this moment, for example, when cash is selected (S105), cash is inserted into a cash slot (not shown) of the display device 102, the cash counter 144 (see FIG. 25) counts the cash inserted. In accordance with the result of the counting, the arithmetic and control unit 151 of the display management device 103, i.e. the availability determination section 172 (see FIG. 28) calculates a remaining time (available time) corresponding to a balance and sets a mode to cause the display device 102 to display the remaining time (S106).

Further, at S105, when any card is selected other than the cash, and the selected card is inserted into the card reader 143 of the display device 102 (see FIG. 26), the card reader 143 reads out information in the card. In accordance with the result of reading, the arithmetic and control unit 151 of the display management device 103 (see FIG. 25), i.e. the availability determination section 172 (see FIG. 27) determines whether it is possible to charge the user (S107). More specifically, in accordance with the information which is written in the card, the availability determination section 172 determines the presence or absence of the balance in the card, or asks a card company about the presence or absence of the balance in the card, etc. via the communication network 105, and then, determines whether the user's card can be charged.

As a result of the determination, if the portable information device 101 can use the display device 102, the availability determination section 172 sets a mode to cause the display device 102 to display the integral of the used time and the corresponding integral charge (S108). On the other hand, as a result of the above determination, if the portable information device 101 cannot use the display device 102, the procedure goes back to S101, and the advertisement display is continued.

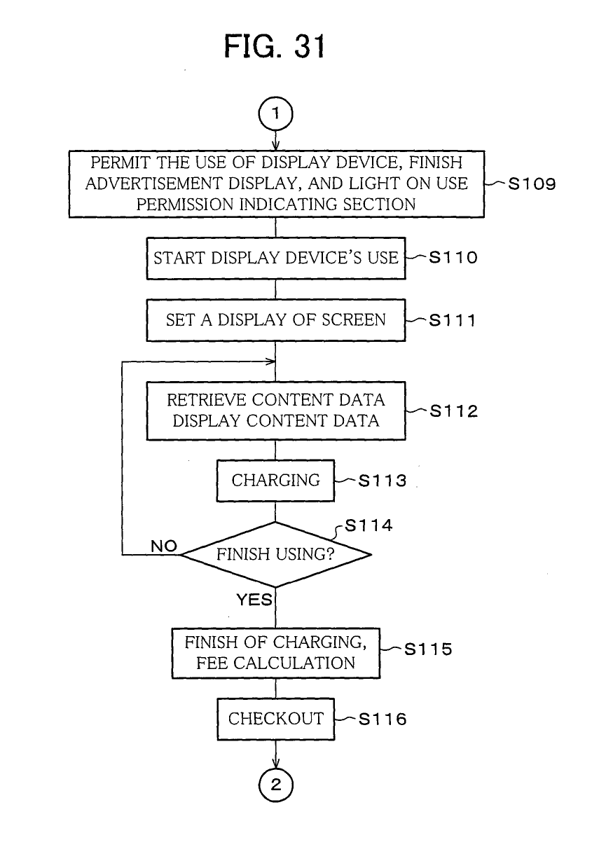

Next, thereafter, if the portable information device 101 can use the display device 102, as shown in FIG. 31, the availability determination section 172 permits the use of the display device 102 and causes the use permission indicating section 161 to light on, so as to let the user of the portable information device 101 know that the display device 102 is available. Further, the display switching control section 171 finishes the advertisement display on the display device 102 (S109). Note that, the display switching control section 171 at this moment may be arranged so that the advertisement is appeared on one corner of the screen in the form of a small image for a banner advertising, etc., without completely finishing the advertisement display.

Then, the display switching control section 171, as a process for the availability of the display device 102 by the portable information device 101, transmits to the portable information device 101 a profile (display profile) which is necessary for the display on the display device 102 (S110). The portable information device 101, which has received the profile, makes a display setting for the screen of the display device 102 according to the display profile (S111).

Next, the display switching control section 171 in the display management device 103, in response to the instruction from the portable information device 101, retrieves content data from any of the information distribution device 104 and causes the display device 102 to display the content data (S112). Then, the charge processing section 173 starts charging for the use of the display device 102 by the portable information device 101 (S113). In this case, at least one of the use of the display device 102 itself, and the obtaining of content data from the information distribution device 104 is charged as the use of the display device 102.

Thereafter, the display switching control section 171 observes whether the portable information device 101 has finished using the display device 102 (S114). Note that, the use of the display device 102 is finished in accordance with, for example, a use finishing operation carried out by the user of the portable information device 101 in the operating section 111 of the portable information device 101, lack of the balance for the use of the display device 102, the user's touch of a use finishing section provided on the display device 102, or no access for a given time period from the portable information device 101 to the display device 102. Note that, the lack of the balance is detected by the charge processing section 173.

At S114, when the display switching control section 171 detects that the portable information device 101 has finished using the display device 102, the charge processing section 173 finishes charging and calculates the use fee of the display device 102 (S115). Then, checkout processing is performed (S116). At this moment, in case of payment by cash with change occurred, the charge processing section 173 makes change. In case of payment by card, checkout processing is performed suitably according to the type of the card. Thereafter, the procedure goes back to S101, and the display switching control section 171 restarts the advertisement display on the display device 102.

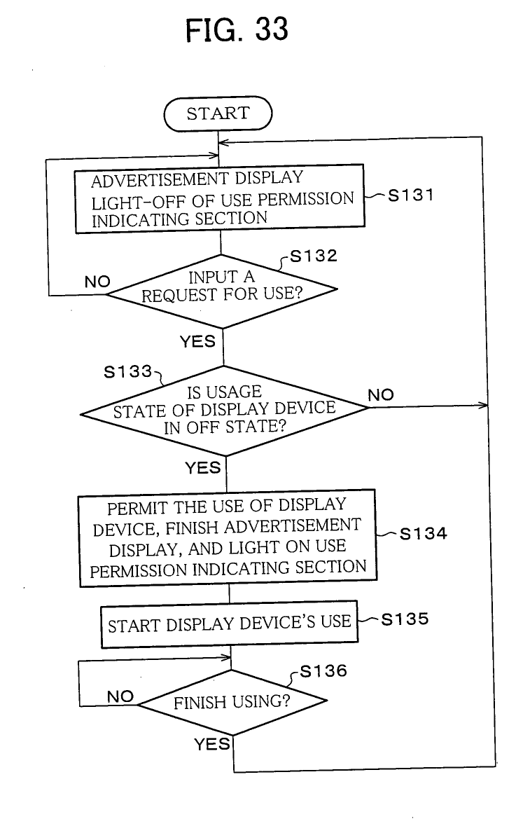

Next, in the information service system, the operation in the case where the user of the portable information device 101 is not charged for the use of the display device 102 by the portable information device 101 with reference to a flow chart of FIG. 33.

First, the display switching control section 171 of the display management section 119 in the display management device 103 (see FIG. 28) causes the display device 102 to display the advertisement. At this moment, the use permission indicating section 161 (see FIG. 25) is in a light-off state (S131). The advertisement data displayed at this moment is the same data as that described above.

In this state, when the request for the use of the display device 102 (a request for occupancy) is supplied from the portable information device 101 (S132), the display switching control section 171 determines whether the usage state of the display device 102 is in OFF state, that is, whether the display device 102 is not currently used by other portable information device 101 (whether the advertisement is being displayed) (S133).

As a result of the determination, when the usage state of the display device 102 is in OFF state, the availability determination section 172 permits the use of the display device 102 and causes the use permission indicating section 161 to light on, so as to let the user of the portable information device 101 know that the display device 102 is available. Further, the display switching control section 171 finishes the advertisement display on the display device 102 (S134). Note that, the display switching control section 171 at this moment may be arranged so that the advertisement is appeared on one corner of the screen in the form of a small image for a banner advertising, etc., without completely finishing the advertisement display.

Next, the display switching control section 171 in the display management device 103, in response to the instruction from the portable information device 101, obtains content data from the information distribution device 104 and causes the display device 102 to display the content data (S135).

Thereafter, the display switching control section 171 observes whether the portable information device 101 has finished using the display device 102 (S136). Note that, the use of the display device 102 is finished in accordance with, for example, a use finishing operation carried out by the user of the portable information device 101 in the operating section 111 of the portable information device 101, the user's touch of a use finishing section provided on the display device 102, or no access for a given time period from the portable information device 101 to the display device 102.

At S136, when the display switching control section 171 detects that the portable information device 101 has finished using the display device 102, the procedure goes back to S131, and the display switching control section 171 restarts the advertisement display on the display device 102.

In this process, as described above, the charge processing section 173 does not carry out the charge processing for the use of the display device 102 by the portable information device 101. However, for the advertisement display on the display device 102, the charge processing is carried out in accordance with the contract with the advertiser D. Therefore, in the case where the use fee by the portable information device 101 is asked to the advertiser D, the charge processing section 173 carries out the charge processing for the use fee to the advertiser D. Further, in the case of a period contract with the advertiser D, the calculation processing is carried out suitably for various fees according to the contract.

[Fourth Embodiment]

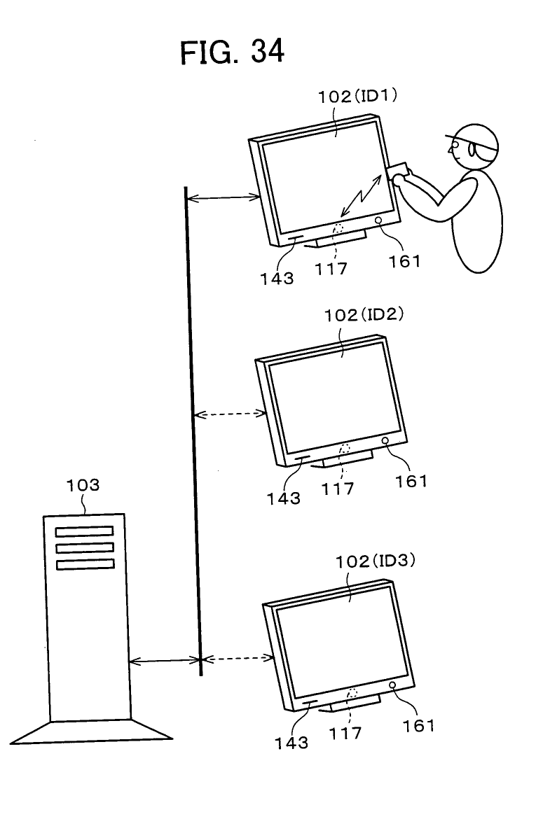

The following will explain still another embodiment of the present invention with reference to FIGS. 34 through 40. Note that, for the purpose of explanation, means having the same functions as the foregoing means are given the same reference numerals and explanations thereof are omitted here.

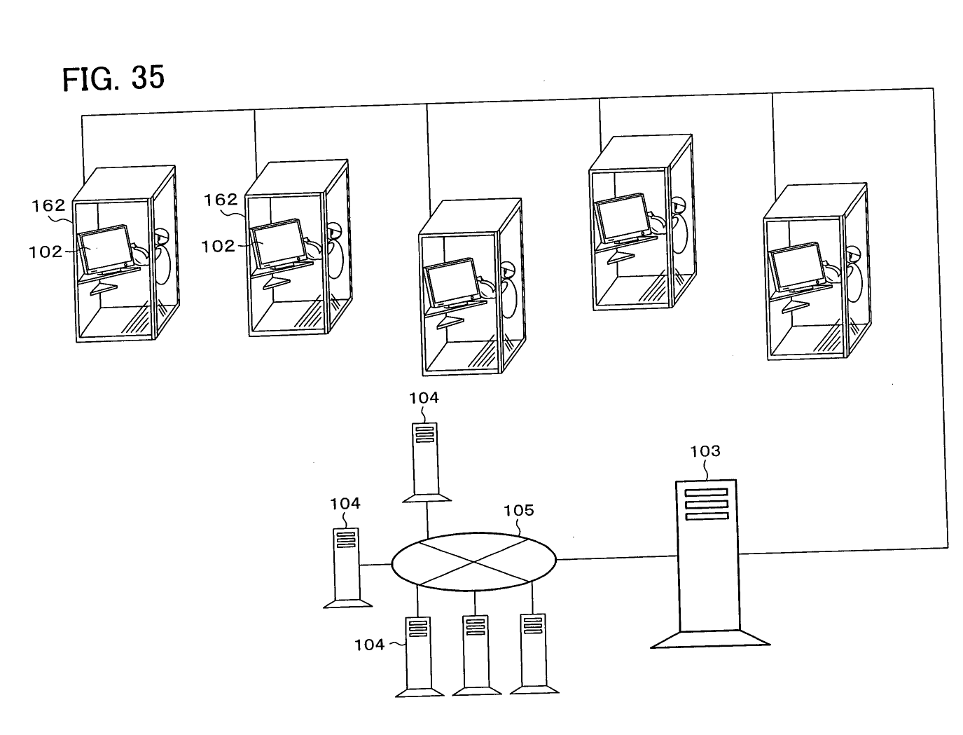

An information service system of the present embodiment has a basic arrangement shown in FIG. 22. As shown in FIG. 34, one display management device 103 manages a plurality of display devices 102 which are connected to the display management device 103. Therefore, for example, in an arrangement in which the display device 102 is provided inside a box 162, as shown in FIG. 27, the display device 102 and the display management device 103 in the present information service system are the ones shown in FIG. 35.

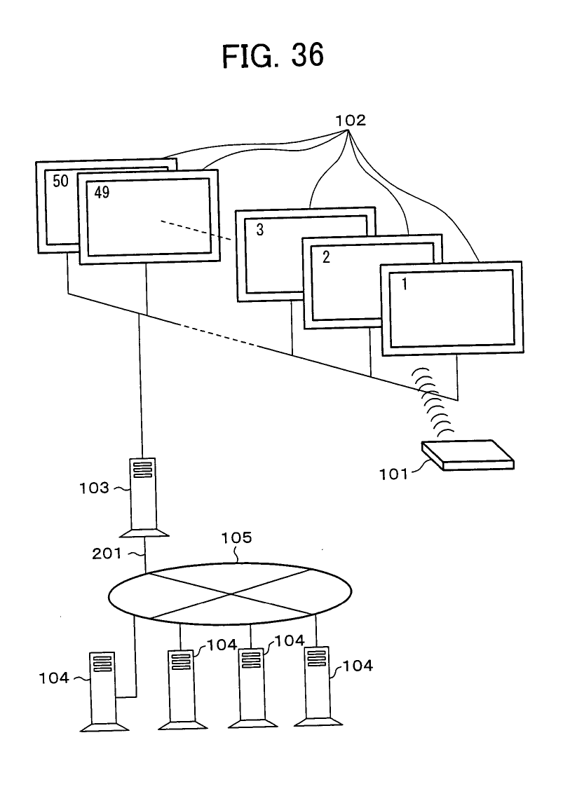

FIG. 36 shows an information service system in the case where, for example, fifty 21-inch color TFT liquid crystal panels as display devices 102 are installed, for example, in a waiting room of a station. The display devices 102 constituting a group of display devices are connected with a cable to one display management device 103. The display devices 102 are assigned the respective identification numbers 1 though 50, each of which is displayed on the upper corner of the screen of the display device 102.

The display management device 103 is connected with an exclusive line 201 to a communication network 105. The communication network 105 is connected to an information distribution devices 104 owned by an information distributing company which is under a contract for the use of the present system with the railway company.

On the display device 102, information on the station yard and an advertisement of the railway company are usually displayed all the time. The advertisement display is carried out so that the information and advertisement video data which are stored in the display management device 103 owned by the station are delivered to each of the display devices 102. That is, the railway company is an advertiser D and an installation location provider E in this case.

Alternatively, the information distributing company, which is under a contract with the railway company specifying on hours, a period of time, and the number of the display devices 102 to display the advertisement, may cause the display devices 102 to display the above advertisement during the contracted hours. In this case, the advertisement video data which are stored in the information distribution device 104 owned by the information distributing company are transmitted via the communication network 105 (Internet) to the display management device 103. Then, the advertisement video data are displayed on at least one or more display devices 102 specified by the display management device 103.

Therefore, the advertiser D is the information distributing company in this case, and the use fee of the system paid to the railway company by the information distributing company may differ depending on the number of the display devices 102 to display the advertisement, the hours during which the advertisement is aired, etc.

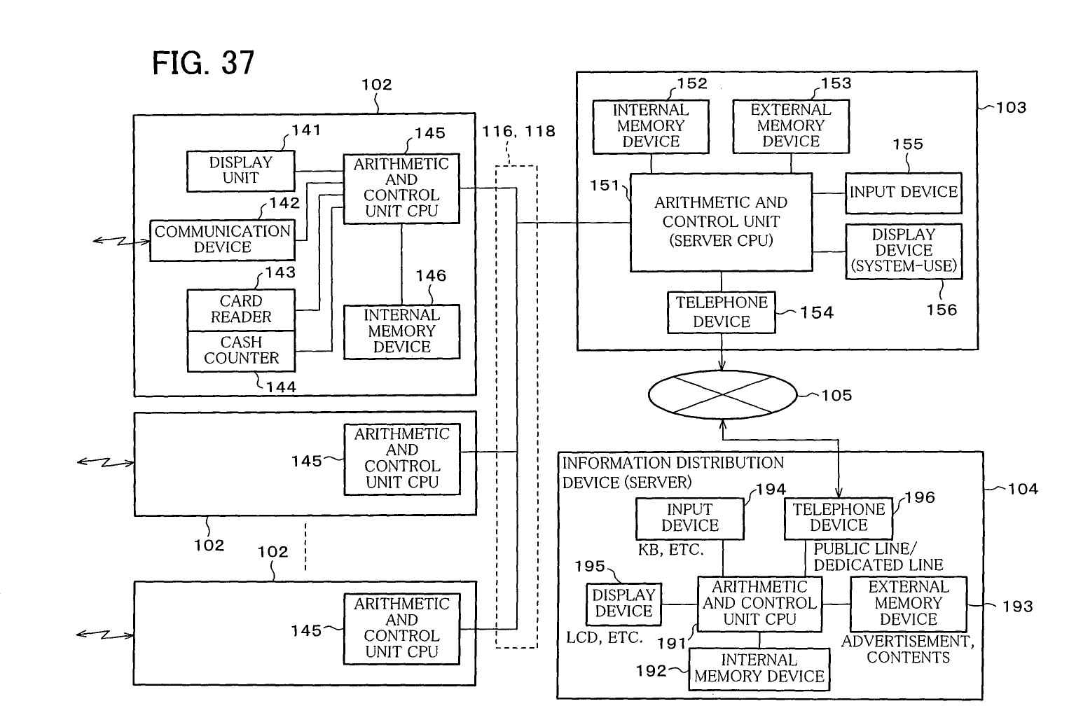

A specific arrangement of the information service system is shown in FIG. 37. Note that, description of a portable information device 101 is omitted here because the portable information device 101 is the same as that shown in FIG. 25.

In FIG. 37, the display device 102 includes a display unit 141, a communication device 142, a card reader 143, a cash counter 144, an arithmetic and control unit 145, and an internal memory device 146.

In the present embodiment, the display unit 141 constitutes a display section 114 shown in FIG. 22, and the communication device 142 constitutes a transmitting/receiving section 117. The arithmetic and control unit 145, which constitutes a display control section 115, communicates with an arithmetic and control unit 151 of the display management device 103 so as to control the whole display device 102.

The display management device 103 includes an internal memory device 152, an external memory device 153, and a communication device, which are provided in the display management device 103 shown in FIG. 4. Further, the display management device 103 includes an input device 155 for inputting various instructions, and a display device 56 for system monitoring. The telephone device 154 constitutes an external network section 121 and causes the display management device 103 to connect to the information distribution device 104 via the communication network 105. The information distribution device 104 has the same arrangement as that shown in FIG. 25.

In the above arrangement, the following will explain the operation of the present information service system.

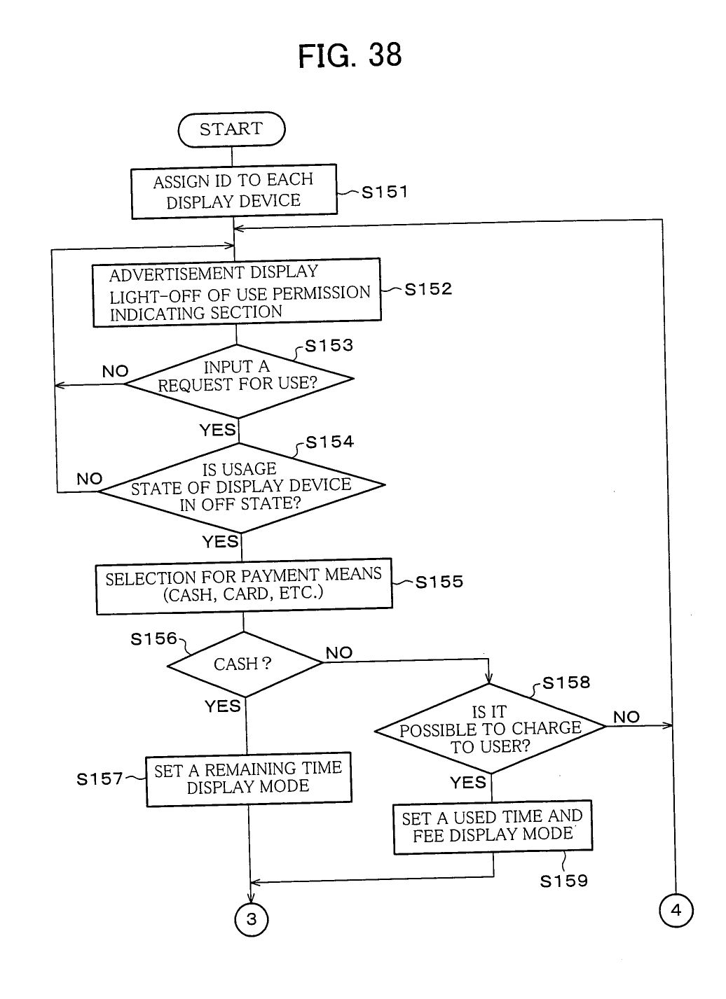

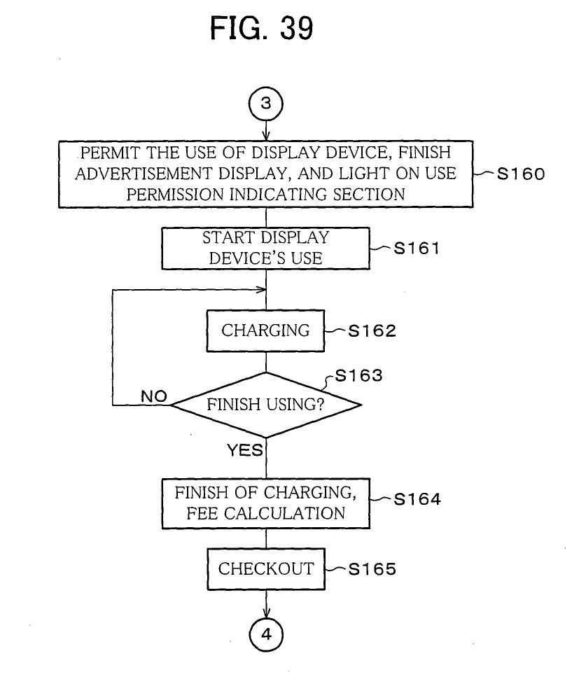

First, the operation in the case where the user of the portable information device 101 is charged for the use of the display device 102 by the portable information device 101 will be explained with reference to flow charts of FIGS. 38 and 39.

As shown in FIG. 38, the display switching control section 171 in the display management device 103 (see FIG. 28) previously assigns IDs to each of the display devices 102 which are connected to the display management device 103 (S151). With these IDs, the display management device 103 manages the plurality of display devices 102.

In this state, first, the display switching control section 171 causes each of the display devices 102 to display the advertisement. At this moment, the respective use permission indicating sections 161 (see FIG. 34) are in a light-off state (S152). The advertisement data displayed at this moment are data supplied via the communication network 105 from a provider C (information distribution device 104) to the display management device 103, or data stored previously in a memory section 120, in the arrangement shown in FIG. 29.

Next, when the request for the use of the display device 102 (a request for occupancy) is supplied from the portable information device 101 to any one of the display devices 102 (S153), the display control section 115 in the display device 102 transmits this information with ID information to the display management device 103. The display switching control section 171 in the display management device 103 determines whether the usage state of the display device 102 which is assigned the ID is in OFF state, that is, whether the display device 102 which is assigned the ID is not currently used by other portable information device 101 (whether the advertisement is being displayed) (S154).

As a result of the determination, when the usage state of the display device 102 is in OFF state, the display switching control section 171, as shown in FIG. 32, causes the display device 102 to display a selection screen showing payment means for the use fee of the display device 102 (settlement means) and requests the user to select the payment means (S155). Note that, a selection method is as described previously.

At this moment, for example, when cash is selected (S156), cash is inserted into a cash slot (not shown) of the display device 102, the cash counter 144 (see FIG. 37) counts the cash inserted. In accordance with the result of the counting, the arithmetic and control unit 151 of the display management device 103, i.e. the availability determination section 172 (see FIG. 28) calculates a remaining time (available time) corresponding to a balance and sets a mode to cause the display device 102 to display the remaining time (S157).

Further, at S156, when any card is selected other than the cash, and the selected card is inserted into the card reader 143 of the display device 102 (see FIG. 34), the card reader 143 reads out information in the card. In accordance with the result of reading, the arithmetic and control unit 151 of the display management device 103 (see FIG. 37), i.e. the availability determination section 172 (see FIG. 28) determines whether it is possible to charge the user (S158). More specifically, in accordance with the information which is written in the card, the availability determination section 172 determines the presence or absence of the balance in the card, or asks a card company about the presence or absence of the balance in the card, etc. via the communication network 105, and then, determines whether the user's card can be charged.

As a result of the determination, if the portable information device 101 can use the display device 102, the availability determination section 172 sets a mode to cause the display device 102 to display a used time and the corresponding integral charge (S159). On the other hand, as a result of the above determination, if the portable information device 101 cannot use the display device 102, the procedure goes back to S152.

Next, thereafter, if the portable information device 101 can use the display device 102, as shown in FIG. 39, the availability determination section 172 permits the use of the display device 102 and causes the use permission indicating section 161 to light on, so as to let the user of the portable information device 101 know that the display device 102 is available. Further, the display switching control section 171 finishes the advertisement display on the display device 102 (S160). Note that, as described previously, the advertisement may be appeared in the form of a small image for a banner advertising, etc.

Next, the display switching control section 171 in the display management device 103, in response to the instruction from the portable information device 101, retrieves content data from any one of the information distribution device 104 and causes the display device 102 to display the content data retrieved (S161). Then, the charge processing section 173 starts charging for the use of the display device 102 by the portable information device 101 (S162). In this case, at least one of the use of the display device 102 itself, and the obtaining of content data from the information distribution device 104 is charged as the use of the display device 102.

Thereafter, the display switching control section 171 observes whether the portable information device 101 have finished using the display device 102 (S163). Note that, finishing the use of the display device 102 is as described previously.

At S163, when the display switching control section 171 detects that the portable information device 101 has finished using the display device 102, the charge processing section 173 finishes charging and calculates the use fee of the display device 102 (S164). Then, checkout processing is performed (S165). At this moment, in case of payment by cash with change occurred, the charge processing section 173 makes change. In case of payment by card, checkout processing is performed suitably according to the type of the card. Thereafter, the procedure goes back to S152, and the display switching control section 171 restarts the advertisement display on the display device 102.

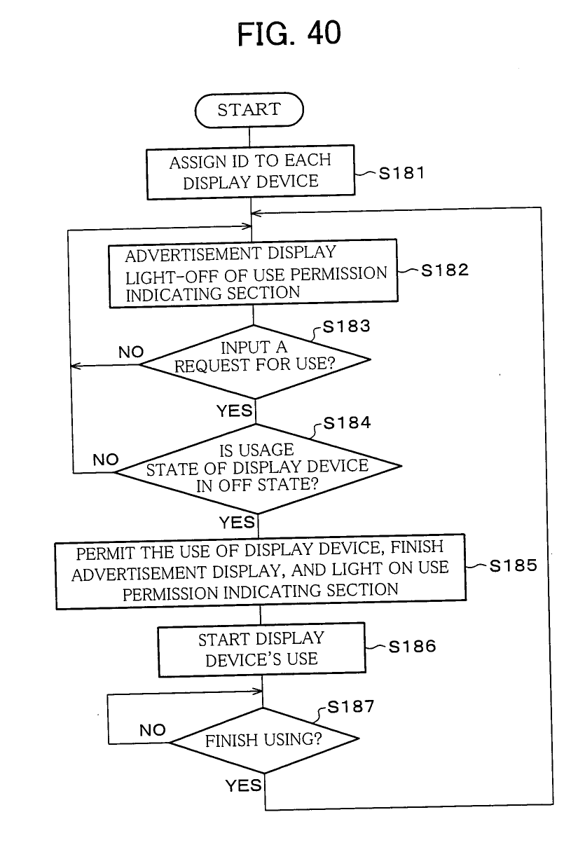

Next, in the information service system, the operation in the case where the user of the portable information device 101 is not charged for the use of the display device 102 by the portable information device 101 with reference to a flow chart of FIG. 40.

The display switching control section 171 in the display management device 103 (see FIG. 28) previously assigns IDs to each of the display devices 102 which are connected to the display management device 103 (S181). With these IDs, the display management device 103 manages the plurality of display devices 102.

In this state, the display switching control section 171 causes each of the display devices 102 to display the advertisement. At this moment, the respective use permission indicating sections 161 (see FIG. 34) are in a light-off state (S182).

In this state, when the request for the use of the display device 102 (a request for occupancy) is supplied from the portable information device 101 to any one of the display devices 102 (S183), the display control section 115 in the display device 102 transmits this information with ID information to the display management device 103. The display switching control section 171 in the display management device 103 determines whether the usage state of the display device 102 which is assigned the ID is in OFF state, that is, whether the display device 102 is not currently used by other portable information device 101 (whether the advertisement is being displayed) (S184).

As a result of the determination, when the usage state of the display device 102 is in OFF state, the availability determination section 172 permits the use of the display device 102 and causes the use permission indicating section 161 to light on, so as to let the user of the portable information device 101 know that the display device 102 is available. Further, the display switching control section 171 finishes the advertisement display on the display device 2 (S185). Note that, as described previously, the advertisement may be appeared in the form of a small image for a banner advertising, etc.

Next, the display switching control section 171 in the display management device 103, in response to the instruction from the portable information device 101, obtains content data from the information distribution device 104 and causes the display device 102 to display the obtained content data (S186).

Thereafter, the display switching control section 171 observes whether the portable information device 101 has finished using the display device 102 (S187). Note that, finishing the use of the display device 102 is as described previously.

At S187, when the display switching control section 171 detects that the portable information device 101 has finished using the display device 102, the procedure goes back to S182, and the display switching control section 171 restarts the advertisement display on the display device 102.

In this process, as described above, the charge processing section 173 does not carry out the charge processing for the use of the display device 102 by the portable information device 101. However, for the advertisement display on the display device 102, the charge processing is carried out in accordance with the contract with the advertiser D. In the case where the use fee by the portable information device 101 is asked to the advertiser D, the charge processing section 173 carries out the charge processing for the use fee to the advertiser D. Further, in the case of a period contract with the advertiser D, the calculation processing is carried out suitably for various fees according to the contract.

[Fifth Embodiment]

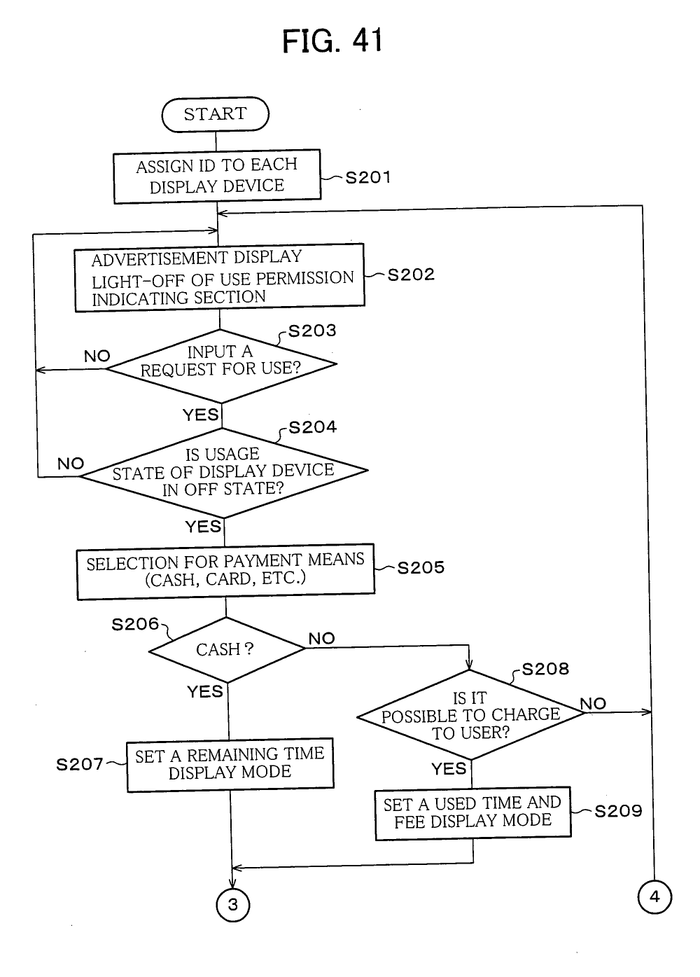

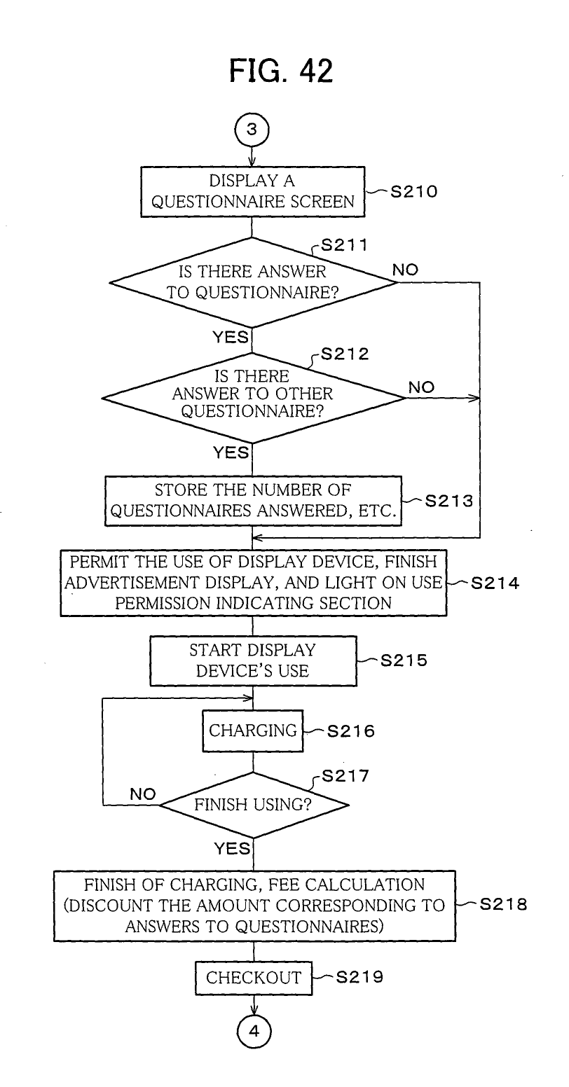

The following will explain yet another embodiment of the present embodiment with reference to FIGS. 41 through 45. An information service system here is arranged so that when requested for the use of a display device 102 by a portable information device 101, a display management device 103 shows a questionnaire in accordance with an order from the advertiser D to a user of the portable information device 101 (see FIG. 29); and in the case where the questionnaire is answered, a fee for the use of the display device 102 by the portable information device 101 is reduced. The following will explain the operation in this case, with reference to flow charts in FIGS. 41 and 42. Note that, the embodiment of the information service system in this case is shown in FIG. 36 and provided, for example, in the station yard as described previously.

As shown in FIG. 41, a display switching control section 171 in the display management device 103 (see FIG. 28) previously assigns IDs to each of the display devices 102 which are connected to the display management device 103 (S201).

In this state, first, the display switching control section 171 causes each of the display devices 102 to display the advertisement. At this moment, the respective use permission indicating sections 161 (see FIG. 34) are in a light-off state (S202). The advertisement data displayed at this moment are, for example, data of the foregoing railway company and data stored in a memory section 120 of the display management device 103. Further, the advertisement data, in the case where the advertiser D is a company other than the railway company, are data supplied via the communication network 105 from a provider C (information distribution device 104) to the display management device 103, in the arrangement shown in FIG. 29.

Next, when the request for the use of the display device 102 (a request for occupancy) is supplied from the portable information device 101 to any one of the display devices 102 (S203), a display control section 115 in the display device 102 transmits this information with ID information to the display management device 103. In the request for the use of the display device 102, for example, an ID for the display device 102 intended to use (the number displayed on the corner of the screen), a name of the user, etc. This input is carried out so that the user of the portable information device 101 operates an operating section 111 with the portable information device 101 directed toward the display device 102.

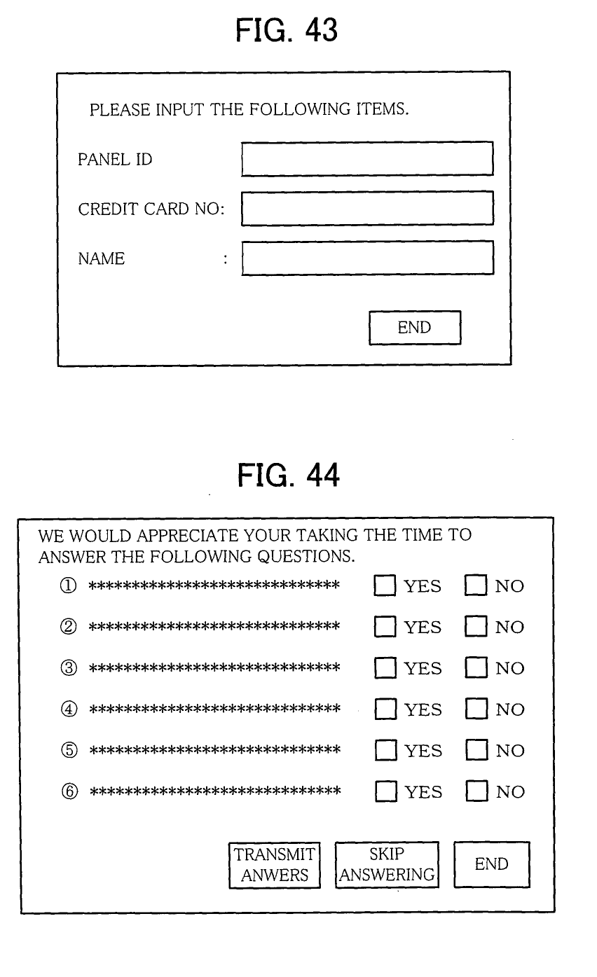

Further, the request for the use of the display device 102 may be arranged so that the request for the use is first transmitted from the portable information device 101; and in accordance with the transmission, an screen for encouraging to input an ID number of a panel, a credit card number, a name, etc., which are shown in FIG. 43, is displayed on the display device 102. Note that, the input of the credit card number is only required in the case where a credit card is only accepted as payment means, for example. In this case, the steps S205 to S208 are not necessary.

Upon reception of the request for the use, the display switching control section 171 in the display management device 103 determines whether the usage state of the display device 102 which is assigned the ID is in OFF state (whether the advertisement is being displayed) (S204).

As a result of the determination, when the usage state of the display device 102 is in OFF state, the display switching control section 171, as shown in FIG. 32, causes the display device 102 to display a selection screen showing payment means for the use fee of the display device 102 (settlement means) and requests the user to select the payment means (S205).

At this moment, for example, when cash is selected (S206), cash is inserted into a cash slot (not shown) of the display device 102, the cash counter 144 (see FIG. 37) counts the cash inserted. In accordance with the result of the counting, the availability determination section 172 in the display management device 103 (see FIG. 28) calculates a remaining time (available time) corresponding to a balance and sets a mode to cause the display device 102 to display the remaining time (S207).

Further, at S206, when any card is selected other than the cash, and the selected card is inserted into the card reader 143 of the display device 102 (see FIG. 34), the card reader 143 reads out information in the card. In accordance with the result of reading, the availability determination section 172 in the display management device 103 (see FIG. 28) determines whether it is possible to charge the user (S208). More specifically, in accordance with the information which is written in the card, the availability determination section 172 determines the presence or absence of the balance in the card, or asks a card company about the presence or absence of the balance in the card, etc. via the communication network 105, and then, determines whether the user's card can be charged.

As a result of the determination, if the portable information device 101 can use the display device 102, the availability determination section 172 sets a mode to cause the display device 102 to display a used time and the corresponding integral charge (S209). On the other hand, as a result of the above determination, if the portable information device 101 cannot use the display device 102, the procedure goes back to S202.

Next, if the portable information device 101 can use the display device 102, as shown in FIG. 42, the display switching control section 171 causes the display device 102 to display a questionnaire screen shown in FIG. 44 (S210). This questionnaire is created, for example, by the foregoing railway company and stored in the memory section 120 of the display management device 103. Note that, in the case where the advertiser D of the advertisement displayed on the display device 102 is a company other than the railway company, the questionnaire is the one created by that company, for example. In this case, the questionnaire is transmitted via the communication network 105 from the information distribution device 104 to the display management device 103.

Next, when the questionnaire is answered by the user of the portable information device 101 (S211) and an answer transmission button is turned ON by the operating section 111 of the portable information device 101, a questionnaire result is transmitted to the display management device 103 and stored in the memory section 120. Further, in the case where the questionnaire is the one from the advertiser D which is other than the railway company, the questionnaire result is transmitted via the communication network 105 from the display management device 103, for example, to the information distribution device 104 owned by the advertiser D and saved in the information distribution device 104.

Thereafter, the display device 102 shows a screen for asking whether to answer another company's questionnaire. In the case where it is selected to answer the questionnaire, the same steps as described above are carried out (S212). The number of questionnaires thus answered is recorded in the memory section 120 of the display management device 103 (S213).

On the other hand, at the steps S211 and S212, in the case where it is refused to answer the questionnaire, the procedure goes to a step S214. The refusal of answering the questionnaire is carried out, for example, by an answer skip button operated by the operating section 111 of the portable information device 101.

Thereafter, the availability determination section 172 permits the use of the display device 102 and causes the use permission indicating section 161 to light on, so as to let the user of the portable information device 101 know that the display device 102 is available. Alternatively, the availability determination section 172 causes the display section 114 of the display device 102 to display that the display device 102 is available. Further, the display switching control section 171 finishes the advertisement display on the display device 102 (S214). Note that, the advertisement may be appeared in the form of a small image for a banner advertising, etc., as described above.

Next, the display switching control section 171 in the display management device 103, in response to the instruction from the portable information device 101, retrieves content data from any of the information distribution devices 104 and causes the display device 102 to display the content data retrieved; or retrieves content data into the portable information device 101 or the display management device 103 (S215). Then, the charge processing section 173 starts charging for the use of the display device 102 by the portable information device 101 (S216). In this case, at least one of the use of the display device 102 itself, and the obtaining of content data from the information distribution device 104 is charged as the use of the display device 102.

As described above, in the state where the portable information device 101 can use the display device 102, the same image as that displayed on the display section 114 of the display device 102 is displayed on a small-size display device 135 of the portable information device 101. Note that, such an image that cannot be recognized without scrolling on the small-size display device 135 is possible to be recognized on the display section 114 of the display device 102 without scrolling because the display section 114 of the display device 102 is a large-sized screen.

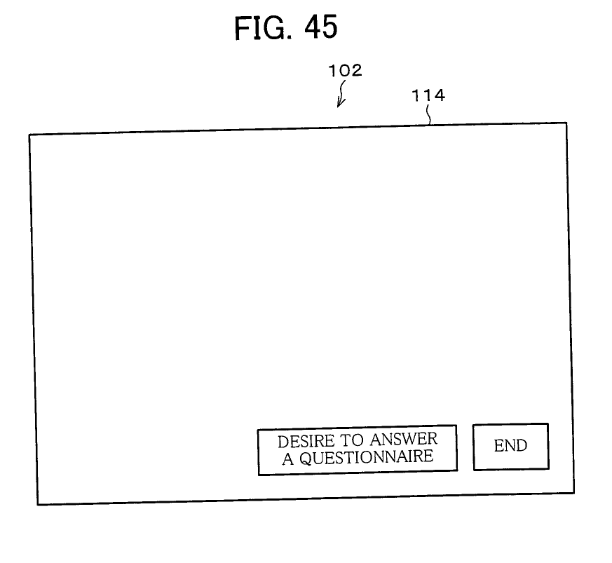

Further, the display switching control section 171, while the display device 102 is used by the portable information device 101, causes a desire-to-answer questionnaire button to be displayed on one corner of the display section 114, as shown in FIG. 45. The display switching control section 171, when the desire-to-answer questionnaire button is turned ON (clicked), causes the questionnaire screen shown in FIG. 44 to be displayed on the display section 114. This makes it possible to answer an unanswered questionnaire at any time.

Thereafter, the display switching control section 171 observes whether the portable information device 101 has finished using the display device 102 (S217). Note that, the use of the display device 102 can be finished by the foregoing method, or by turning ON (clicking) a finish button displayed on the end part of the display section 114.

At the step S217, when the display switching control section 171 detects that the portable information device 101 has finished using the display device 102, the charge processing section 173 finishes charging and calculates the use fee of the display device 102 (S218). Then, the charge processing section 173 performs checkout processing (S219). Upon checkout processing, the charge processing section 173 discounts in accordance with the answered questionnaire such as the number of questionnaires that have been answered. The advertiser D who has carried out the questionnaire bears the amount that has been discounted.

Further, in case of payment by cash with change occurred, the charge processing section 173 makes change. In case of payment by card, checkout processing is performed suitably according to the type of the card. For example, in the case of payment by credit card, the charge processing section 173 accesses to a server of the credit company and charges the use fee to the credit card's account. Thereafter, the procedure goes back to S202, and the display switching control section 171 restarts the advertisement display on the display device 102.

This information service system allows the user of the portable information device 101 to use the display device 102 at a low price or at no charge (in accordance with the proportion of answers to the questionnaire). The advertiser D that has conducted the questionnaire bears the amount that has been discounted by that. However, the advertiser D can effectively collect client information from the questionnaire, so that great merit can be obtained in business activities.

[Sixth Embodiment]

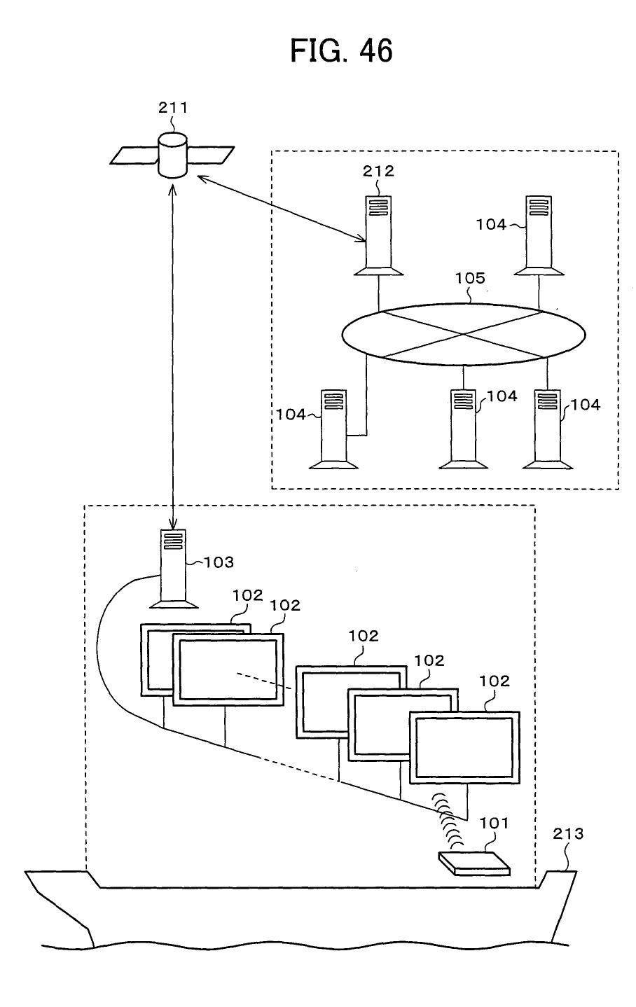

The following will explain still another embodiment of the present invention with reference to FIG. 46. The present information service system is a system in which a communication satellite 211 and a communication management device 212 are provided between a display management device 103 and a communication network 105 in the foregoing information service system.

The display management device 103 is connected for example, via cables to display devices 102, and the communication management device 212 is, for example, wire-connected to the communication network 105 (Internet). The communication management device 212 serves as a relay for the communication via the communication satellite 211 among the display management device 103, the communication network 105, and information distribution devices 104.

The display devices 102 and the display management device 103 are installed in an accommodation area of transportation, such as airplane, ship, train, and bus, i.e. means of transport 213. The communication management device 212 is provided fixedly to the ground. Other arrangement is similar to that of the foregoing information service system.

According to the arrangement as described above, in the present information service system, a predetermined information communication service can be enjoyed even in the means of transport 213, for example, in the same manner as that at home.

As described above, the information service system of the present invention enables the portable information device 101 to use any one of the display devices 102 which are provided, for example, all over the places such as a street corner. Therefore, this information service system is not always necessary to provide a display device with the portable information device 101 itself, so that it is possible to help the size and weight reduction for the portable information device 101. Further, the display device 102 is not necessary to be carried with the portable information device 101, so that it is possible to increase a screen size of the display device 102. This enables the user of the portable information device 101 such as a PC to work while looking at a large screen in visiting places and means of transport (in the case where the display device 102 is provided to the seat of a vehicle), without limitation to the display device which is equipped with the portable information device 1.

Thus, the present information service system is a convenient system for the user of the portable information device 101 and a system to provide an effective advertising medium for the advertiser who uses the display device 102 for the purpose of the advertisement display. Further, by charging to the user of the portable information device 101 and the advertiser, profits can be increased properly.

Further, in the present information service system, the user of the portable information device 101 can connect to an Internet provider (information distribution device 104) with which the user of the portable information device 101 is under contract, via the display device 102, the display management device 103, and the communication network 105 (Internet). The steps of the procedure for this connection are the same as those carried out for a usual terminal device. More specifically, an Internet Web page can be displayed on the display section 114 by calling up a screen for the Internet connection to the display section 114 of the display device 102 and transmitting a telephone number of an access point, an ID, and a password so as to connect to the provider.

Further, in the present information service system, a company that owns the display devices 102 and the display management device 103, i.e. a display installer B may make a contract for the provision of various kinds of applications software with a plurality of information distribution devices 104, i.e. information distributing companies. In such a case, the application software desired by the portable information device 101 can be easily downloaded to the display management device 103 or the portable information device 101. Also, in the case where the application software is payware, it is possible to easily charge the display management device 103 for this processing.

In this case, the display management device 103, in the case where it is possible to obtain the application software desired by the portable information device 101 from the plurality of information distribution devices 104 (information distributing company), may compare the use fees given by the respective information distribution devices 104 so as to download the application software whose use fee is the lowest.

As described above, the advertisement of the company which owns the display management device 103, i.e. the advertisement of the display installer B shown in FIG. 29 is usually displayed on the display device 102 all the time. Also, another company can make a contract with the display installer B, so as to make their advertisement displayed on the display device 102. These advertisement providing method, charging method, etc. are as described previously.

As described above, the information service system includes the display device 102, provided at the place where unspecified number of users each having the portable information device 101 can use the display device 102, for displaying information; the transmitting/receiving section 117 for communicating with the portable information device 101; and the display management device 103 for retrieving information via the communication network 105, in accordance with the request supplied via the transmitting/receiving section 117 from the portable information device 101, and causing the display device 102 to display the information. This can remove a large screen from the portable information device so as to reduce the size and weight of the portable information device, take advantage of the small size and light weight of the device, work with a large display screen in visiting places, and use data which is retrieved, for example, via the Internet.

### INDUSTRIAL APPLICATION OF THE PRESENT INVENTION

In order to solve the foregoing problems, an information service system of the present invention comprises: display means, provided at a place where unspecified number of users each having an external device can use the display means, for displaying image information; display side communicating means for communicating with the external device; and display control means for causing the display means to display image information supplied from the external device via the display side communicating means, in accordance with a request from the external device.

With the foregoing arrangement, the external device does not require large-sized display means which can display images properly. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Another information service system of the present invention comprises: display means for displaying image information; display side communicating means for communicating with an external device; display control means for causing the display means to display image information supplied from the external device via the display side communicating means; and display management means having a charge processing section for charging for use of the display means by the external device.

With the foregoing arrangement, the external device does not require large-sized display means which can display images properly. As a result of this, the external device can reduce its size and weight, thereby increasing portability.

Further, the charge processing section of the display management means charges for the use of the display means by the external device, so that it is possible to properly gain profits from the use of the display means.

Still another information service system of the present invention comprises: portable information means and display providing means, the display providing means including: display means, provided at a place where unspecified number of users each having the portable information means can use the display means, for displaying image information; display side communicating means for communicating with the portable information means; display control means for causing the display means to display image information supplied from the portable information means via the display side communicating means, in accordance with a request for use from the portable information means; and display management means for managing display operation of the display means.

With the foregoing arrangement, in accordance with the request from the portable information means, the display control means cause the display means to display the image information supplied from the portable information means via the display side communicating means. Therefore, the portable information means does not require large-sized display means which can display images properly. As a result of this, the portable information means can reduce its size and weight, thereby increasing portability.

Further, since the display means are provided at the place where unspecified number of users each having portable information means can use the display means, e.g. a public place, holders of the portable information means can use the display means easily in visiting places and means of transport.

Yet another information service system comprises: portable information means, display providing means, and the display providing means including: display means for displaying image information; display side communicating means for communicating with the portable information means; display control means for causing the display means to display image information supplied from the portable information means via the display side communicating means; and display management means having a charge processing section for charging for use of the display means by the portable information means.

With the foregoing arrangement, in accordance with the request from the portable information means, the display control means cause the display means to display the image information supplied from the portable information means via the display side communicating means. Therefore, the portable information means does not require large-sized display means which can display images properly. As a result of this, the portable information means can reduce its size and weight, thereby increasing portability.

Further, the charge processing section of the display management means charges for the use of the display means by the portable information means, so that it is possible to properly gain profits from the use of the display means.

The foregoing information service system may have an arrangement in which the display means are paired up with the display side communicating means, and plural pairs of the display means and the display side communicating means are provided with respect to one display management means.

With the foregoing arrangement, one display management means manage a plurality of display means. This enables an efficient system arrangement and makes the installation of the plurality of display means easy.

The foregoing information service system may have an arrangement in which the display means are paired up with the display side communicating means, and at least plural pairs of the display means and the display side communicating means are dispersed in plural areas.

With the foregoing arrangement, the display means are dispersed in plural areas. This makes the use of the display means easy and enhances convenience of the present system.

The foregoing information service system may have an arrangement in which the charge processing section charges an amount of money depending on a length of time that the portable information means use the display means.

With the foregoing arrangement, it is possible to charge properly for the use of the display means by the portable information means.

The foregoing information service system may have an arrangement in which the display management means have a fee-based information storing section for storing fee-based information and provide the portable information means with the fee-based information in response to a request from the portable information means; and the charge processing section, when the fee-based information is provided to the portable information means, further charges a fee for the use of the fee-based information.

With the foregoing arrangement, the portable information means not only can use the display means for causing the display means to display image information held by the portable information means, but also can use fee-based information held by the fee-based information storing section of the display management means, thereby enhancing convenience of the system. Further, it is possible to properly charge not only for the use of the display means by the portable information means but also for the use of the fee-based information held by the display management means.

The foregoing information service system may have an arrangement in which the display providing means further have a fee payment means accepting section; and the charge processing section asks a user of the portable information means for payment of a price charged and performs checkout processing with respect to fee payment means taken in the fee payment means accepting section.

With the foregoing arrangement, the charge processing section performs checkout processing for the price charged with respect to the fee payment means, for example, cash, credit card, debit card, various prepaid cards, and electric money, which are taken in the fee payment means accepting section. This makes easy checkout processing for the use fee by the user (holder) of the portable information means.

The foregoing information service system may have an arrangement in which the display management means include an availability determination section for managing a length of time that the portable information means use the display means in accordance with an amount that can be spent, given by the fee payment means taken in the fee payment means accepting section.

With the foregoing arrangement, the availability determination section manages a length of time that the portable information means use the display means in accordance with an amount that can be spent, given by the fee payment means, for example, cash, credit card, debit card, various prepaid cards, and electric money, which are taken in the fee payment means accepting section, so that it is possible to properly manage a length of time the portable information means can use the display means.

The foregoing information service system may have an arrangement in which the display management means further include: an advertisement information storage section for storing advertisement information which is displayed on the display means; and a display switching control section for switching so that the advertisement information stored in the advertisement information storage section is displayed on the display means while the display means are not used by the portable information means.

With the foregoing arrangement, while the display means are not used by the portable information means, advertisement information stored in the advertisement information storage section is displayed on the display means by switching operation of the display switching control section. Therefore, while the display means are not used by the portable information means, an advertiser can take advantage of display operation in the display means effectively for advertising.

The foregoing information service system may have an arrangement in which the display management means further include: an advertisement information storage section for storing advertisement information which is displayed on the display means; and a display switching control section for switching so that the advertisement information stored in the advertisement information storage section is displayed on the display means while the display means are not used by the portable information means, and the charge processing section charge an advertiser for display of the advertisement information on the display means.

With the foregoing arrangement, while the display means are not used by the portable information means, advertisement information stored in the advertisement information storage section is displayed on the display means by switching operation of the display switching control section. Therefore, while the display means are not used by the portable information means, an advertiser can take advantage of display operation in the display means effectively for advertising.

Further, the charge processing section charges an advertiser for display of advertisement information on the display means. This makes it possible to gain profits properly from the display of advertisement information on the display means.

The foregoing information service system may have an arrangement in which the display management means further include: an advertisement information storage section for storing advertisement information which is displayed on the display means; and a display switching control section for switching so that the advertisement information stored in the advertisement information storage section is displayed on the display means while the display means are not used by the portable information means, and the charge processing section reduces an amount asked to a user of the portable information means from a price charged and asks an advertiser whose advertisement is displayed on the display means for the amount that has been reduced.

With the foregoing arrangement, while the display means are not used by the portable information means, advertisement information stored in the advertisement information storage section is displayed on the display means by switching operation of the display switching control section. Therefore, while the display means are not used by the portable information means, an advertiser can take advantage of display operation in the display means effectively for advertising.

Further, in accordance with the advertisement display, the charge processing section reduces an amount asked to a user of the portable information means from a price charged and asks an advertiser whose advertisement is displayed on the display means for the amount that has been reduced. This provides a low-cost and friendly system for the user of the portable information means.

Still another information service system comprises: portable information means and display providing means, the display providing means including: display means for displaying image information; display side communicating means for communicating with the portable information means; display control means for causing the display means to display image information supplied from the portable information means via the display side communicating means; and display management means for managing an operation of the display means, the display management means including: an advertisement information storage section for storing advertisement information which is displayed on the display means; a display switching control section for switching so that the advertisement information stored in the advertisement information storage section is displayed on the display means while the display means are not used by the portable information means; and a charge processing section for charging an advertiser whose advertisement is displayed on the display means for a use fee for the display means.

With the foregoing arrangement, in accordance with the request from the portable information means, the display control means cause the display means to display the image information supplied from the portable information means via the display side communicating means. Therefore, the portable information means does not require large-sized display means which can display images properly. As a result of this, the portable information means can reduce its size and weight, thereby increasing portability.

Further, while the display means are not used by the portable information means, advertisement information stored in the advertisement information storage section is displayed on the display means by switching operation of the display switching control section. Therefore, while the display means are not used by the portable information means, an advertiser can take advantage of display operation in the display means effectively for advertising.

Further, in accordance with the advertisement display, the charge processing section charges an advertiser whose advertisement is displayed on the display means for a use fee for the display means. This provides an economically less burdensome and friendly system for the user of the portable information means.

The foregoing information service system may have an arrangement in which the charge processing section returns a part of profits gained by charging at least to an installation location provider who provides an installation location for the display means.

With the foregoing arrangement, at least the installation location provider for the display means can gain profits from providing the installation location.

The foregoing information service system may have an arrangement in which the charge processing section returns a part of profits gained by charging at least to an installation location provider who provides an installation location for the display means, and carries out the charging to the installation location provider in case where the installation location provider is an advertiser.

With the foregoing arrangement, at least the installation location provider for the display means can gain profits from providing the installation location. On the other hand, in the case where the installation location provider is an advertiser, the charging is carried out to the installation location provider. This makes it possible to properly carry out the return of profits and the charging to the installation location provider.

The foregoing information service system may have an arrangement in which the portable information means communicates with the display providing means in accordance with IEEE802.11, USB, or IEEE 1394 specification.

With the foregoing arrangement, it is possible to easily make connections for communication between the portable information means and the display providing means.

An information service method of the present invention comprises the steps of: installing display means for displaying image information at a place where unspecified number of users each having portable information means can use the display means; and causing the display means to display image information supplied from the portable information means in accordance with a request for use from the portable information means.

With the foregoing arrangement, in accordance with the request from the portable information means, the image information supplied from the portable information means is displayed on the display means. Therefore, the portable information means does not require large-sized display means which can display images properly. As a result of this, the portable information means can reduce its size and weight, thereby increasing portability.

Further, since the display means are provided at the place where unspecified number of users each having portable information means can use the display means, e.g. a public place, holders of the portable information means can use the display means easily in visiting places and means of transport.

Yet another information service method comprises the steps of: installing display means for displaying image information; causing the display means to display image information supplied from portable information means; and charging for use of the display means by the portable information means.

With the foregoing arrangement, in accordance with the request from the portable information means, the image information supplied from the portable information means is displayed on the display means. Therefore, the portable information means does not require large-sized display means which can display images properly. As a result of this, the portable information means can reduce its size and weight, thereby increasing portability.

Further, it is charged for the use of the display means by the portable information means, so that it is possible to properly gain profits from the use of the display means.

The foregoing information service method may further comprise the steps of: asking a user of the portable information means for payment of a price charged; and performing checkout processing with respect to fee payment means provided.

With the foregoing arrangement, checkout processing for the price charged is performed with respect to the fee payment means, for example, cash, credit card, debit card, various prepaid cards, and electric money, which are taken in the fee payment means accepting section. This makes easy checkout processing for the use fee by the user (holder) of the portable information means.

The foregoing information service method may further comprise the step of: causing the display means to display advertisement information while the display means are not used by the portable information means.

With the foregoing arrangement, while the display means are not used by the portable information means, advertisement information is displayed on the display means. Therefore, while the display means are not used by the portable information means, an advertiser can take advantage of display operation in the display means effectively for advertising.

The foregoing information service method may further comprise the step of: charging an advertiser for display of the advertisement information on the display means.

Further, an advertiser is charged for display of advertisement information on the display means. This makes it possible to gain profits properly from the display of advertisement information on the display means.

The foregoing information service method may further comprise the steps of: causing the display means to display advertisement information while the display means are not used by the portable information means; reducing an amount asked to a user of the portable information means from a price charged; and asking an advertiser whose advertisement is displayed on the display means for the amount that has been reduced.

With the foregoing arrangement, while the display means are not used by the portable information means, advertisement information is displayed on the display means. Therefore, while the display means are not used by the portable information means, an advertiser can take advantage of display operation in the display means effectively for advertising.

Further, in accordance with the advertisement display, an amount asked to a user of the portable information means is reduced from a price charged and the amount that has been reduced is asked to an advertiser whose advertisement is displayed on the display means. This provides a low-cost and friendly system for the user of the portable information means.

The foregoing information service method may comprise the steps of: installing display means for displaying image information; causing the display means to display image information supplied from portable information means; causing the display means to display advertisement information while the display means are not used by the portable information means; and charging an advertiser whose advertisement is displayed on the display means for a use fee for the display means regarding an advertisement display and a use fee for the display means by the portable information means.

With the foregoing arrangement, in accordance with the request from the portable information means, the image information supplied from the portable information means is displayed on the display means. Therefore, the portable information means does not require large-sized display means which can display images properly. As a result of this, the portable information means can reduce its size and weight, thereby increasing portability.

Further, while the display means are not used by the portable information means, advertisement information is displayed on the display means. Therefore, while the display means are not used by the portable information means, an advertiser can take advantage of display operation in the display means effectively for advertising.

Further, in accordance with the advertisement display, a use fee for the display means is charged to an advertiser whose advertisement is displayed on the display means. This provides an economically less burdensome and friendly system for the user of the portable information means.

The foregoing information service method may further comprise the step of: returning a part of profits gained by charging to an installation location provider for the display means.

With the foregoing arrangement, at least the installation location provider for the display means can gain profits from providing the installation location.

The foregoing information service method may further comprise the step of: returning a part of profits gained by charging to an installation location provider who provides an installation location for the display means; and carrying out the charging to the installation location provider in case where the installation location provider is an advertiser.

With the foregoing arrangement, at least the installation location provider for the display means can gain profits from providing the installation location. On the other hand, in the case where the installation location provider is an advertiser, the charging is carried out to the installation location provider. This makes it possible to properly carry out the return of profits and the charging to the installation location provider.

An information service system of the present invention comprises: display means, provided at a place where unspecified number of users each having an external device, e.g. a portable personal computer can use the display means, for displaying information; display side communicating means for communicating with the external device; and display management means for retrieving information via a communication network, in accordance with a request supplied from the external device via the display side communicating means, and causing the display means to display the information.

With the foregoing arrangement, the display management means, in accordance with the request supplied from the external device via the display side communicating means, retrieve information via a communication network and cause the display means to display the information. Therefore, the external device does not require large-sized display means which can display information properly. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Another information service system of the present invention comprises: display means, provided at a place where unspecified number of users each having an external device can use the display means, for displaying information; display side communicating means for communicating with the external device; and display management means for retrieving information via a communication network, in accordance with a request supplied from the external device via the display side communicating means, supplying the information to the external device via the display side communicating means, and causing the display means to display a process of this processing.

With the foregoing arrangement, the display management means, in accordance with the request supplied from the external device via the display side communicating means, retrieve information via a communication network, supply the information to the external device via the display side communicating means, and cause the display means to display a process of this processing. Therefore, the external device does not require large-sized display means which can properly display a process of the processing carried out in accordance with the request from the external device. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Still another information service system comprises: display means for displaying information; display side communicating means for communicating with an external device; and display management means for retrieving information via a communication network, in accordance with a request supplied from the external device via the display side communicating means, causing the display means to display the information, and charging for at least a part of processing which is carried out in accordance with the request from the external device.

With the foregoing arrangement, the display management means, in accordance with the request supplied from the external device via the display side communicating means, retrieve information via a communication network and cause the display means to display the information. Therefore, the external device does not require large-sized display means which can display information properly. As a result of this, the external device can reduce its size and weight, thereby increasing portability.

Further, the display management means charge for at least a part of processing which is carried out in accordance with the request from the external device, so that it is possible to gain profits from carrying out the foregoing processing.

Yet another information service system comprises: display means for displaying information; display side communicating means for communicating with an external device; and display management means for retrieving information via a communication network, in accordance with a request supplied from the external device via the display side communicating means, supplying the information to the external device via the display side communicating means, causing the display means to display a process of this processing, and charging for at least a part of processing which is carried out in accordance with the request from the external device.

With the foregoing arrangement, the display management means, in accordance with the request supplied from the external device via the display side communicating means, retrieve information via a communication network, supply the information to the external device via the display side communicating means, and cause the display means to display a process of this processing. Therefore, the external device does not require large-sized display means which can properly display a process of the processing carried out in accordance with the request from the external device. As a result of this, the external device can reduce its size and weight, thereby increasing portability.

Further, the display management means charge for at least a part of processing which is carried out in accordance with the request from the external device, so that it is possible to gain profits from carrying out the foregoing processing.

The foregoing information service system may be arranged so as to further comprise: portable information means as the external device; and information distributing means for being capable of distributing information via the network to the display management means.

With the foregoing arrangement, the display management means, in accordance with the request supplied from the portable information means via the display side communicating means, can properly retrieve information from the information distributing means via a communication network. The portable information means do not require large-sized display means. As a result of this, the portable information means can reduce its size and weight, thereby increasing portability.

The foregoing information service system may have an arrangement in which the display means are paired up with the display side communicating means, and plural pairs of the display means and the display side communicating means are provided with respect to one display management means.

With the foregoing arrangement, one display management means manage a plurality of display means. This enables an efficient system arrangement and makes the installation of the plurality of display means easy.

The foregoing information service system may have an arrangement in which the display means are paired up with the display side communicating means, and at least plural pairs of the display means and the display side communicating means are dispersed in plural areas.

With the foregoing arrangement, the display means are dispersed in plural areas. This makes the use of the display means easy and enhances convenience of the present system.

The foregoing information service system may have an arrangement in which the display management means carry out the charging in accordance with a length of time that the display means is used.

With the foregoing arrangement, it is possible to charge properly for the use of the display means.

The foregoing information service system may have an arrangement in which the display management means obtain fee-based information from information distributing means which make a contract for information distribution via the communication network with the display management means.

With the foregoing arrangement, by previously making a contract for information distribution with selected information distributing means which provide useful fee-based information, the display management means can obtain fee-based information from such display management means. This makes it possible to easily obtain various kinds of high-quality information.

The foregoing information service system may have an arrangement in which the information distributing means exist in plurality, and the display management means obtain fee-based information to be obtained from information distributing means which supply the fee-based information at the lowest price.

With the foregoing arrangement, it is possible to supply useful information to a user of the present system at low prices.

The foregoing information service system may have an arrangement in which a fee payment means accepting section is further included, and the display management means ask a user of the external device for payment of a price charged and perform checkout processing with respect to fee payment means taken in the fee payment means accepting section.

With the foregoing arrangement, the display management means ask a user of the external device for payment of a price charged and perform checkout processing with respect to the fee payment means, for example, cash, credit card, debit card, various prepaid cards, and electric money, which are taken in the fee payment means accepting section. This makes easy checkout processing for the use fee by the user (holder) of the external device.

The foregoing information service system may have arrangement in which the display management means manage a length of time that the external device use the display means in accordance with an amount that can be spent, given by the fee payment means that are taken in the fee payment means accepting section.

With the foregoing arrangement, the display management means manage a length of time that the external device use the display means in accordance with an amount that can be spent, given by the fee payment means, for example, cash, credit card, debit card, various prepaid cards, and electric money, which are taken in the fee payment means accepting section, so that it is possible to properly manage a length of time the external device can use the display means.

The foregoing information service system may have an arrangement in which the display management means further include an advertisement information storage section for storing advertisement information which is displayed on the display means, and causes the display means to display the advertisement information stored in the advertisement information storage section while the display means are not used by the external device.

With the foregoing arrangement, while the display means are not used by the external device, advertisement information stored in the advertisement information storage section is displayed on the display means. Therefore, while the display means are not used by the external device, an advertiser can take advantage of display operation in the display means effectively for advertising.

The foregoing information service system may have an arrangement in which the display management means retrieve advertisement information via the communication network, and causes the display means to display the advertisement information while the display means are not used by the external device.

With the foregoing arrangement, while the display means are not used by the external device, advertisement information retrieved via the communication network is displayed on the display means. Therefore, while the display means are not used by the external device, an advertiser can take advantage of display operation in the display means effectively for advertising.

The foregoing information service system may have an arrangement in which the display management means charge an advertiser for display of the advertisement information on the display means.

With the foregoing arrangement, it is possible to properly gain profits from the display of advertisement information on the display means.

The foregoing information service system may have an arrangement in which the display management means, while the display means are not used by the external device, cause the display means to display advertisement information, charge an advertiser for display of the advertisement information on the display means, reduce an amount asked by charging to a user of the external device, and ask the advertiser for the amount that has been reduced.

With the foregoing arrangement, while the display means are not used by the external device, advertisement information is displayed on the display means. Therefore, while the display means are not used by the external device, an advertiser can take advantage of display operation in the display means effectively for advertising.

Further, in accordance with the advertisement display, the display management means reduce an amount asked to a user of the external device from a price charged and asks an advertiser whose advertisement is displayed on the display means for the amount that has been reduced. This provides a low-cost and friendly system for the user of the external device.

The foregoing information service system may have an arrangement in which the display management means return a part of profits gained by charging at least to an installation location provider who provides an installation location for the display means.

With the foregoing arrangement, at least the installation location provider for the display means can gain profits from providing the installation location.

The foregoing information service system may have an arrangement in which the display management means return a part of profits gained by charging at least to an installation location provider who provides an installation location for the display means, and carries out the charging to the installation location provider in case where the installation location provider is an advertiser.

With the foregoing arrangement, at least the installation location provider for the display means can gain profits from providing the installation location. On the other hand, in the case where the installation location provider is an advertiser, the charging is carried out to the installation location provider. This makes it possible to properly carry out the return of profits and the charging to the installation location provider.

The foregoing information service system may have an arrangement in which the display management means include a questions storage section for storing questions to a user of the external device, and cause the display means to display the questions when a request for use of the present system is inputted from the external device.

With the foregoing arrangement, when a request for use of the present system is inputted from the external device, the display management means read out questions to the user of the external device from the questions storage section to display the questions on the display means. Therefore, answering of the questions by the user of the external device enables easy collection of valuable information in business activities, such as information on the user of the external device and the user's trend.

The foregoing information service system may have an arrangement in which the display management means, when a request for use of the present system is inputted from the external device, retrieve questions to a user of the external device via the communication network from a request issuer of the questions and cause the display means to display the questions.

With the foregoing arrangement, when a request for use of the present system is inputted from the external device, the display management means retrives questions to a user of the external device via the communication network from a request issuer of the questions and cause the display means to display the questions. Therefore, answering of the questions by the user of the external device enables easy collection of valuable information in business activities, such as information on the user of the external device and the user's trend.

The foregoing information service system may have an arrangement in which the display management means, when a request for use of the present system is inputted from the external device, cause the display means to display questions to a user of the external device, and reduce an amount asked by charging to the user of the external device when answers to the questions can be obtained.

With the foregoing arrangement, when a request for use of the present system is inputted from the external device, the questions to the user of the external device are displayed on the display means by the display management means. Therefore, answering of the questions by the user of the external device enables easy collection of valuable information in business activities, such as information on the user of the external device and the user's trend.

Meanwhile, by answering questions, the user of the external device can get an amount asked by charging reduced. This makes a low-price and friendly system for the user of the external device.

The foregoing information service system may have an arrangement in which the display management means ask a request issuer of the questions for the amount that has been reduced in accordance with answers to the questions.

With the foregoing arrangement, it is possible to properly collect profits from the use of the present system.

The foregoing information service system may have an arrangement in which the display side communicating means communicate with the external device in accordance with IEEE802.11, USB, or IEEE1394 specification.

With the foregoing arrangement, it is possible to easily make connections for communication between the display management means and the external device.

The foregoing information service system may have an arrangement in which between the display management means and the communication network provided are wireless communication means and communication management means for relaying via the wireless communication means between the display management means and the communication network.

With the foregoing arrangement, the display management means are arranged so as to be connected to the communication network via the wireless communication means and the communication management means, so that it is possible to establish the display means and the display management means in the means of transport for transporting, such as airplane, ship, train, and bus. This allows the user of the external device to use the present system in the means of transport, thereby enhancing convenience of the present system.

An information service method of the present invention comprises the steps of: installing display means for displaying information at a place where unspecified number of users each having an external device can use the display means; retrieving information via a communication network, in accordance with a request supplied from the external device; and causing the display means to display the information.

With the foregoing arrangement, the external device does not require large-sized display means which can display information properly. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Another information service method of the present invention comprises the steps of: installing display means for displaying information at a place where unspecified number of users each having an external device can use the display means; retrieving information via a communication network, in accordance with a request supplied from the external device; supplying the information to the external device; and causing the display means to display a process of this processing.

With the foregoing arrangement, the external device does not require large-sized display means which can properly display a process of the processing carried out in accordance with the request from the external device. As a result of this, the external device can reduce its size and weight, thereby increasing portability.

Further, since the display means are provided at the place where unspecified number of users each having an external device can use the display means, e.g. a public place, holders of the external device can use the display means easily in visiting places and means of transport.

Still another information service method of the present invention comprises the steps of: installing display means for displaying information; retrieving information via a communication network, in accordance with a request supplied from the external device; causing the display means to display the information; charging for at least a part of processing which is carried out in accordance with the request from the external device.

With the foregoing arrangement, in the case where information that has been retrieved via the communication network is displayed, the external device does not require large-sized display means which can display information properly. As a result of this, the external device can reduce its size and weight, thereby increasing portability.

Further, charging is carried out for at least a part of processing which is carried out in accordance with the request from the external device, so that it is possible to gain profits from carrying out the foregoing processing.

Yet another information service method of the present invention comprises the steps of: installing display means for displaying information; retrieving information via a communication network, in accordance with a request supplied from the external device; supplying the information to the external device; causing the display means to display a process of this processing; and charging for at least a part of processing which is carried out in accordance with the request from the external device.

With the foregoing arrangement, in the case where information that has been retrieved via the communication network is supplied to the external device, the external device does not require large-sized display means which can properly display a process of the processing carried out in accordance with the request from the external device. As a result of this, the external device can reduce its size and weight, thereby increasing portability.

Further, charging is carried out for at least a part of processing which is carried out in accordance with the request from the external device, so that it is possible to gain profits from carrying out the foregoing processing.

The foregoing information service method may further comprise the steps of: using portable information means as the external device; and retrieving the information from information distributing means for being capable of distributing information via the communication network.

With the foregoing arrangement, it is possible to properly retrieve information from the information distributing means via the communication network in accordance with the request supplied from the portable information means. The portable information means do not require large-sized display means. As a result of this, the portable information means can reduce its size and weight, thereby increasing portability.

The foregoing information service method may have an arrangement in which the information obtained is fee-based information, and the fee-based information is obtained from information distributing means which make a contract for information distribution via the communication network.

With the foregoing arrangement, by previously making a contract for information distribution with selected information distributing means which provide useful fee-based information, the display management means can obtain fee-based information from such display management means. This makes it possible to easily obtain various kinds of high-quality information.

The foregoing information service method may have an arrangement in which the information distributing means exist in plurality, and fee-based information to be obtained is obtained from information distributing means which supply the fee-based information at the lowest price.

With the foregoing arrangement, it is possible to supply useful information to a user of the present system at low prices.

The foregoing information service method may further comprise the step of: causing the display means to display advertisement information while the display means are not used by the external device.

With the foregoing arrangement, while the display means are not used by the external device, an advertiser can take advantage of display operation in the display means effectively for advertising.

The foregoing information service method may further comprise the steps of: causing the display means to display advertisement information while the display means are not used by the external device; and charging an advertiser for display of the advertisement information on the display means.

With the foregoing arrangement, it is possible to properly gain profits from the display of the advertisement information on the display means.

The foregoing information service method may further comprise the steps of: causing the display means to display advertisement information while the display means are not used by the external device; charging an advertiser for display of the advertisement information on the display means; reducing an amount asked by charging to a user of the external device; and asking the advertiser for the amount that has been reduced.

With the foregoing arrangement, while the display means are not used by the external device, an advertiser can take advantage of display operation in the display means effectively for advertising.

Further, in accordance with the advertisement display, an amount asked to the user of the external device is reduced. This provides a low-price and friendly system for the user of the external device.

The foregoing information service method further comprises the step of: causing the display means to display questions to a user of the external device when a request for use of the present system is inputted from the external device.

With the foregoing arrangement, answering of the questions by the user of the external device enables easy collection of valuable information in business activities, such as information on the user of the external device and the user's trend.

The information service method may further comprise the steps of: causing the display means to display questionnaire entries for a user of the external device when a request for use of the present system is inputted from the external device; and reducing an amount asked by charging to the user of the external device when answers to the questions can be obtained.

With the foregoing arrangement, answering of the questions by the user of the external device enables easy collection of valuable information in business activities, such as information on the user of the external device and the user's trend.

Meanwhile, by answering questions, the user of the external device can get an amount asked by charging reduced. This makes a low-price and friendly system for the user of the external device.

The foregoing information service method may further comprise the step of: asking a request issuer of the questions for the amount that has been reduced in accordance with answering to the questions.

With the foregoing arrangement, it is possible to properly collect profits from the use of the present system.

The foregoing information service method may further comprise the step of: retrieving further via wireless communication means, information which is retrieved via the communication network.

With the foregoing arrangement, it is possible to establish the display means in the means of transport for transporting, such as airplane, ship, train, and bus. This allows the user of the external device to use the present system in the means of transport, thereby enhancing convenience of the present system.

The embodiments and concrete examples of implementation discussed in the foregoing detailed explanation serve solely to illustrate the technical details

What is claimed is:

1. An information service system comprising:
display means, provided at a place where unspecified number of users each having an external device can use the display means, for displaying image information;
display side communicating means for communicating with the external device; and
display control means for causing the display means to display image information supplied from the external device via the display side communicating means, in accordance with a request from the external device.

2. An information service system comprising:
display means for displaying image information;
display side communicating means for communicating with an external device;
display control means for causing the display means to display image information supplied from the external device via the display side communicating means; and
display management means having a charge processing section for charging for use of the display means by the external device.

3. An information service system comprising:
portable information means and display providing means, the display providing means including:
display means, provided at a place where unspecified number of users each having the portable information means can use the display means, for displaying image information;
display side communicating means for communicating with the portable information means;
display control means for causing the display means to display image information supplied from the portable information means via the display side communicating means, in accordance with a request for use from the portable information means; and
display management means for managing display operation of the display means.

4. An information service system comprising:
portable information means and display providing means,
the display providing means including:
display means for displaying image information;
display side communicating means for communicating with the portable information means;
display control means for causing the display means to display image information supplied from the portable information means via the display side communicating means; and
display management means having a charge processing section for charging for use of the display means by the portable information means.

5. The information service system according to any one of claims 1 to 4, wherein the display means are paired up with the display side communicating means, and plural pairs of the display means and the display side communicating means are provided with respect to one display management means.

6. The information service system according to any one of claims 1 to 4, wherein the display means are paired up with the display side communicating means, and at least plural pairs of the display means and the display side communicating means are dispersed in plural areas.

7. The information service system according to claim 4, wherein the charge processing section charges an amount of money depending on a length of time that the portable information means use the display means.

8. The information service system according to claim 4 or 7, wherein the display management means have a fee-based information storing section for storing fee-based information and provide the portable information means with the fee-based information in response to a request from the portable information means; and
the charge processing section, when the fee-based information is provided to the portable information means, further charges a fee for the use of the fee-based information.

9. The information service system according to claim 4 or 7, wherein the display providing means further have a fee payment means accepting section; and
the charge processing section asks a user of the portable information means for payment of a price charged and performs checkout processing with respect to fee payment means taken in the fee payment means accepting section.

10. The information service system according to claim 9, wherein the display management means include an availability determination section for managing a length of time that the portable information means use the display means in accordance with an amount that can be spent, given by the fee payment means that are taken in the fee payment means accepting section.

11. The information service system according to claim 3 or 4, wherein the display management means further include:
an advertisement information storage section for storing advertisement information which is displayed on the display means; and
a display switching control section for switching so that the advertisement information stored in the advertisement information storage section is displayed on the display means while the display means are not used by the portable information means.

12. The information service system according to claim 4 or 7, wherein the display management means further include:
an advertisement information storage section for storing advertisement information which is displayed on the display means; and
a display switching control section for switching so that the advertisement information stored in the advertisement information storage section is displayed on the display means while the display means are not used by the portable information means, and
the charge processing section charges an advertiser for display of the advertisement information on the display means.

13. The information service system according to claim 4 or 7, wherein the display management means further include:
an advertisement information storage section for storing advertisement information which is displayed on the display means; and
a display switching control section for switching so that the advertisement information stored in the advertisement information storage section is displayed on the display means while the display means are not used by the portable information means, and
the charge processing section reduces an amount asked to a user of the portable information means from a price charged and asks an advertiser whose advertisement is displayed on the display means for the amount that has been reduced.

14. An information service system comprising:
portable information means and display providing means,
the display providing means including:
display means for displaying image information;
display side communicating means for communicating with the portable information means;
display control means for causing the display means to display image information supplied from the portable information means via the display side communicating means; and
display management means for managing an operation of the display means,
the display management means including:
an advertisement information storage section for storing advertisement information which is displayed on the display means;
a display switching control section for switching so that the advertisement information stored in the advertisement information storage section is displayed on the display means while the display means are not used by the portable information means; and
a charge processing section for charging an advertiser whose advertisement is displayed on the display means for a use fee for the display means.

15. The information service system according to claim 4 or 14, wherein the charge processing section returns a part of profits gained by charging at least to an installation location provider who provides an installation location for the display means.

16. The information service system according to claim 12, wherein the charge processing section returns a part of profits gained by charging at least to an installation location provider who provides an installation location for the display means, and carries out the charging to the installation location provider in case where the installation location provider is an advertiser.

17. The information service system according to claim 13, wherein the charge processing section returns a part of profits gained by charging at least to an installation location provider who provides an installation location for the display means, and carries out the charging to the installation location provider in case where the installation location provider is an advertiser.

18. The information service system according to claim 14, wherein the charge processing section returns a part of profits gained by charging at least to an installation location provider who provides an installation location for the display means, and carries out the charging to the installation location provider in case where the installation location provider is an advertiser.

19. The information service system according to claim 3 or 4, wherein the portable information means communicates with the display providing means in accordance with IEEE802.11, USB, or IEEE1394 specification.

20. An information service method comprising the steps of:
installing display means for displaying image information at a place where unspecified number of users each having portable information means can use the display means; and
causing the display means to display image information supplied from the portable information means in accordance with a request for use from the portable information means.

21. An information service method comprising the steps of:
installing display means for displaying image information;
causing the display means to display image information supplied from portable information means; and
charging for use of the display means by the portable information means.

22. The information service method according to claim 21, further comprising the steps of:
asking a user of the portable information means for payment of a price charged; and
performing checkout processing with respect to fee payment means provided.

23. The information service method according to any one of claims 20 to 22, further comprising the step of:
causing the display means to display advertisement information while the display means are not used by the portable information means.

24. The information service method according to claim 23, further comprising the step of:
charging an advertiser for display of the advertisement information on the display means.

25. The information service method according to claim 22, further comprising the steps of:
causing the display means to display advertisement information while the display means are not used by the portable information means;
reducing an amount asked to a user of the portable information means from a price charged; and
asking an advertiser whose advertisement is displayed on the display means for the amount that has been reduced.

26. An information service method comprising the steps of:
installing display means for displaying image information;
causing the display means to display image information supplied from portable information means;
causing the display means to display advertisement information while the display means are not used by the portable information means; and
charging an advertiser whose advertisement is displayed on the display means for a use fee for the display means regarding an advertisement display and a use fee for the display means by the portable information means.

27. The information service method according to claim 21 or 26, further comprising the step of:
returning a part of profits gained by charging to an installation location provider for the display means.

28. The information service method according to claim 23, further comprising the step of:
returning a part of profits gained by charging to an installation location provider who provides an installation location for the display means; and
carrying out the charging to the installation location provider in case where the installation location provider is an advertiser.

29. The information service method according to claim 25, further comprising the step of:
returning a part of profits gained by charging to an installation location provider who provides an installation location for the display means; and
carrying out the charging to the installation location provider in case where the installation location provider is an advertiser.

30. The information service method according to claim 26, further comprising the step of:
returning a part of profits gained by charging to an installation location provider who provides an installation location for the display means; and
carrying out the charging to the installation location provider in case where the installation location provider is an advertiser.

31. An information service system comprising:
display means, provided at a place where unspecified number of users each having an external device can use the display means, for displaying information;
display side communicating means for communicating with the external device; and
display management means for retrieving information via a communication network, in accordance with a request supplied from the external device via the display side communicating means, and causing the display means to display the information.

32. An information service system comprising:
display means, provided at a place where unspecified number of users each having an external device can use the display means, for displaying information;
display side communicating means for communicating with the external device; and
display management means for retrieving information via a communication network, in accordance with a request supplied from the external device via the display side communicating means, supplying the information to the external device via the display side communicating means, and causing the display means to display a process of this processing.

33. An information service system comprising:
display means for displaying information;
display side communicating means for communicating with an external device; and
display management means for retrieving information via a communication network, in accordance with a request supplied from the external device via the display side communicating means, causing the display means to display the information, and charging for at least a part of processing which is carried out in accordance with the request from the external device.

34. An information service system comprising:
display means for displaying information;
display side communicating means for communicating with an external device; and
display management means for retrieving information via a communication network, in accordance with a request supplied from the external device via the display side communicating means, supplying the information to the external device via the display side communicating means, causing the display means to display a process of this processing, and charging for at least a part of processing which is carried out in accordance with the request from the external device.

35. The information service system according to any one of claims 31 to 34, further comprising:
portable information means as the external device; and
information distributing means for being capable of distributing information via the network to the display management means.

36. The information service system according to any one of claims 31 to 34, wherein the display means are paired up with the display side communicating means, and plural pairs of the display means and the display side communicating means are provided with respect to one display management means.

37. The information service system according to any one of claims 31 to 34, wherein the display means are paired up with the display side communicating means, and at least plural pairs of the display means and the display side communicating means are dispersed in plural areas.

38. The information service system according to claims 33, wherein the display management means carry out the charging in accordance with a length of time that the display means is used.

39. The information service system according to claim 33 or 34, wherein the display management means obtain fee-based information from information distributing means which make a contract for information distribution via the communication network with the display management means.

40. The information service system according to claim 39, wherein the information distributing means exist in plurality, and the display management means obtain fee-based information to be obtained from information distributing means which supply the fee-based information at the lowest price.

41. The information service system according to claim 33 or 34, wherein a fee payment means accepting section is further included, and the display management means ask a user of the external device for payment of a price charged and perform checkout processing with respect to fee payment means taken in the fee payment means accepting section.

42. The information service system according to claim 41, wherein the display management means manage a length of time that the external device use the display means in accordance with an amount that can be spent, given by the fee payment means that are taken in the fee payment means accepting section.

43. The information service system according to any one of claims 31 to 34, wherein the display management means further include an advertisement information storage section for storing advertisement information which is displayed on the display means, and causes the display means to display the advertisement information stored in the advertisement information storage section while the display means are not used by the external device.

44. The information service system according to any one of claims 31 to 34, wherein the display management means retrieve advertisement information via the communication network while the display means are not used by the external device, and causes the display means to display the advertisement information.

45. The information service system according to any one of claim 43, wherein the display management means charge an advertiser for display of the advertisement information on the display means.

46. The information service system according to any one of claim 44, wherein the display management means charge an advertiser for display of the advertisement information on the display means.

47. The information service system according to claim 33 or 34, wherein the display management means, while the display means are not used by the external device, cause the display means to display advertisement information, charge an advertiser for display of the advertisement information on the display means, reduce an amount asked by charging to a user of the external device, and ask the advertiser for the amount that has been reduced.

48. The information service system according to claim 33 or 34, wherein the display management means return a part of profits gained by charging at least to an installation location provider who provides an installation location for the display means.

49. The information service system according to claim 45, wherein the display management means return a part of profits gained by charging at least to an installation location provider who provides an installation location for the display means, and carries out the charging to the installation location provider in case where the installation location provider is an advertiser.

50. The information service system according to claim 46, wherein the display management means return a part of profits gained by charging at least to an installation location provider who provides an installation location for the display means, and carries out the charging to the installation location provider in case where the installation location provider is an advertiser.

51. The information service system according to claim 47, wherein the display management means return a part of profits gained by charging at least to an installation location provider who provides an installation location for the display means, and carries out the charging to the installation location provider in case where the installation location provider is an advertiser.

52. The information service system according to any one of claims 31 to 34, wherein the display management means include a questions storage section for storing questions for a user of the external device, and cause the display means to display the questions when a request for use of the present system is inputted from the external device.

53. The information service system according to any one of claims 31 to 34, wherein the display management means, when a request for use of the present system is inputted from the external device, retrieve questions to a user of the external device via the communication network from a request issuer of the questions and cause the display means to display the questions.

54. The information service system according to claim 33 or 34, wherein the display management means, when a request for use of the present system is inputted from the external device, cause the display means to display questions to a user of the external device, and reduce an amount asked by charging to the user of the external device when answers to the questions can be obtained.

55. The information service system according to claim 54, wherein the display management means ask a request issuer of the questions for the amount that has been reduced in accordance with answers to the questions.

56. The information service system according to any one of claims 31 to 34, wherein the display side communicating means communicate with the external device in accordance with IEEE802.11, USB, or IEEE1394 specification.

57. The information service system according to any one of claims 31 to 34, wherein between the display management means and the communication network provided are wireless communication means and communication management means for relaying via the wireless communication means between the display management means and the communication network.

58. An information service method comprising the steps of:
installing display means for displaying information at a place where unspecified number of users each having an external device can use the display means;
retrieving information via a communication network, in accordance with a request supplied from the external device; and
causing the display means to display the information.

59. An information service method comprising the steps of:
installing display means for displaying information at a place where unspecified number of users each having an external device can use the display means;
retrieving information via a communication network, in accordance with a request supplied from the external device;
supplying the information to the external device; and
causing the display means to display a process of this processing.

60. An information service method comprising the steps of:
installing display means for displaying information;
retrieving information via a communication network, in accordance with a request supplied from the external device;
causing the display means to display the information;
charging for at least a part of processing which is carried out in accordance with the request from the external device.

61. An information service method comprising the steps of:
installing display means for displaying information;
retrieving information via a communication network, in accordance with a request supplied from the external device;
supplying the information to the external device;
causing the display means to display a process of this processing; and
charging for at least a part of processing which is carried out in accordance with the request from the external device.

62. The information service method according to any one of claims 58 to 61, further comprising the steps of:
using portable information means as the external device; and
retrieving the information from information distributing means for being capable of distributing information via the communication network.

63. The information service method according to claim 60 or 61, wherein the information obtained is fee-based information, and the fee-based information is obtained from information distributing means which make a contract for information distribution via the communication network.

64. The information service method according to claim 63, wherein the information distributing means exist in plurality, and fee-based information to be obtained is obtained from information distributing means which supply the fee-based information at the lowest price.

65. The information service method according to any one of claims 58 to 61, further comprising the step of:
causing the display means to display advertisement information while the display means are not used by the external device.

66. The information service method according to claim 65, further comprising the steps of:
causing the display means to display advertisement information while the display means are not used by the external device; and
charging an advertiser for display of the advertisement information on the display means.

67. The information service method according to claim 60 or 61, further comprising the steps of:
causing the display means to display advertisement information while the display means are not used by the external device;
charging an advertiser for display of the advertisement information on the display means;
reducing an amount asked by charging to a user of the external device; and
asking the advertiser for the amount that has been reduced.

68. The information service method according to any one of claims 58 to 61, further comprising the step of:
causing the display means to display questions to a user of the external device when a request for use of the present system is inputted from the external device.

69. The information service method according to claim 60 or 61, further comprising the steps of:
causing the display means to display questionnaire entries for a user of the external device when a request for use of the present system is inputted from the external device; and
reducing an amount asked by charging to the user of the external device when answers to the questions can be obtained.

70. The information service method according to claim 69, further comprising the step of:
asking a request issuer of the questions for the amount that has been reduced in accordance with answering to the questions.

71. The information service method according to any one of claims 58 to 61, further comprising the step of:
retrieving further via wireless communication means, information which is retrieved via the communication network.
